(19) United States
(12) Patent Application Publication
(10) Pub. No.: US 2026/0225945 A1
(43) Pub. Date: Aug. 6, 2026

(54) CRYSTALLIZED GLASS

(71) Applicant: NIPPON ELECTRIC GLASS CO., LTD., Otsu-shi, Shiga (JP)

(72) Inventor: Yusuke OKADA, Otsu-shi (JP)

(21) Appl. No.: 19/150,370

(22) PCT Filed: Jan. 23, 2024
(86) PCT No.: PCT/JP2024/001772

§ 371 Date: Jul. 23, 2025

(30) Foreign Application Priority Data
Jan. 25, 2023 (JP) 2023-009545

(51) Int. Cl. C03C 10/00

(52) U.S. Cl. CPC C03C 10/0018

(57) ABSTRACT

Provided is a LAS-based crystallized glass which has a low coefficient of thermal expansion and excellent transparency and the cost of the raw material batch for which is kept down. A LAS-based crystallized glass contains, in terms of % by mass, 55 to 75% SiO₂, 10 to 35% Al₂O₃, 0.1 to 5% Li₂O, 0 to 10% BaO, 0 to 10% MgO, 0 to 5% TiO₂, 0 to 5% ZrO₂, and 0 to 5% P₂O₅ and satisfies that a value of 8Li₂O—4(Na₂O+K₂O+MgO)—(BaO+ZnO) is not more than 30%.

### TECHNICAL FIELD

The present invention relates to Li₂O—Al₂O₃—SiO₂-based crystallized glasses (hereinafter, referred to LAS-based crystallized glasses).

### BACKGROUND ART

LAS-based crystallized glass is used as a material of window glasses for fire doors, front windows for stoves, image sensor substrates, setters for firing, and so on.

For example, Patent Literatures 1 to 4 disclose LAS-based crystallized glasses in which LAS-based crystals, such as a β-quartz solid solution or a β-spodumene solid solution, are precipitated as a major crystalline phase.

Because precipitated crystals of such a LAS-based crystallized glass have a negative coefficient of thermal expansion, the LAS-based crystallized glass has a low coefficient of thermal expansion and excellent thermal characteristics. Furthermore, because a large amount of crystals are precipitated therein, the LAS-based crystallized glass has high mechanical strength. In addition, by appropriately adjusting heat treatment conditions in a crystallization process, the type of crystals to be precipitated can be controlled and a crystallized glass being transparent and having a low coefficient of thermal expansion and high mechanical strength can be produced.

Meanwhile, the cost of the glass raw material batch has recently been rising. For example, along with the popularization of small-sized electronic devices, such as a laptop personal computer and a mobile phone, and electric vehicles, the demand for Li-ion secondary batteries has increased relative to the amount of Li raw material (Li₂O) supplied and, therefore, the price of the Li raw material is rising.

Under the above circumstances, the need to keep down the cost of the raw material batch for LAS-based crystallized glass is growing. However, it is not easy to realize a LAS-based crystallized glass being transparent and having a low coefficient of thermal expansion while keeping down the cost of the raw material batch. For example, Li showing a particular rise in price is an essential element. If the content of Li₂O in a LAS-based crystallized glass is small, the amount of precipitated crystals having a low coefficient of thermal expansion, such as a β-quartz solid solution or a β-spodumene solid solution, becomes small and, thus, the coefficient of thermal expansion of the LAS-based crystallized glass easily becomes high.

For example, Patent Literatures 1 and 2 disclose the compositions of LAS-based crystallized glasses each having a low coefficient of thermal expansion and high transparency. Most of the glass compositions in examples in these literatures have a content of Li₂O of about 3.5 to about 4% by mass. Specifically, the glasses in Example Nos. 1 to 4 and 6 to 7 in Patent Literature 1 and the glasses in Example Nos. 1 to 8, 11 to 14, 16 to 39, 44 to 122, and 124 to 131 have a content of Li₂O of about 3.5 to about 4% by mass. This suggests that in order to achieve excellent thermal characteristics and transparency, the content of Li₂O needs to be about 3.5 to about 4% by mass.

On the other hand, Patent Literature 3 discloses examples in which, in the composition of a LAS-based crystallized glass similar to those in Patent Literatures 1 and 2, Li₂O is replaced with MgO. Specifically, in Example Nos. 1 to 3, 11, and 14 to 16, transparent LAS-based crystallized glasses are disclosed in which the content of Li₂O is reduced to not more than 3.24% by mass and the content of MgO is increased to not less than 1.6% by mass. These examples suggest that incorporation of MgO in place of Li₂O is one of useful ways to reduce Li₂O and concurrently keep transparency.

Patent Literature 4 also discloses a composition of a LAS-based crystallized glass in which ZnO or MgO is incorporated therein and the content of Li₂O is reduced to not more than 2.9%.

### CITATION LIST

### Patent Literature

[PTL 1]
JP-A-2012-56829
[PTL 2]
WO 2022/054739
[PTL 3]
JP-A-2020-196664
[PTL 4]
JP-A-2022-511634

### SUMMARY OF INVENTION

### Technical Problem

However, when the content of MgO is increased as in the LAS-based crystallized glass in Patent Literature 3, the coefficient of thermal expansion tends to increase. On the other hand, all the crystallized glasses described in Literature 4 cited have a high coefficient of thermal expansion, and further, are colored strongly with V₂O₅. In addition, ZnO described as an essential component in this patent literature tends to be slightly expensive compared to the other raw materials except for Li₂O.

In view of the above circumstances, an object of the present invention is to provide a LAS-based crystallized glass which has a low coefficient of thermal expansion and excellent transparency and the cost of the raw material batch for which is kept down.

### Solution to Problem

As the results of intensive studies, the inventors found that by appropriately designing the composition of a LAS-based crystallized glass, a LAS-based crystallized glass can be obtained which has a low coefficient of thermal expansion and excellent transparency and the cost of the raw material batch for which is kept down.

A LAS-based crystallized glass according to the present invention contains, in terms of % by mass, 55 to 75% SiO₂, 10 to 35% Al₂O₃, 0.1 to 5% Li₂O, 0 to 10% BaO, 0 to 10% MgO, 0 to 5% TiO₂, 0 to 5% ZrO₂, and 0 to 5% P₂O₅ and satisfies that a value of 8Li₂O−4(Na₂O+K₂O+MgO)—(BaO+ZnO) is not more than 30%. The term “8Li₂O−4(Na₂O+K₂O+MgO)—(BaO+ZnO)” used herein refers to a value obtained by subtracting four times the total content of Na₂O, K₂O, and MgO and the total content of Bao and ZnO from eight times the content of Li₂O.

The LAS-based crystallized glass according to the present invention preferably contains, in terms of % by mass, 0.1 to 4% Li₂O and 1 to 10% BaO and satisfies that the value of 8Li₂O−4(Na₂O+K₂O+MgO)—(BaO+ZnO) is 0 to 25%.

The LAS-based crystallized glass according to the present invention preferably contains 2 to 10% BaO in terms of % by mass.

The LAS-based crystallized glass according to the present invention preferably contains more than 0 to less than 0.7% Na₂O+K₂O in terms of % by mass. The term “Na₂O+K₂O” used herein refers to a total content of Na₂O and K₂O.

The LAS-based crystallized glass according to the present invention preferably contains 0.01 to 4% P₂O₅ in terms of % by mass.

The LAS-based crystallized glass according to the present invention preferably contains 0 to less than 900 ppm Fe₂O₃ in terms of % by mass.

The LAS-based crystallized glass according to the present invention preferably contains 0 to 0.2% CaO in terms of % by mass.

The LAS-based crystallized glass according to the present invention preferably satisfies that the value of 8Li₂O−4(Na₂O+K₂O+MgO)—(BaO+ZnO) is 12 to 25% in terms of % by mass.

The LAS-based crystallized glass according to the present invention is preferably substantially free of As₂O₃ and Sb₂O₃.

The LAS-based crystallized glass according to the present invention preferably satisfies that Li₂O/BaO is not more than 2.5 in terms of mass ratio. The term “Li₂O/BaO” used herein refers to a value of the content of Li₂O divided by the content of BaO.

In the LAS-based crystallized glass according to the present invention, (Na₂O+K₂O+MgO)/BaO is preferably not more than 6 in terms of mass ratio. The term “(Na₂O+K₂O+MgO)/BaO” used herein refers to a value of the total content of Na₂O, K₂O, and MgO divided by the content of BaO.

The LAS-based crystallized glass according to the present invention preferably satisfies that (Li₂O+Na₂O+K₂O)/ZrO₂ is not more than 2.5 in terms of mass ratio. The term “(Li₂O+Na₂O+K₂O)/ZrO₂” used herein refers to a value of the total content of Li₂O, Na₂O, and K₂O divided by the content of ZrO₂.

The LAS-based crystallized glass according to the present invention preferably contains 0 to less than 1.1% ZnO in terms of % by mass.

The LAS-based crystallized glass according to the present invention preferably contains 0.1 to 3.47% Li₂O in terms of % by mass and satisfies that the value of 8Li₂O−4(Na₂O+K₂O+MgO)—(BaO+ZnO) is 18 to 25%.

The LAS-based crystallized glass according to the present invention preferably contains 0.1 to 1000 ppm Pr₆O₁₁ in terms of % by mass.

The LAS-based crystallized glass according to the present invention preferably contains 0.1 to 2000 ppm Sm₂O₃ in terms of % by mass.

A LAS-based crystallized glass according to the present invention preferably contains, in terms of % by mass, 55 to 75% SiO₂, 15 to 30% Al₂O₃, 2.5 to 3.55% Li₂O, 0 to 1.1% MgO, 0 to 1.6% CaO, 0.01 to 2.5% TiO₂, 0 to 2.9% ZrO₂, 0 to 2% P₂O₅ , 30 to 2000 ppm Fe₂O₃, and 0 to 1000 ppm V₂O₅ and satisfies that a value of 8Li₂O—4(Na₂O+K₂O+MgO)—(BaO+ZnO) is 0 to 30%.

A LAS-based crystallized glass according to the present invention preferably contains, in terms of % by mass, 55 to 75% SiO₂, 15 to 30% Al₂O₃, 2.0 to 3.49% Li₂O, 2.7 to 10% BaO, 0 to 4% MgO+CaO, 0.01 to 5% TiO₂, 1.3 to 5% ZrO₂, and 30 to 10000 ppm Fe₂O₃ and satisfies that a value of 8Li₂O —4(Na₂O+K₂O+MgO)—(BaO+ZnO) is 10 to 30%.

A LAS-based crystallized glass according to the present invention preferably contains, in terms of % by mass, 55 to 75% SiO₂, 15 to 30% Al₂O₃, 2.0 to 3.55% Li₂O, 2.6 to 10% BaO, 0 to 4% MgO+CaO, 0.01 to 2.5% TiO₂, 0 to 2.9% ZrO₂, 0 to 2% P₂O₅ , and 30 to 10000 ppm Fe₂O₃ and satisfies that a value of 8Li₂O—4(Na₂O+K₂O+MgO)—(BaO+ZnO) is 0 to 30%.

A LAS-based crystallized glass according to the present invention preferably contains, in terms of % by mass, 55 to 68% SiO₂, 15 to 30% Al₂O₃, 2.0 to 3.49% Li₂O, 0 to 2.7% BaO, 1.5 to 5% MgO+CaO, 0.01 to 3.9% TiO₂, 1.4 to 2.9% ZrO₂, 0 to 2.5% P₂O₅ , and 30 to 10000 ppm Fe₂O₃ and satisfies that a value of 8Li₂O—4(Na₂O+K₂O+MgO)—(BaO+ZnO) is 10 to 30%.

The LAS-based crystallized glass according to the present invention preferably has an L* value of total transmittance of not less than 90 at a thickness of 4 mm.

In the LAS-based crystallized glass according to the present invention, a β-quartz solid solution is preferably precipitated as a major crystalline phase.

The LAS-based crystallized glass according to the present invention preferably has a coefficient of thermal expansion of −20×10⁻⁷/° C. to 20×10⁻⁷/° C. at 30 to 750° C.

The present invention relates to a glass production method that is a method for producing any one of the above-described LAS-based crystallized glasses and includes the steps of: melting a glass raw material to obtain a molten glass; forming the molten glass into shape; and subjecting a glass obtained in the step of forming the molten glass into shape to heat treatment to crystallize the glass, wherein a process for forming the molten glass into shape is at least one selected from an overflow process, a float process, a down-draw process, a slot down process, a redraw process, a containerless process, a blow process, a press forming process, a roll process, a bushing process, and a tube draw process.

A crystallizable glass according to the present invention contains, in terms of % by mass, 55 to 75% SiO₂, 10 to 35% Al₂O₃, 0.1 to 5% Li₂0, 0 to 10% BaO, 0 to 10% MgO, 0 to 5% TiO₂, 0 to 5% ZrO₂, and 0 to 5% P₂O₅ and satisfies that a value of 8Li₂O—4(Na₂O+K₂O+MgO)—(Bao+ZnO) is not more than 30%.

### Advantageous Effects of Invention

The present invention enables provision of a LAS-based crystallized glass which has a low coefficient of thermal expansion and excellent transparency and the cost of the raw material batch for which is kept down.

### BRIEF DESCRIPTION OF DRAWINGS

FIG. 1 is a scatter graph on which, for LAS-based crystallized glasses in Examples of the present invention, their coefficients of thermal expansion at 30 to 750° C. are plotted against their values of 8Li₂O—4(Na₂O+K₂O+MgO)—(BaO+ZnO).

### DESCRIPTION OF EMBODIMENTS

First, a description will be given of the glass composition of a LAS-based crystallized glass according to the present invention. Regarding the following contents of components, “%” refers to “% by mass” unless otherwise stated.

SiO₂ is a component forming part of a glass network and also a constituent of a LAS-based crystal. If the content of SiO₂ is too small, the coefficient of thermal expansion tends to increase and, therefore, a crystallized glass having excellent thermal shock resistance is difficult to obtain. In addition, the chemical durability tends to decrease. Therefore, the content of SiO₂ is preferably not less than 55%, not less than 57.5% or not less than 60%, and more preferably not less than 61%. On the other hand, if the content of SiO₂ is too large, the meltability of glass decreases and the viscosity of glass melt increases, which makes the glass difficult to fine and difficult to form into shape and, thus, makes it likely that the productivity decreases. Therefore, the content of SiO₂ is preferably not more than 75%, not more than 72.5%, not more than 70% or not more than 67.5%, and more preferably not more than 65%.

Al₂O₃ is a component forming part of a glass network and also a constituent of a LAS-based crystal. In addition, Al₂O₃ is a component that is located around a crystal nucleus and forms a core-shell structure. Because of the presence of a core-shell structure, a crystal nucleus component is less likely to be supplied from the outside of the shell and, thus, the crystal nuclei are less likely to become enlarged and a large number of fine crystal nuclei are likely to be formed. As a result, fine crystals can be homogeneously precipitated in the glass. Furthermore, Al₂O₃ is also a component that reduces the high-temperature viscosity of the crystallized glass. If the content of Al₂O₃ is too small, the coefficient of thermal expansion tends to increase and, therefore, a crystallized glass having excellent thermal shock resistance is difficult to obtain.

In addition, the chemical durability tends to decrease. Furthermore, the crystal nuclei easily become large and, therefore, the crystallized glass easily becomes cloudy. Therefore, the content of Al₂O₃ is preferably not less than 10%, not less than 12.5%, not less than 15% or not less than 17.5%, and more preferably not less than 20%. On the other hand, if the content of Al₂O₃ is too large, mullite or like crystals tend to precipitate to devitrify the glass and the crystallized glass becomes susceptible to breakage. Therefore, the content of Al₂O₃ is preferably not more than 35%, not more than 32.5%, not more than 30%, not more than 27%, not more than 26% or not more than 25%, and more preferably not more than 24%.

Li₂O is a constituent of a LAS-based crystal and also a component that reduces the viscosity of glass to improve the meltability and formability of the glass. In addition, Li₂O is also a component that easily reduces the refractive index of crystallized glass. If the content of Li₂O is too small, mullite or like crystals tend to precipitate to devitrify the glass. In addition, the meltability of glass decreases and the viscosity of glass melt increases, which makes the glass difficult to fine and difficult to form into shape and, thus, makes it likely that the productivity decreases. Furthermore, LAS-based crystals are less likely to precipitate and, therefore, the coefficient of thermal expansion of crystallized glass tends to increase and a crystallized glass having excellent thermal shock resistance is difficult to obtain. Therefore, the content of Li₂O is preferably not less than 0.1%, not less than 1%, not less than 1.5%, not less than 2%, not less than 2.5% or not less than 2.75%, and more preferably not less than 3%. On the other hand, if the content of Li₂O is too large, the crystallinity becomes excessively high, the glass therefore tends to be likely to devitrify, and the crystallized glass becomes susceptible to breakage. In addition, since Li₂O is an expensive raw material, the cost of the raw material batch becomes high. Therefore, the content of Li₂O is preferably not more than 5%, not more than 4%, not more than 3.9%, not more than 3.8%, not more than 3.75%, not more than 3.7%, not more than 3.65%, not more than 3.6%, not more than 3.55%, not more than 3.5%, not more than 3.49% or not more than 3.47%, and more preferably not more than 3.45%.

Bao is a component that reduces the viscosity of glass to improve the meltability and formability of the glass. Furthermore, Bao is also a component for controlling the coefficient of thermal expansion and refractive index of crystallized glass. More specifically, the incorporation of Bao into glass tends to make the coefficient of thermal expansion of the resultant crystallized glass lower than in the case of incorporation of Na₂O, K₂O or MgO in an equivalent amount of substance (equivalent molar amount). In addition, the liquidus temperature can be easily decreased, the liquidus viscosity can be easily increased, and, therefore, the productivity can be easily secured. Furthermore, Bao tends to suppress the precipitation of mullite when forming crystallizable glass into shape. Mullite and like crystals rapidly grow and are considered to be therefore difficult to remove after formation, for which reason it is preferred to avoid a composition likely to precipitate mullite and like crystals. In addition, the resultant crystallized glass is less colored, scattering in the glass tends to be likely to be small, and, therefore, the crystallized glass can easily obtain a desired transparency. Therefore, the content of Bao is preferably not less than 0%, not less than 0.5%, not less than 1%, not less than 1.5%, not less than 2%, not less than 2.6%, not less than 2.7%, not less than 3%, not less than 3.5%, not less than 3.75%, not less than 4%, not less than 4.1%, not less than 4.2%, not less than 4.3% or not less than 4.4%, and more preferably not less than 4.5%. On the other hand, if the content of Bao is too large, crystals containing Ba precipitate to make the glass easily devitrifiable and therefore make the crystallized glass susceptible to breakage. Therefore, the content of BaO is preferably not more than 10%, not more than 9.5%, not more than 9%, not more than 8.5%, not more than 8%, not more than 7.5%, not more than 7% or not more than 6.5%, and more preferably not more than 6%. A BaO raw material tends to be expensive compared to a MgO raw material and a CaO raw material both of which control the viscosity of glass like BaO. Therefore, in order to further keep down the cost of the raw material batch, the content of BaO may be not more than 4%, not more than 3%, not more than 2.8%, not more than 2.7%, not more than 2.4%, not more than 2.2%, not more than 2% or not more than 1.75%.

Li₂O is a constituent of a LAS-based crystal and also a component that reduces the viscosity of glass to improve the meltability and formability of the glass. If the content of this is too large, the liquidus viscosity becomes excessively low and, therefore, the glass tends to be difficult to form into shape. In addition, the crystallinity becomes excessively high and, therefore, the glass tends to be likely to devitrify. For this reason, the crystallized glass becomes less likely to obtain desired characteristics, such as it becomes susceptible to breakage. On the other hand, Bao is also a component that reduces the viscosity of glass to improve the meltability and formability of the glass, but this effect of Bao tends to be smaller than Li₂O. Furthermore, Bao has the effect of decreasing the liquidus temperature and, therefore, tends to suppress devitrification. For these reasons, in order to obtain a crystallized glass having desired characteristics while suppressing the devitrification of glass and avoiding an excessive reduction in liquidus viscosity, it is preferred to suitably control Li₂O/BaO (the ratio between the content of Li₂O and the content of BaO). Li₂O/BaO is preferably not more than 400, not more than 100, not more than 30, not more than 10, not more than 5, not more than 3, not more than 2.5, not more than 2, not more than 1 or not more than 0.9, more preferably not more than 0.8, preferably not less than 0.05, not less than 0.1 or not less than 0.2, and more preferably not less than 0.3.

MgO is a component that can be incorporated into LAS-based crystals to form a solid solution together and increases the coefficient of thermal expansion of the LAS-based crystals. Therefore, if the content of MgO is too large, the coefficient of thermal expansion tends to be high and, therefore, a crystallized glass having excellent thermal shock resistance is less likely to be obtained. In addition, the crystallinity becomes excessively high and mullite or like crystals are likely to precipitate to devitrify the glass. Therefore, the crystallized glass tends to be likely to become cloudy and likely to be susceptible to breakage. The content of MgO is preferably not more than 10%, not more than 5%, not more than 4%, not more than 3%, not more than 2.5%, not more than 2%, not more than 1.5%, not more than 1.2%, not more than 1.1%, not more than 1%, not more than 0.8%, not more than 0.6%, not more than 0.5% or not more than 0.4%, and more preferably not more than 0.3%. On the other hand, MgO is an inexpensive raw material and can reduce the viscosity of glass at low cost. For this reason, to the extent that the clouding of the crystallized glass and the increase in coefficient of thermal expansion thereof are acceptable, MgO can be incorporated into glass to reduce the viscosity while keeping down the production cost. In addition, MgO is likely to be mixed as impurities into glass during production of the glass. Therefore, if complete removal of MgO is pursued, the cost tends to be high. For this reason, the content of MgO is preferably not less than 0%, not less than 0.001% or not less than 0.005%, and more preferably not less than 0.01%.

CaO is a component that reduces the viscosity of glass to improve the meltability and formability of the glass. Furthermore, Cao is also a component for controlling the coefficient of thermal expansion and refractive index of crystallized glass. If the content of Cao is too large, the crystallized glass is likely to become cloudy and the coefficient of thermal expansion of the crystallized glass is likely to increase. Therefore, the content of Cao is preferably not more than 2%, not more than 1.6%, not more than 1.4%, not more than 1.2%, not more than 1%, not more than 0.5%, not more than 0.2%, not more than 0.15% or not more than 0.1%, and more preferably not more than 0.075%. On the other hand, Cao is likely to be incorporated as impurities into the raw materials. Therefore, if complete removal of Cao is pursued, the cost of the raw material batch is likely to be high. For this reason, the content of CaO is preferably not less than 0%, not less than 0.001%, not less than 0.002% or not less than 0.005%, and more preferably not less than 0.01%.

MgO and CaO are components that improve the meltability and formability of glass. On the other hand, if the total content of them is too large, the crystallized glass is likely to become cloudy and the coefficient of thermal expansion of the crystallized glass is likely to increase. Therefore, MgO+CaO is preferably 0 to 10%, 1.5 to 5%, 0 to 4% or 1 to 4%, and more preferably 1 to 3%. Furthermore, MgO and CaO tend to be inexpensive compared to a BaO raw material that controls the viscosity of glass like MgO and Cao. Therefore, in the case of further keeping down the cost of the raw material batch, the meltability and formability of glass may be improved by incorporating MgO and CaO into the raw material batch while controlling the content of BaO. Hence, the content of Bao is preferably not more than 4%, not more than 3%, not more than 2.8%, not more than 2.6%, not more than 2.4%, not more than 2.2%, not more than 2% or not more than 1.75%, in which case MgO+Cao is preferably not less than 0%, not less than 0.01%, not less than 0.1%, not less than 0.4%, not less than 0.7%, not less than 1%, not less than 1.5% or not less than 2%, and preferably not more than 10%, not more than 5%, not more than 4%, not more than 3% or not more than 2.5%.

TiO₂ is a nucleating component for precipitating crystals in the crystallization process. On the other hand, if TiO₂ is much contained in glass, it significantly intensifies the tinting of the glass. Particularly, zirconia titanate-based crystals containing ZrO₂ and TiO₂ act as crystal nuclei, but electrons transition from the valence band of oxygen serving as a ligand to the conduction bands of zirconium and titanium serving as central metals (LMCT transition), which involves the tinting of crystallized glass. Furthermore, if titanium remains in the residual glass phase, LMCT transition may occur from the valence band of the SiO₂ skeleton to the conduction band of tetravalent titanium in the residual glass phase. In addition, d-d transition occurs in trivalent titanium in the residual glass phase, which involves the tinting of the crystallized glass. In the case where titanium and iron coexist, tinting like ilmenite (FeTiO₃) develops. In another case, it is known that the coexistence of titanium and tin intensifies the yellowish tint of glass. Therefore, the content of TiO₂ is preferably not more than 5%, not more than 4%, not more than 3.9%, not more than 3.8%, not more than 3%, not more than 2.6%, not more than 2.5%, not more than 2.4%, not more than 2.2%, not more than 2.1%, not more than 2% or not more than 1.95%, and more preferably not more than 1.9%. However, since TiO₂ can be a component of crystal nuclei as described above, the incorporation of TiO₂ into glass makes crystal nuclei easy to precipitate in the crystallization process. If the content of TiO₂ is too small, crystal nuclei may not precipitate well in the crystallization process and, thus, coarse β-quartz solid solution may precipitate to make the crystallized glass cloudy. Furthermore, TiO₂ is likely to be mixed as impurities into the glass. Therefore, if complete removal of TiO₂ is pursued, the cost of the raw material batch is likely to be high. For these reasons, the lower limit of the content of TiO₂ is preferably not less than 0%, more than 0%, not less than 0.001%, not less than 0.01%, not less than 0.1%, not less than 1%, not less than 1.2% or not less than 1.4%, and more preferably not less than 1.5%.

ZrO₂ is a nucleating component for precipitating crystals in the crystallization process. If the content of ZrO₂ is too small, crystal nuclei may not be formed well and, thus, coarse crystals may be likely to precipitate, which makes it likely that the resultant crystallized glass becomes cloudy and susceptible to breakage. Therefore, the content of ZrO₂ is preferably not less than 0%, not less than 0.5%, not less than 1%, not less than 1.3%, not less than 1.4% or not less than 1.8%, and more preferably not less than 2%. On the other hand, if the content of ZrO₂ is too large, coarse ZrO₂ crystals precipitate to make the glass easily devitrifiable and make the crystallized glass susceptible to breakage. In addition, the crystallized glass tends to become cloudy. Therefore, the content of ZrO₂ is preferably not more than 5%, not more than 4.5%, not more than 4%, not more than 3.5%, not more than 3% or not more than 2.9%, and more preferably not more than 2.8%.

P₂O₅ is a component that has an effect on the precipitation of crystals and suppresses the precipitation of coarse ZrO₂ crystals. When the crystallized glass contains P₂O₅ , the transmittance of the crystallized glass is improved and the coefficient of thermal expansion thereof tends to be decreased. If the content of P₂O₅ is too small, coarse ZrO₂ crystals precipitate, which may make the glass easily devitrifiable and make the crystallized glass susceptible to breakage. In addition, desired thermal characteristics and transparency may be less likely to be obtained. Therefore, the content of P₂O₅ is preferably not less than 0%, not less than 0.01%, not less than 0.1%, not less than 0.2%, not less than 0.3%, not less than 0.5% or not less than 0.8%, and more preferably not less than 1%. On the other hand, if the content of P₂O₅ is too large, crystallization tends to be excessively suppressed and desired thermal characteristics and transparency may be less likely to be obtained. In addition, the raw material price of P₂O₅ is expensive and, therefore, the larger the content of P₂O₅ is, the higher the cost of the raw material batch tends to be. For these reasons, the content of P₂O₅ is preferably not more than 5%, not more than 4%, not more than 3%, not more than 2.5%, not more than 2% or not more than 1.8%, and more preferably not more than 1.6%.

Na₂O is a component that has an effect on crystallinity and reduces the viscosity of glass to improve the meltability and formability of the glass. Furthermore, Na₂O is also a component for controlling the coefficient of thermal expansion and refractive index of crystallized glass. If the content of Na₂O is too large, the crystallinity becomes excessively high, which makes the glass easily devitrifiable and makes the crystallized glass susceptible to breakage. Furthermore, the ionic radius of a Na cation is large and, therefore, Na cations are less likely to be incorporated into the crystals. Therefore, Na cations after crystallization are likely to remain in the residual glass (glass matrix). For this reason, if the content of Na₂O is too large, a difference in refractive index between the crystalline phase and the residual glass is likely to occur and, therefore, the crystallized glass tends to be likely to become cloudy. Hence, the content of Na₂O is preferably not more than 1%, not more than 0.9%, not more than 0.7%, not more than 0.5%, not more than 0.3% or not more than 0.2%, and more preferably not more than 0.15%. However, Na₂O is likely to be mixed as impurities into the glass. Therefore, if complete removal of Na₂O is pursued, the cost of the raw material batch tends to be high. In order to reduce the increase in the cost of raw material batch, the lower limit of the content of Na₂O is preferably not less than 0%, more preferably not less than 0.0003%, even more preferably not less than 0.0005%, and particularly preferably not less than 0.001%.

K₂O is a component that has an effect on crystallinity and reduces the viscosity of glass to improve the meltability and formability of the glass. Furthermore, K₂O is also a component for controlling the coefficient of thermal expansion and refractive index of crystallized glass. If the content of K₂O is too large, the crystallinity becomes excessively high, which makes the glass easily devitrifiable and makes the crystallized glass susceptible to breakage. Furthermore, the ionic radius of a K cation is large and, therefore, K cations are less likely to be incorporated into the crystals. Therefore, K cations after crystallization are likely to remain in the residual glass. For this reason, if the content of K₂O is too large, a difference in refractive index between the crystalline phase and the residual glass is likely to occur and, therefore, the crystallized glass tends to be likely to become cloudy. Hence, the content of K₂O is preferably not more than 1%, not more than 0.9%, not more than 0.7%, not more than 0.5%, not more than 0.3%, not more than 0.2%, not more than 0.1% or not more than 0.07%, and more preferably not more than 0.04%. However, K₂O is likely to be mixed as impurities into the glass. Therefore, if complete removal of K₂O is pursued, the cost of the raw material batch tends to be high. In order to reduce the increase in the cost of raw material batch, the lower limit of the content of K₂O is preferably not less than 0%, more preferably not less than 0.0003%, even more preferably not less than 0.0005%, and particularly preferably not less than 0.001%.

As described above, Na₂O and K₂O have similar effects in the present invention. Therefore, if the total content of Na₂O and K₂O is too large, the crystallinity becomes excessively high, which makes the glass easily devitrifiable and makes the crystallized glass susceptible to breakage. In addition, a difference in refractive index between the crystalline phase and the residual glass phase is likely to occur and, therefore, the crystallized glass tends to be likely to become cloudy. Hence, Na₂O+K₂O is preferably not more than 2%, not more than 1.5%, not more than 1%, not more than 0.9%, not more than 0.7%, less than 0.7%, not more than 0.6%, not more than 0.5%, not more than 0.4%, not more than 0.3%, not more than 0.2% or not more than 0.17%, and more preferably not more than 0.14%. However, Na₂O and K₂O are likely to be mixed as impurities into the glass. Therefore, if complete removal of them is pursued, the cost of the raw material batch tends to be high. In order to reduce the increase in the cost of raw material batch, the lower limit of Na₂O+K₂O is preferably more than 0%, more preferably not less than 0.0006%, even more preferably not less than 0.001%, and particularly preferably not less than 0.002%.

Although Na₂O, K₂O, and MgO are components that reduce the viscosity of glass to improve the meltability and formability of the glass, if the contents of these components are too large, non-cross-linked oxygen in the glass matrix increases and, therefore, the coefficient of thermal expansion of the resultant crystallized glass is likely to increase. BaO is likewise a component that reduces the viscosity of glass to improve the meltability and formability of glass, but the incorporation of Bao into the glass has a smaller effect of increasing the coefficient of thermal expansion compared to the incorporation of Na₂O, K₂O or MgO in an equivalent amount of substance. Therefore, in order to keep down the coefficient of thermal expansion of the resultant crystallized glass while improving the meltability and formability of glass, (Na₂O+K₂O+MgO)/BaO should preferably be suitably controlled. Specifically, (Na₂O+K₂O+MgO)/BaO is preferably not more than 230, not more than 100, not more than 30, not more than 10, not more than 6, not more than 1, not more than 0.8, not more than 0.7, not more than 0.3, not more than 0.2 or not more than 0.1, more preferably not more than 0.06, preferably not less than 0.003, and more preferably not less than 0.01.

ZnO is, like BaO, a component that reduces the viscosity of glass to improve the meltability and formability of the glass. Furthermore, ZnO is also a component for controlling the coefficient of thermal expansion and refractive index of crystallized glass. If the content of ZnO is too large, crystals containing Zn precipitate to make the glass easily devitrifiable and make the crystallized glass susceptible to breakage and easily clouded. In addition, ZnO tends to be expensive compared to raw materials for components other than Li₂O. Therefore, when the raw material batch contains ZnO, the cost thereof is likely to be high. For these reasons, the content of ZnO is preferably not more than 10%, not more than 8%, not more than 6%, not more than 4%, not more than 3%, not more than 2%, less than 1.1%, not more than 1%, not more than 0.8%, not more than 0.6%, not more than 0.4%, not more than 0.2% or not more than 0.1%, and more preferably not more than 0.05%.

The value of 8Li₂O—4(Na₂O+K₂O+MgO)—(BaO+ZnO) is a value that largely influences the thermal expansion characteristics of the crystallized glass. If this value is too low, the coefficient of thermal expansion of the resultant crystallized glass becomes excessively high and, thus, desired thermal shock resistance tends to be difficult to obtain. Therefore, the above value is preferably not less than −1.5%, not less than 0%, not less than 5%, not less than 6%, not less than 7%, not less than 8%, not less than 9%, not less than 10%, not less than 11%, not less than 12%, not less than 13%, not less than 14%, not less than 15%, not less than 16% or not less than 17%, and more preferably not less than 18%. On the other hand, if this value is too high, not only the cost of the raw material batch becomes high, but also the viscosity of glass melt increases and, thus, the productivity tends to become worse. Therefore, the above value is preferably not more than 30%, not more than 29%, not more than 28%, not more than 27%, not more than 26%, not more than 25%, not more than 24%, not more than 23%, not more than 22%, not more than 21% or not more than 20%, and more preferably not more than 19%.

Although Li₂O, Na₂O, and K₂O are components that improve the meltability and formability of glass, if the contents of these components are too large, the low-temperature viscosity excessively decreases and, thus, the glass may excessively flow during crystallization. Furthermore, Li₂O, Na₂O, and K₂O are components that may deteriorate the weather resistance, water resistance, chemical resistance, and so on of glass before crystallization. If the glass before crystallization is deteriorated by moisture or so on, a desired crystallization behavior and, as a result, desired characteristics may not be obtained. ZrO₂ is a component that functions as a nucleating agent and has the effect of preferentially crystallizing in an initial stage of crystallization to reduce the flow of the residual glass. Furthermore, ZrO₂ has the effect of efficiently filling voids of a glass network principally composed of a SiO₂ skeleton to block the diffusion of protons, various chemical components, and so on in the glass network, thus improving the weather resistance, water resistance, chemical resistance, and so on of glass before crystallization. On the other hand, if the content of ZrO₂ is too large, coarse ZrO₂ crystals precipitate to make the glass easily devitrifiable and make the crystallized glass susceptible to breakage. Therefore, in order to obtain a crystallized glass having a desired shape and desired characteristics while improving the meltability and formability of glass, (Li₂O+Na₂O+K₂O)/ZrO₂ should preferably be suitably controlled. Specifically, (Li₂O+Na₂O+K₂O)/ZrO₂ is preferably not more than 2.5, not more than 2, not more than 1.9, not more than 1.8, not more than 1.7, not more than 1.65, not more than 1.63 or not more than 1.6, particularly preferably not more than 1.58, and preferably not less than 0.5, not less than 0.8, not less than 1, not less than 1.2 or not less than 1.4.

Fe₂O₃ is a component that intensifies the tinting of glass and a component that significantly intensifies the tinting, particularly, by interactions with TiO₂ and SnO₂. Therefore, in order to reduce the tinting of the crystallized glass, the content of Fe₂O₃ is preferably not more than 20000 ppm, not more than 10000 ppm, less than 5000 ppm, less than 3000 ppm, not more than 2000 ppm, not more than 1000 ppm, less than 900 ppm, not more than 700 ppm, not more than 500 ppm, not more than 300 ppm, not more than 200 ppm, not more than 100 ppm, not more than 95 ppm or not more than 85 ppm, and more preferably not more than 80 ppm. However, Fe₂O₃ is likely to be mixed as impurities into the glass. Therefore, if complete removal of Fe₂O₃ is pursued, the cost of the raw material batch is likely to be high. In order to reduce the increase in the cost of raw material batch, the lower limit of the content of Fe₂O₃ is preferably not less than 0.001 ppm, not less than 0.01 ppm, not less than 0.1 ppm, not less than 1 ppm, not less than 10 ppm or not less than 30 ppm, and more preferably not less than 40 ppm.

As₂O₃ and Sb₂O₃ are highly toxic and may contaminate the environment, for example, during the production process of glass or during treatment of waste glass. Therefore, the content of each of these components is preferably not more than 2%, not more than 1%, not more than 0.7%, not more than 0.6%, not more than 0.5%, not more than 0.4%, not more than 0.3%, not more than 0.2% or not more than 0.1%, and the glass is particularly preferably substantially free of them (specifically, the content of each component is less than 0.1% by mass). To the extent that influences on the environment during the production process of glass or during treatment of waste glass are ignorable, As₂O₃ and/or Sb₂O₃ may be incorporated into glass and these components can be allowed to function as an fining agent, a nucleating agent or so on.

PbO is highly toxic and may contaminate the environment, for example, during the production process of glass or during treatment of waste glass. Therefore, the content of each of these components is preferably not more than 2%, not more than 1%, not more than 0.7%, not more than 0.6%, not more than 0.5%, not more than 0.4%, not more than 0.3%, not more than 0.2% or not more than 0.1%, and the glass is particularly preferably substantially free of this component (specifically, the content of this component is less than 0.1% by mass). To the extent that influences on the environment during the production process of glass or during treatment of waste glass are ignorable, PbO may be incorporated into glass and, in doing so, PbO can be allowed to function as a tinting material, an additive for reducing the viscosity or so on.

Sro is a component that reduces the viscosity of glass to improve the meltability and formability of the glass. Furthermore, Sro is also a component for controlling the coefficient of thermal expansion and refractive index of crystallized glass. If the content of Sro is too large, the glass is likely to devitrify and the crystallized glass becomes susceptible to breakage. In addition, because Sro is expensive, if a large amount of Sro is incorporated into raw materials, the raw material cost easily becomes high. Therefore, the content of Sro is not particularly limited, but is preferably not more than 8%, not more than 7%, not more than 6%, not more than 5%, not more than 4%, not more than 3%, not more than 2%, not more than 1% or not more than 0.5%, and more preferably not more than 0.1%. However, Sro is likely to be mixed as impurities into the glass. Therefore, if complete removal of Sro is pursued, the cost of the raw material batch is likely to be high. In order to reduce the increase in the cost of raw material batch, the lower limit of the content of Sro is preferably not less than 0.0001% or not less than 0.0003%, and more preferably not less than 0.0005%.

SnO₂ is a component acting as a fining agent. Furthermore, SnO₂ can be also a component that efficiently precipitates crystals in the crystallization process. If the content of SnO₂ is too small, glass is difficult to fine and, thus, the productivity is likely to decrease. Therefore, the content of SnO₂ is preferably not less than 0%, not less than 0.01%, not less than 0.1% or not less than 0.15%, and more preferably not less than 0.2%. On the other hand, if the content of SnO₂ is too large, the crystallized glass tends to be strongly colored and become cloudy. Furthermore, the amount of SnO₂ evaporated during melting of glass tends to increase to allow the evaporant of SnO₂ to scatter and thus easily contaminate the environment. Therefore, the content of SnO₂ is preferably not more than 3% or not more than 2%, and more preferably not more than 1.5%.

V₂O₅ is a component that, in minute amounts, has an effect on the color of the crystallized glass. If the content of V₂O₅ is too large, a crystallized glass having excellent transparency is less likely to be obtained. Therefore, the content of V₂O₅ is preferably not more than 10000 ppm, not more than 5000 ppm, not more than 1000 ppm or not more than 100 ppm, and more preferably not more than 50 ppm. However, V₂O₅ may be mixed as impurities in raw materials. Therefore, if complete removal of V₂O₅ is pursued, the raw material cost is likely to be high. Therefore, the content of V₂O₅ is preferably not less than 0 ppm, not less than 0.001 ppm, not less than 0.01 ppm or not less than 0.1 ppm, and more preferably not less than 1 ppm.

Pt is a component that can be incorporated in a state of ions, colloid, metal or so on into glass and causes the glass to develop a yellowish to dark brown tint. Furthermore, this tendency is significant after crystallization. Therefore, the content of Pt is preferably not more than 7 ppm, not more than 6 ppm, not more than 5 ppm, not more than 4 ppm, not more than 3 ppm or not more than 2 ppm, and more preferably not more than 1 ppm. Although the incorporation of Pt should be avoided as much as possible, there may be a case where, with the use of general melting facilities, Pt members need to be used in order to obtain a homogeneous glass. Therefore, if complete removal of Pt is pursued, the production cost tends to increase. In the absence of any adverse effect in terms of tinting, in order to reduce the increase in production cost, the lower limit of the content of Pt is preferably not less than 0.0001 ppm, not less than 0.001 ppm, not less than 0.01 ppm, not less than 0.02 ppm, not less than 0.03 ppm, not less than 0.04 ppm, not less than 0.05 ppm or not less than 0.06 ppm, and more preferably not less than 0.07 ppm. Furthermore, so long as the tinting is permitted, Pt may be used as a nucleating agent for promoting the precipitation of the major crystalline phase, as with ZrO₂ or TiO₂. In doing so, Pt may be used alone as a nucleating agent or used as a nucleating agent in combination with another or other components. In using Pt as a nucleating agent, its form (colloid, metallic crystals or so on) is not particularly limited.

Rh is a component that can be incorporated in a state of ions, colloid, metal or so on into glass and tends to cause the glass to develop a yellowish to dark brown tint, like Pt. Therefore, the content of Rh is preferably not more than 7 ppm, not more than 6 ppm, not more than 5 ppm, not more than 4 ppm, not more than 3 ppm, not more than 2 ppm, not more than 1 ppm, not more than 0.9 ppm, not more than 0.8 ppm, not more than 0.7 ppm, not more than 0.6 ppm, not more than 0.5 ppm or not more than 0.4 ppm, and more preferably not more than 0.3 ppm. Although the incorporation of Rh should be avoided as much as possible, there may be a case where, with the use of general melting facilities, Rh members need to be used in order to obtain a homogeneous glass. Therefore, if complete removal of Rh is pursued, the production cost tends to increase. In the absence of any adverse effect in terms of tinting, in order to reduce the increase in production cost, the lower limit of the content of Rh is preferably not less than 0.0001 ppm, not less than 0.001 ppm, not less than 0.01 ppm, not less than 0.02 ppm, not less than 0.03 ppm, not less than 0.04 ppm, not less than 0.05 ppm or not less than 0.06 ppm, and particularly preferably not less than 0.07 ppm.

Furthermore, so long as the tinting is permitted, Rh may be used as a nucleating agent, as with ZrO₂ or TiO₂. In doing so, Rh may be used alone as a nucleating agent or used as a nucleating agent in combination with another or other components. In using Rh as a nucleating agent that promotes precipitation of a major crystalline phase, its form (colloid, metallic crystals or so on) is not particularly limited.

Furthermore, Pt+Rh (the total content of Pt and Rh) is preferably not more than 7 ppm, not more than 3 ppm, less than 1 ppm, less than 0.9 ppm, less than 0.8 ppm, less than 0.7 ppm, less than 0.6 ppm, less than 0.5 ppm or less than 0.4 ppm, and more preferably not more than 0.3 ppm. Although the incorporation of Pt and Rh should be avoided as much as possible, there may be a case where, with the use of general melting facilities, Pt members and Rh members need to be used in order to obtain a homogeneous glass. Therefore, if complete removal of Pt and Rh is pursued, the production cost tends to increase. In the absence of any adverse effect in terms of tinting, in order to reduce the increase in production cost, the lower limit of Pt+Rh is preferably not less than 0.0001 ppm, not less than 0.001 ppm, not less than 0.01 ppm, not less than 0.02 ppm, not less than 0.03 ppm, not less than 0.04 ppm, not less than 0.05 ppm or not less than 0.06 ppm, and more preferably not less than 0.07 ppm.

MoO₃ is an element that, in minute amounts, has an effect on crystallization and the color of the crystallized glass. In the case of LAS crystallized glass, MoO₃ can be considered to have the effect of suppressing the precipitation of β-spodumene solid solution as secondary crystals under given conditions. Therefore, in suppressing the precipitation of β-spodumene solid solution, the content of MoO₃ is preferably more than 0 ppm, not less than 0.1 ppm or not less than 0.2 ppm, and more preferably not less than 0.3 ppm. On the other hand, if MoO₃ is excessively incorporated, the crystallized glass may be colored to impair the design quality. Therefore, from the viewpoint of suppressing the coloration of the crystallized glass, the content of MoO₃ is preferably not more than 100 ppm, not more than 80 ppm, not more than 60 ppm or not more than 40 ppm, and more preferably not more than 20 ppm.

Pr₆O₁₁ is a component that has an effect on the absorption of light in the infrared wavelength range and the coefficient of thermal expansion in the LAS crystallized glass. By incorporating an appropriate amount of Pr₆O₁₁ into glass, the transmittance in wavelengths from near 1300 to near 2300 nm can be adjusted and the LAS crystallized glass can be used, for example, as a glass for adjusting the light intensity of an optical sensor or the like. Furthermore, in comparison between glasses having similar compositions, the larger the amount of Pr₆O₁₁ incorporated is, the lower the coefficient of thermal expansion of the crystallized glass at 30 to 380° C. tends to be. Therefore, the content of Pr₆O₁₁ is preferably not less than 0 ppm, not less than 0.1 ppm, not less than 0.5 ppm, not less than 1 ppm, not less than 10 ppm or not less than 30 ppm. On the other hand, if Pr₆O₁₁ is excessively incorporated, the resultant crystallizable glass and crystallized glass may be strongly colored to impair the design quality. Particularly, if the glass has excessively high light absorption in the infrared wavelength range, when it is used in a product equipped with an optical temperature sensor or the like, light in a particular wavelength range becomes difficult to transmit through the glass, which may cause the sensor to malfunction. Therefore, the content of Pr₆O₁₁ is preferably not more than 2000 ppm, not more than 1000 ppm, not more than 500 ppm, not more than 200 ppm or not more than 100 ppm, and more preferably not more than 50 ppm.

Sm₂O₃ is an element likely to be mixed as impurities into glass, but, so long as it is mixed in a small amount into the LAS crystallized glass according to the present invention, it tends to be less likely to change the characteristics of the crystallized glass. If complete removal of Sm₂O₃ is pursued, the cost of the raw material batch is likely to be high. Therefore, from the viewpoint of reducing the cost of the raw material batch, the content of Sm₂O₃ is preferably not less than 0 ppm, not less than 0.1 ppm, not less than 0.5 ppm, not less than 1 ppm, not less than 10 ppm or not less than 30 ppm. On the other hand, if Sm₂O₃ is excessively incorporated, the glass or the crystallized glass may be strongly colored to impair the design quality. Therefore, the content of Sm₂O₃ is preferably not more than 2000 ppm, not more than 1000 ppm, not more than 500 ppm, not more than 200 ppm or not more than 100 ppm, and more preferably not more than 50 ppm.

The β-OH value largely influences the low-temperature viscosity and crystallization of glass. The β-OH value is preferably not less than 0.01/mm, not less than 0.02/mm, not less than 0.04/mm or not less than 0.06/mm, and more preferably not less than 0.08/mm. When the β-OH value is within the above range, the low-temperature viscosity tends to decrease and the rate of crystallization tends to increase, which enables an increase in production efficiency. On the other hand, if the β-OH value is too high, bubbles are likely to be produced at the interface between the glass and a metallic member for use in melting the glass and, therefore, the quality of a glass product tends to decrease. In addition, depending on the composition, the rate of crystallization becomes excessively high, which causes other kinds of crystals, which would normally not precipitate or would precipitate in infinitesimal quantity, to precipitate and grow. As a result, the light scattering in the crystallized glass may increase and the crystallized glass may easily become cloudy. Therefore, the β-OH value is preferably not more than 2/mm, not more than 1.5/mm, not more than 1/mm, not more than 0.8/mm, not more than 0.7/mm or not more than 0.6/mm, and more preferably not more than 0.5/mm. The β-OH value changes depending on the raw material used, the melting atmosphere, the melting temperature, the melting time, and so on and can be therefore controlled by changing these conditions as necessary. For example, the β-OH value can be increased by increasing the amount of hydroxide in the raw material, melting the raw material by heating it with a burner or raising the melting temperature. Alternatively, the β-OH value can be increased by lengthening the melting time under a sealed condition or shortening the melting time under an unsealed condition.

In the absence of any adverse effect in terms of thermal characteristics and transparency, the LAS crystallized glass according to the present invention may contain, in addition to the above components, minor components, including H₂, CO₂, CO, H₂O, He, Ne, Ar, and N₂, each up to 0.1%. Furthermore, when Ag, Au, Pd, Ir, Cr, Sc, Ce, Pm, Eu, Gd, Tb, Dy, Ho, Er, Tm, Yb, Lu, Ac, Th, Pa, U, and so on are deliberately incorporated into glass, the cost of the raw material batch tends to increase. However, when glass containing Ag, Au or so on is subjected to light irradiation or heat treatment, agglomerates of these components are formed and crystallization can be promoted based on these agglomerates. Moreover, Pd and so on have various catalytic actions. When glass contains these components, the crystallized glass can be given specific functions. In view of the above circumstances, when being aimed at giving the function of promoting crystallization or other functions, the crystallized glass may contain each of the above components in an amount of not more than 1%, not more than 0.5%, not more than 0.3% or not more than 0.1%. Otherwise, the content of each of the above components is preferably not more than 500 ppm, more preferably not more than 300 ppm, even more preferably not more than 100 ppm, and particularly preferably not more than 10 ppm.

Furthermore, in the absence of any adverse effect in terms of thermal characteristics and transparency, the LAS crystallized glass according to the present invention may contain SO₃, MnO, Cl₂, Y₂O₃, La₂O₃, WO₃, HfO₂, Ta₂O₅, Nd₂O₃, Nb₂O₅, RfO₂, and so on up to 10% in total. However, the raw material batch of the above components is expensive and, thus, the production cost tends to increase. Therefore, these components may not be incorporated into glass unless the circumstances are exceptional. Particularly, HfO₂ is expensive and Ta₂O₅ may become a conflict mineral. Therefore, the total content of these components is preferably not more than 5%, not more than 4%, not more than 3%, not more than 2%, not more than 1%, not more than 0.5%, not more than 0.4%, not more than 0.3%, not more than 0.2%, not more than 0.1%, not more than 0.05%, less than 0.05%, not more than 0.049%, not more than 0.048%, not more than 0.047% or not more than 0.046%, and more preferably not more than 0.045%.

The preferred composition range of the LAS-based crystallized glass according to the present invention is 55 to 75% SiO₂, 10 to 35% Al₂O₃, 0.1 to 4% Li₂O, 0 to 10% MgO, 2 to 10% BaO, 0 to 5% TiO₂, 0 to 5% ZrO₂, 0.01 to 4% P₂O₅ , more than 0 to 0.7% Na₂O+K₂O, 0 to less than 900 ppm Fe₂O₃, 0 to 0.2% CaO, and 0 to 25% (8Li₂O—4(Na₂O+K₂O+MgO)—(Bao+ZnO)).

Alternatively, the preferred composition range is 55 to 75% SiO₂, 10 to 35% Al₂O₃, 0.1 to 4% Li₂0, 0 to 10% MgO, 1 to 10% BaO, 0 to 1.1% ZnO, 0 to 5% TiO₂, 0 to 5% ZrO₂, 0 to 5% P₂O₅ , more than 0 to 0.7% Na₂O+K₂O, and 0 to 25% (8Li₂O—4(Na₂O+K₂O+MgO)—(BaO+ZnO)).

Alternatively, the preferred composition range is 55 to 75% SiO₂, 10 to 35% Al₂O₃, 0.1 to 3.47% Li₂O, 0 to 10% MgO, 2 to 10% BaO, 0 to 5% TiO₂, 0 to 5% ZrO₂, 0 to 5% P₂O₅ , 18 to 25% (8Li₂O—4(Na₂O+K₂O+MgO)—(Bao+ZnO)). Alternatively, the LAS-based crystallized glass preferably contains 55 to 75% SiO₂, 15 to 30% Al₂O₃, 2.5 to 3.55% Li₂O, 0 to 10% BaO, 0 to 1.1% MgO, 0 to 1.6% CaO, 0.01 to 2.5% TiO₂, 0 to 2.9% ZrO₂, 0 to 2% P₂O₅ , 30 to 2000 ppm Fe₂O₃, and 0 to 1000 ppm V₂O₅, wherein 8Li₂O—4(Na₂O+K₂O+MgO) —(BaO+ZnO) is preferably 0 to 30%.

Alternatively, the LAS-based crystallized glass preferably contains 55 to 75% SiO₂, 15 to 30% Al₂O₃, 2.0 to 3.49% Li₂O, 2.7 to 10% BaO, 0 to 4% MgO+CaO, 0.01 to 5% TiO₂, 1.3 to 5% ZrO₂, and 30 to 10000 ppm Fe₂O₃, wherein 8Li₂O—4(Na₂O+K₂O+MgO)—(BaO+ZnO) is preferably 10 to 30%. Alternatively, the LAS-based crystallized glass preferably contains 55 to 75% SiO₂, 15 to 30% Al₂O₃, 2.0 to 3.55% Li₂O, 2.6 to 10% BaO, 0 to 4% MgO+CaO, 0.01 to 2.5% TiO₂, 0 to 2.9% ZrO₂, 0 to 2% P₂O₅ , and 30 to 10000 ppm Fe₂O₃, wherein 8Li₂O—4(Na₂O+K₂O+MgO)—(BaO+ZnO) is preferably 0 to 30%.

Alternatively, the LAS-based crystallized glass preferably contains 55 to 68% SiO₂, 15 to 30% Al₂O₃, 2.0 to 3.49% Li₂O, 0 to 2.7% BaO, 1.5 to 5% MgO+CaO, 0.01 to 3.9% TiO₂, 1.4 to 2.9% ZrO₂, 0 to 2.5% P₂O₅ , and 30 to 10000 ppm Fe₂O₃, wherein 8Li₂O—4(Na₂O+K₂O+MgO)—(BaO+ZnO) is preferably 10 to 30%.

Alternatively, the LAS-based crystallized glass preferably contains 55 to 75% SiO₂, 10 to 35% Al₂O₃, 0.1 to 5% Li₂O, 0 to 10% BaO, 0 to 10% MgO, 0 to 5% TiO₂, 0 to 5% ZrO₂, 0 to 5% P₂O₅ , and 10 to 500 ppm Pr₆O₁₁ , wherein 8Li₂O—4(Na₂O+K₂O+MgO)—(BaO+ZnO) is preferably not more than 30%.

When having any of the above compositions, a LAS-based crystallized glass can be easily obtained which has a low coefficient of thermal expansion and excellent transparency and the cost of the raw material batch for which is kept down.

In the LAS crystallized glass according to the present invention, the L* value of total transmittance at a thickness of 4 mm is preferably not less than 70, not less than 75, not less than 80, not less than 85, not less than 90, not less than 91, not less than 92, not less than 92.5, not less than 93 or not less than 93.5, and more preferably not less than 94. If this value is too low, a desired transmittancy cannot be obtained, which may limit the applications of the LAS crystallized glass. In addition, regardless of whether the glass is tinted or not, the transmitted light tends to appear dim.

In the LAS crystallized glass according to the present invention, the a* value of total transmittance at a thickness of 4 mm is preferably within ±5, within ±4, within ±3, within 2.5, within ±2, within ±1.5, within ±1, within ±0.8 or within ±0.6, and more preferably within ±0.5. If this value is too negatively large, the glass tends to appear greenish. If this value is too positively large, the glass tends to appear reddish.

In the LAS crystallized glass according to the present invention, the b* value of total transmittance at a thickness of 4 mm is preferably within ±20, within ±15, within ±10, within ±7, within ±6.5, within ±6, within ±5.5, within ±5.3, within ±5 or within ±4.8, and more preferably within ±4.5. If this value is too negatively large, the glass tends to appear blueish. If this value is too positively large, the glass tends to appear yellowish.

In the LAS crystallized glass according to the present invention, the L* value of diffuse transmittance at a thickness of 4 mm is preferably not more than 20, not more than 15, not more than 10, not more than 8, not more than 6, not more than 5 or not more than 4, and more preferably not more than 3. If the absolute value of this value is too large, the crystallized glass tends to become cloudy.

In the LAS crystallized glass according to the present invention, the a* value of diffuse transmittance at a thickness of 4 mm is preferably within ±5, within ±4, within ±3, within ±2.5, within ±2, within ±1.5, within ±1, within ±0.8 or within ±0.6, and more preferably within ±0.5. If this value is too negatively large, the glass tends to appear greenish. If this value is too positively large, the glass tends to appear reddish.

In the LAS crystallized glass according to the present invention, the b* value of diffuse transmittance at a thickness of 4 mm is preferably within #20, within ±15, within ±10, within ±5, within ±4, within ±3, within £2.5 or within ±2, and more preferably within ±1.5. If this value is too negatively large, the glass tends to appear blueish. If this value is too positively large, the glass tends to appear yellowish.

In the LAS-based crystallized glass according to the present invention, a β-quartz solid solution is preferably precipitated as a major crystalline phase. When a β-quartz solid solution is precipitated as a major crystalline phase, its crystal grain size is likely to be small. Therefore, the crystallized glass easily transmits visible light and the transparency is easily increased. In addition, the coefficient of thermal expansion of the glass can be easily approximated to zero. In the LAS-based crystallized glass according to the present invention, a β-spodumene solid solution is precipitated by subjecting glass to a heat treatment at a higher temperature than under a crystallization condition for precipitating a β-quartz solid solution. The crystal grain size of the β-spodumene solid solution is likely to be larger than that of the β-quartz solid solution and an obtained crystallized glass generally tends to become cloudy. However, when the glass composition and the firing conditions are suitably adjusted, the difference in refractive index between the crystalline phase containing the β-spodumene solid solution and the residual glass phase can be reduced, in which case the crystallized glass is less likely to become cloudy. The LAS-based crystallized glass according to the present invention may contain crystals of a β-spodumene solid solution or the like in the absence of any adverse effect in terms of tinting and so on.

In the LAS crystallized glass according to the present invention, the absolute value of the coefficient of thermal expansion at 30 to 750° C. is preferably not more than 20×10⁻⁷/° C., not more than 15×10⁻⁷/° C., not more than 10×10⁻⁷/° C., not more than 5×10⁻⁷/° C., not more than 4×10⁻⁷/° C., not more than 3×10⁻⁷/° C., not more than 2×10⁻⁷/° C., not more than 1.5×10⁻⁷/0° C. or not more than 1×10⁻⁷/0° C.

In the LAS crystallized glass according to the present invention, the absolute value of the coefficient of thermal expansion at 30 to 380° C. is preferably not more than 20×10⁻⁷/° C., not more than 15×10⁻⁷/° C., not more than 10×10⁻⁷/° C., not more than 5×10⁻⁷/° C., not more than 4×10⁻⁷/° C., not more than 3×10⁻⁷/° C., not more than 2×10⁻⁷/° C., not more than 1.5×10⁻⁷/° C. or not more than 1×10⁻⁷/° C.

If the absolute value of the coefficient of thermal expansion is too high, the thermal shock resistance becomes low, which makes it difficult to use the crystallized glass at high temperatures. In addition, the crystallized glass is difficult to use for applications requiring positional stability. Particularly, in the case where the glass is assumed to be used in a top plate for a cooker, the absolute value of the coefficient of thermal expansion is preferably low in order to avoid breakage due to heat and strain. The upper limit of the absolute value of the coefficient of thermal expansion is not particularly limited, but is actually 50×10⁻⁷/° C. at 30 to 750° C. and at 30 to 380° C.

In the LAS-based crystallized glass according to the present invention, the density thereof is preferably 2.40 to 2.80 g/cm³, 2.42 to 2.78 g/cm³, 2.44 to 2.76 g/cm³ or 2.46 to 2.74 g/cm³, and particularly preferably 2.47 to 2.73 g/cm³. If the density of the crystallized glass is too small, the gas permeability of the crystallized glass may deteriorate. On the other hand, if the density of the crystallized glass is too large, the weight per unit area of the glass becomes large and, therefore, the glass becomes difficult to handle. Furthermore, the density of the crystallized glass provides an indicator for determining whether the glass is well crystallized. Specifically, it can be said that, as for the same type of glass, the larger the density is (the larger the density difference between the glass before being crystallized and the crystallized glass is), the further the crystallization has progressed.

In the LAS-based crystallized glass according to the present invention, the glass transition temperature (the temperature at which the inclination of the thermal expansion curve of glass changes) is preferably not lower than 690° C., not lower than 700° C., not lower than 710° C., not lower than 720° C. or not lower than 730° C., and more preferably not lower than 735° C. If the glass transition temperature is too low, glass excessively flows by the application of heat and, therefore, becomes difficult to form into a desired shape.

In the LAS-based crystallized glass according to the present invention, the deformation point (the temperature at which the inclination of the thermal expansion curve of glass changes above the glass transition temperature) is preferably not lower than 750° C., not lower than 760° C., not lower than 770° C. or not lower than 780° C., and more preferably not lower than 790° C. If the deformation point is too low, glass excessively flows by the application of heat and, therefore, becomes difficult to form into a desired shape.

In the LAS-based crystallized glass according to the present invention, the temperature the viscosity at which corresponds to approximately 10⁴ dPa·s is preferably not higher than 1400° C., not higher than 1390° C., not higher than 1380° C., not higher than 1375° C., not higher than 1370° C. or not higher than 1365° C., and more preferably not higher than 1360° C. If the above temperature is too high, the meltability of glass decreases and the glass becomes difficult to fine, which makes it likely that the productivity decreases. In addition, a forming member tends to be susceptible to load and, therefore, the productivity is likely to decrease.

In the LAS-based crystallized glass according to the present invention, the temperature the viscosity at which corresponds to approximately 10^{3.5} dPa·s is preferably not higher than 1500° C., not higher than 1490° C., not higher than 1480° C., not higher than 1470° C., not higher than 1460° C. or not higher than 1450° C., and more preferably not higher than 1445° C. If the above temperature is too high, the meltability of glass decreases and the glass becomes difficult to fine, which makes it likely that the productivity decreases. In addition, a forming member tends to be susceptible to load and, therefore, the productivity is likely to decrease.

In the LAS-based crystallized glass according to the present invention, the temperature the viscosity at which corresponds to approximately 10³ dPa·s is preferably not higher than 1600° C., not higher than 1590° C., not higher than 1580° C., not higher than 1570° C., not higher than 1560° C., not higher than 1550° C. or not higher than 1545° C., and more preferably not higher than 1540° C. If the above temperature is too high, the meltability of glass decreases and the glass becomes difficult to fine, which makes it likely that the productivity decreases. In addition, a forming member tends to be susceptible to load and, therefore, the productivity is likely to decrease.

In the LAS-based crystallized glass according to the present invention, the temperature the viscosity at which corresponds to approximately 10^{2.5} dPa·s is preferably not higher than 1700° C., not higher than 1690° C., not higher than 1680° C., not higher than 1670° C., not higher than 1660° C. or not higher than 1655° C., and more preferably not higher than 1650° C. If the above temperature is too high, the meltability of glass decreases and the glass becomes difficult to fine, which makes it likely that the productivity decreases.

In the LAS-based crystallized glass according to the present invention, the liquidus temperature (T_{L}) is preferably not higher than 1540° C., not higher than 1535° C., not higher than 1530° C., not higher than 1525° C., not higher than 1520° C., not higher than 1515° C., not higher than 1510° C., not higher than 1505° C., not higher than 1500° C., not higher than 1495° C., not higher than 1490° C., not higher than 1485° C., not higher than 1480° C., not higher than 1475° C., not higher than 1470° C., not higher than 1465° C., not higher than 1460° C., not higher than 1455° C., not higher than 1450° C., not higher than 1445° C., not higher than 1440° C., not higher than 1435° C., not higher than 1430° C., not higher than 1425° C., not higher than 1420° C. or not higher than 1415° C., and particularly preferably not higher than 1410° C. If the liquidus temperature is too high, devitrification is likely to occur during production. On the other hand, when the liquidus temperature is not higher than 1480° C., the glass can be easily produced by a roll process or the like. When the liquidus temperature is not higher than 1450° C., the glass can be easily produced by a casting process or the like. When the liquidus temperature is not higher than 1410° C., the glass can be easily produced by a fusion process or the like.

In the LAS-based crystallized glass according to the present invention, the liquidus viscosity (the logarithmic value logη of the viscosity corresponding to the liquidus temperature) is not less than 2.70, not less than 2.75, not less than 2.80, not less than 2.85, not less than 2.90, not less than 2.95, not less than 3.00, not less than 3.05, not less than 3.10, not less than 3.15, not less than 3.20, not less than 3.25, not less than 3.30, not less than 3.35, not less than 3.40, not less than 3.45, not less than 3.50, not less than 3.55, not less than 3.60 or not less than 3.65, and particularly preferably not less than 3.70. If the liquidus viscosity is too low, devitrification is likely to occur during production. On the other hand, when the liquidus viscosity is not less than 3.40, the glass can be easily produced by a roll process or the like. When the liquidus viscosity is not less than 3.50, the glass can be easily produced by a casting process or the like. When the liquidus viscosity is not less than 3.70, the glass can be easily produced by a fusion process or the like.

The LAS-based crystallized glass according to the present invention may be subjected to chemical strengthening or other treatments. Regarding the conditions for chemical strengthening treatment, the treatment time and treatment temperature are preferably appropriately selected in consideration of the glass composition, the volume fraction of each phase, the type of molten salt, and so on. For example, for the purpose of facilitating chemical strengthening, a glass composition containing a large amount of Na₂O, which is likely to be contained in the residual glass phase, may be selected. For another example, the molten salt may contain a single or multiple types of monovalent cations of Li, Na, K, and so on and divalent cations of Mg, Ba, Zn, Ca, Sr, and so on. For still another example, aside from an ordinary single-step strengthening process, a multistep chemical strengthening process may be selected. The molten salt that can be used is a nitrate (such as potassium nitrate, sodium nitrate or lithium nitrate), a carbonate (such as potassium carbonate, sodium carbonate or lithium carbonate), a sulfate (such as potassium sulfate, sodium sulfate or lithium sulfate), a chloride salt (such as potassium chloride, sodium chloride or lithium chloride) or any combination of them. Among them, a nitrate or so on having a low melting point is preferably used as the molten salt and sodium nitrate is particularly preferably used. The temperature for ion exchange is preferably 330 to 550° C., more preferably 350 to 500° C., and particularly preferably 390 to 450° C., and the time for ion exchange is preferably 30 minutes to 12 hours and more preferably 45 minutes to 10 hours. The above-described conditions for strengthening may be arbitrarily changed depending on the application or strength required and preferred conditions are not necessarily limited to the above.

Next, a description will be given of a method for producing a crystallized glass according to the present invention.

First, a raw material batch prepared to provide a glass having the above-described composition is charged into a glass melting furnace, melted at 1200 to 1800° C., and then formed into shape. In melting glass, one or a combination of two or more of the following melting processes may be used: a flame melting process using a burner or the like; an electric melting process by electrical heating; a melting process using laser irradiation; a melting process using plasma; a solution phase synthesis; and a gas phase synthesis.

The forming process is preferably one or a combination of two or more of an overflow process, a float process, a down-draw process, a slot down process, a redraw process, a containerless process, a blow process, a press forming process, a roll process, a bushing process, and a tube draw process. Furthermore, the formed glass may be reheated at a temperature of the glass transition point or above. By doing so, a glass having a good surface quality can be produced.

Next, the obtained crystallizable glass (a glass that is not yet crystallized and crystallizable) is subjected to heat treatment and thus crystallized. The crystallization conditions are as follows: nucleation is first performed at 700 to 950° C. (preferably 750 to 900° C.) for 0.1 to 100 hours (preferably 1 to 60 hours) and crystal growth is then performed at 800 to 1050° C. (preferably 800 to 1000° C.) for 0.1 to 50 hours (preferably 0.2 to 10 hours). Thus, a transparent LAS-based crystallized glass with β-quartz solid solution crystals precipitated as a major crystalline phase therein can be obtained. The heat treatment may be performed at a specific temperature only, may be performed stepwise by holding the glass in two or more temperature levels or may be performed by the application of heat with a temperature gradient.

Furthermore, the crystallization may be promoted by applying sonic waves or electromagnetic waves to the glass. Moreover, the cooling of the crystallized glass in a high-temperature state may be performed at a cooling rate with a specific temperature gradient or in two or more levels of temperature gradients. In order to obtain a sufficient thermal shock resistance, it is desirable to control the cooling rate to sufficiently structurally relax the residual glass phase. The average cooling rate from 800° C. to 25° C. is, in an innermost portion of the crystallized glass thickness farthest from the surface, preferably not higher than 3000° C./min, not higher than 1000° C./min, not higher than 500° C./min, not higher than 400° C./min, not higher than 300° C./min, not higher than 200° C./min, not higher than 100° C./min, not higher than 50° C./min, not higher than 25° C./min or not higher than 10° C./min, and particularly preferably not higher than 5° C./min. In order to obtain dimensional stability over a long period, the above average cooling rate is preferably not higher than 2.5° C./min, not higher than 1° C./min, not higher than 0.5° C./min, not higher than 0.1° C./min, not higher than 0.05° C./min, not higher than 0.01° C./min, not higher than 0.005° C./min, not higher than 0.001° C./min or not higher than 0.0005° C./min, and particularly preferably not higher than 0.0001° C./min. Except for the case where physical strengthening treatment by air cooing, water cooling or the like is performed, the cooling rate of the crystallized glass at the glass surface and the cooling rate thereof in the innermost portion of the thickness farthest from the glass surface preferably approximate to each other. The value of the cooling rate in the innermost portion of the crystallized glass farthest from the surface thereof divided by the cooling rate at the surface of the crystallized glass is preferably 0.0001 to 1, 0.001 to 1, 0.01 to 1, 0.1 to 1, 0.5 to 1, 0.8 to 1 or 0.9 to 1, and particularly preferably 1. As the above value is closer to 1, residual strain is less likely to occur in all locations of the crystallized glass sample and long-term dimensional stability is more likely to be obtained. The cooling rate at the surface can be estimated by contact thermometry or with a radiation thermometer, while the temperature of the inner portions can be determined by placing the crystallized glass in a high-temperature state into a cooling medium, measuring the heat quantity and rate of heat quantity change of the cooling medium, and making an estimate from the obtained numeric measurement data, and the respective specific heats and the thermal conductivity, and so on of the crystallized glass and the cooling medium.

### EXAMPLES

Hereinafter, the present invention will be described with reference to examples, but the present invention is not limited to the following examples. Tables 1 to 44 show examples (Sample Nos. 1 to 131) of the present invention.

TABLE 1

| | Unit | No. 1 | No. 2 | No. 3 | No. 4 | No. 5 | No. 6 |
|---|---|---|---|---|---|---|---|
| SiO₂ | % by | 63.0 | 61.5 | 63.4 | 63.2 | 65.6 | 64.2 |
| Al₂O₃ | mass | 25.5 | 27.3 | 25.5 | 21.3 | 22.3 | 23.9 |
| Li₂O | | 1.81 | 0.92 | 1.81 | 1.81 | 3.67 | 2.74 |
| Na₂O | | 0.48 | 0.51 | 0.49 | 0.67 | 0.43 | 0.45 |
| K₂O | | 0.34 | 0.35 | 0.34 | 0.47 | 0.30 | 0.32 |
| MgO | | 0.79 | 0.83 | 0.39 | 1.11 | 0.69 | 0.74 |
| CaO | | 0.03 | 0.03 | 0.02 | 0.04 | 0.03 | 0.03 |
| BaO | | 1.39 | 1.46 | 1.38 | 1.94 | 1.20 | 1.29 |
| ZrO₂ | | 2.60 | 2.75 | 2.60 | 3.66 | 2.27 | 2.44 |
| TiO₂ | | 2.29 | 2.42 | 2.28 | 3.22 | 1.99 | 2.14 |
| P₂O₅ | | 1.60 | 1.68 | 1.59 | 2.23 | 1.37 | 1.52 |
| ZnO | | 0 | 0 | 0 | 0 | 0 | 0 |
| SnO₂ | | 0.20 | 0.22 | 0.19 | 0.31 | 0.18 | 0.19 |
| SrO | | 0 | 0 | 0 | 0 | 0 | 0 |
| PbO | | <0.001 | <0.001 | <0.001 | <0.001 | <0.001 | <0.001 |
| Cl | | <0.001 | <0.001 | <0.001 | 0.001 | <0.001 | <0.001 |
| As₂O₃ | | <0.01 | <0.01 | <0.01 | <0.01 | <0.01 | <0.01 |
| Sb₂O₃ | | <0.01 | <0.01 | <0.01 | <0.01 | <0.01 | <0.01 |
| HfO₂ | | 0.03 | 0.03 | 0.03 | 0.03 | 0.04 | 0.04 |
| Fe₂O₃ | ppm | 100 | 110 | 100 | 90 | 100 | 120 |
| MoO₃ | | <0.3 | <0.3 | <0.3 | <0.3 | <0.3 | <0.3 |
| Pt | | 1.00 | 2.00 | unmeasured | unmeasured | unmeasured | unmeasured |
| Rh | | 0.10 | 0.03 | unmeasured | unmeasured | unmeasured | unmeasured |
| V₂O₅ | | unmeasured | unmeasured | unmeasured | unmeasured | unmeasured | unmeasured |
| Nd₂O₃ | | <5 | <5 | <5 | <5 | <5 | <5 |
| Pr₆O₁₁ | | unmeasured | unmeasured | unmeasured | unmeasured | unmeasured | unmeasured |
| Sm₂O₃ | | unmeasured | unmeasured | unmeasured | unmeasured | unmeasured | unmeasured |
| Li₂O/BaO | — | 1.30 | 0.63 | 1.31 | 0.93 | 3.06 | 2.12 |
| Na₂O + K₂O | % by | 0.82 | 0.86 | 0.83 | 1.14 | 0.73 | 0.77 |
| | mass | | | | | | |
| MgO + CaO | % by | 0.82 | 0.86 | 0.41 | 1.15 | 0.72 | 0.77 |
| | mass | | | | | | |
| (Na₂O + K₂O + MgO)/BaO | — | 1.16 | 1.16 | 0.88 | 1.16 | 1.18 | 1.17 |
| 8Li₂O − 4(Na₂O + K₂O + MgO) − (BaO + ZnO) | % by | 6.65 | −0.86 | 8.22 | 3.54 | 22.48 | 14.59 |
| | mass | | | | | | |
| (Li₂O + Na₂O + K₂O)/ZrO₂ | — | 1.01 | 0.65 | 1.02 | 0.81 | 1.94 | 1.44 |

TABLE 2

| | | | | | | |
|---|---|---|---|---|---|---|
| Unit | No. 1 | No. 2 | No. 3 | No. 4 | No. 5 | No. 6 |

Before Crystallization

| | | | | | | | |
|---|---|---|---|---|---|---|---|
| β-OH | /mm | 0.10 | 0.10 | 0.10 | 0.10 | 0.10 | 0.10 |
| Density | g/cm³ | 2.47 | 2.48 | 2.46 | 2.48 | 2.43 | unmeasured |
| CLTE at 30-380° C. | ×10⁻⁷/° C. | 29.8 | 26.4 | 29.1 | unmeasured | 40.7 | 34.2 |
| Glass Transition Point Tg | ° C. | 763 | 803 | 771 | unmeasured | 695 | 740 |
| Deformation Point Tf | | 821 | 848 | 824 | unmeasured | 758 | 800 |
| 10⁴ | | unmeasured | unmeasured | unmeasured | 1372 | 1340 | 1356 |
| 10^{3.5} | | 1477 | unmeasured | 1531 | 1440 | 1423 | 1425 |
| 10³ | | 1522 | unmeasured | 1554 | 1524 | 1520 | 1512 |
| 10^{2.5} | | 1614 | unmeasured | 1623 | 1629 | 1632 | 1626 |
| Liquidus Temperature TL | | >1550 | >1580 | >1550 | 1433 | 1356 | 1490 |
| Liquidus Viscosity log η | — | unmeasured | unmeasured | unmeasured | 3.55 | 3.9 | 3.11 |
| Primary Phase | — | unmeasured | unmeasured | unmeasured | mullite, | mullite, | mullite |
| | | | | | ZrO₂ | ZrO₂ | |

After Crystallization

| | | | | | | | |
|---|---|---|---|---|---|---|---|
| Crystallization Conditions | — | 780° C.-3 h | 780° C.-3 h | 780° C.-3 h | 780° C.-3 h | 780° C.-3 h | 780° C.-3 h |
| | | 950° C.-1 h | 950° C.-1 h | 950° C.-1 h | 950° C.-1 h | 950° C.-1 h | 950° C.-1 h |
| Precipitated Crystals | — | β-quartz | unmeasured | β-quartz | β-quartz | unmeasured | unmeasured |
| Crystallinity | % | 60 | unmeasured | 44 | 68 | unmeasured | unmeasured |
| Crystallite Size | nm | unmeasured | unmeasured | unmeasured | unmeasured | unmeasured | unmeasured |
| Density | g/cm³ | 2.58 | 2.56 | 2.55 | 2.60 | 2.54 | 2.59 |
| CLTE at 30-380° C. | ×10⁻⁷/° C. | unmeasured | unmeasured | unmeasured | unmeasured | unmeasured | unmeasured |
| CLTE at 30-750° C. | | unmeasured | unmeasured | unmeasured | unmeasured | unmeasured | 15.7 |
| Total Transmittance L* | — | unmeasured | unmeasured | unmeasured | unmeasured | unmeasured | unmeasured |
| Total Transmittance a* | | unmeasured | unmeasured | unmeasured | unmeasured | unmeasured | unmeasured |
| Total Transmittance b* | | unmeasured | unmeasured | unmeasured | unmeasured | unmeasured | unmeasured |
| Diffuse Transmittance L* | | unmeasured | unmeasured | unmeasured | unmeasured | unmeasured | unmeasured |
| Diffuse Transmittance a* | | unmeasured | unmeasured | unmeasured | unmeasured | unmeasured | unmeasured |
| Diffuse Transmittance b* | | unmeasured | unmeasured | unmeasured | unmeasured | unmeasured | unmeasured |
| Total Transmittance at 4 mm | | unmeasured | unmeasured | unmeasured | unmeasured | unmeasured | unmeasured |
| thickness and 1500 nm wavelength | | | | | | | |

TABLE 3

| | Unit | No. 7 | No. 8 | No. 9 | No. 10 | No. 11 | No. 12 |
|---|---|---|---|---|---|---|---|
| SiO₂ | % by | 63.5 | 64.0 | 65.2 | 65.5 | 66.7 | 69.0 |
| Al₂O₃ | mass | 21.5 | 21.7 | 22.1 | 21.7 | 22.1 | 21.9 |
| Li₂O | | 1.82 | 1.84 | 1.87 | 3.17 | 3.19 | 3.16 |
| Na₂O | | 0.68 | 0.67 | 0.42 | 0.35 | 0.06 | 0.07 |
| K₂O | | 0.48 | 0.48 | 0.29 | 1.65 | 0.01 | 0.01 |
| MgO | | 1.32 | 1.65 | 3.08 | 0.65 | 1.96 | 0.00 |
| CaO | | 0.05 | 0.06 | 0.09 | 0.03 | 0.05 | 0.01 |
| BaO | | 1.15 | 0.02 | 1.18 | 1.15 | 0.01 | 0.02 |
| ZrO₂ | | 3.68 | 3.72 | 2.25 | 2.20 | 2.25 | 2.22 |
| TiO₂ | | 3.24 | 3.27 | 1.97 | 1.91 | 1.96 | 1.94 |
| P₂O₅ | | 2.28 | 2.31 | 1.41 | 1.39 | 1.43 | 1.42 |
| ZnO | | 0 | 0 | 0 | 0 | 0 | 0 |
| SnO₂ | | 0.30 | 0.31 | 0.19 | 0.29 | 0.29 | 0.29 |
| SrO | | 0.002 | <0.001 | 0.002 | 0.001 | <0.001 | 0.002 |
| PbO | | <0.001 | <0.001 | <0.001 | <0.001 | <0.001 | <0.001 |
| Cl | | <0.001 | <0.001 | <0.001 | 0.001 | <0.001 | <0.001 |
| As₂O₃ | | <0.01 | <0.01 | <0.01 | <0.01 | <0.01 | <0.01 |
| Sb₂O₃ | | <0.01 | <0.01 | <0.01 | <0.01 | <0.01 | <0.01 |
| HfO₂ | | 0.04 | 0.04 | 0.03 | 0.03 | 0.03 | 0.03 |
| Fe₂O₃ | ppm | 120 | 140 | 80 | 100 | 70 | 70 |
| MoO₃ | | <0.3 | <0.3 | <0.3 | <0.3 | <0.3 | <0.3 |
| Pt | | unmeasured | unmeasured | unmeasured | unmeasured | unmeasured | unmeasured |
| Rh | | unmeasured | unmeasured | unmeasured | unmeasured | unmeasured | unmeasured |
| V₂O₅ | | unmeasured | unmeasured | unmeasured | unmeasured | 1.00 | 3.00 |
| Nd₂O₃ | | <5 | <5 | <5 | <5 | <5 | <5 |
| Pr₆O₁₁ | | unmeasured | unmeasured | unmeasured | unmeasured | unmeasured | unmeasured |
| Sm₂O₃ | | unmeasured | unmeasured | unmeasured | unmeasured | unmeasured | unmeasured |
| Li₂O/BaO | — | 1.58 | 92 | 1.58 | 2.76 | 319 | 158 |
| Na₂O + K₂O | % by | 1.16 | 1.15 | 0.71 | 2.00 | 0.07 | 0.08 |
| | mass | | | | | | |
| MgO + CaO | % by | 1.37 | 1.71 | 3.17 | 0.68 | 2.01 | 0.01 |
| | mass | | | | | | |
| (Na₂O + K₂O + MgO)/BaO | — | 2.16 | 140.00 | 3.21 | 2.30 | 203.00 | 4.00 |
| 8Li₂O − 4(Na₂O + K₂O + MgO) − (BaO + ZnO) | % by | 3.49 | 3.50 | −1.38 | 13.61 | 17.39 | 24.94 |
| | mass | | | | | | |
| (Li₂O + Na₂O + K₂O)/ZrO₂ | — | 0.81 | 0.80 | 1.15 | 2.35 | 1.45 | 1.46 |

TABLE 4

| | | | | | | |
|---|---|---|---|---|---|---|
| Unit | No. 7 | No. 8 | No .9 | No. 10 | No. 11 | No. 12 |

Before Crystallization

| | | | | | | | |
|---|---|---|---|---|---|---|---|
| β-OH | /mm | 0.10 | 0.10 | 0.10 | 0.10 | 0.10 | 0.10 |
| Density | g/cm³ | unmeasured | unmeasured | unmeasured | 2.43 | 2.43 | 2.39 |
| CLTE at 30-380° C. | ×10⁻⁷/° C. | unmeasured | unmeasured | 32.0 | 40.2 | 35.1 | 32.0 |
| Glass Transition Point Tg | ° C. | unmeasured | unmeasured | 740 | 724 | 728 | 753 |
| Deformation Point Tf | | unmeasured | unmeasured | 802 | 787 | 783 | 814 |
| 10⁴ | | 1351 | 1348 | 1337 | 1366 | 1338 | 1397 |
| 10^{3.5} | | 1431 | 1426 | 1417 | 1451 | 1421 | 1480 |
| 10³ | | 1523 | 1518 | 1509 | 1550 | 1517 | 1577 |
| 10^{2.5} | | 1630 | 1628 | 1618 | 1665 | 1629 | 1694 |
| Liquidus Temperature TL | | unmeasured | unmeasured | 1440 | 1361 | 1355 | 1485 |
| Liquidus Viscosity log η | — | unmeasured | unmeasured | 3.36 | 4.03 | 3.89 | 3.47 |
| Primary Phase | — | unmeasured | unmeasured | mullite | ZrO₂ | mullite | mullite |

After Crystallization

| | | | | | | | |
|---|---|---|---|---|---|---|---|
| Crystallization Conditions | — | 780° C.-3 h | 780° C.-3 h | 780° C.-3 h | 780° C.-3 h | 780° C.-3 h | 780° C.-3 h |
| | | 950° C.-1 h | 950° C.-1 h | 950° C.-1 h | 950° C.-1 h | 920° C.-1 h | 950° C.-1 h |
| Precipitated Crystals | — | unmeasured | unmeasured | unmeasured | β-quartz | β-quartz | β-quartz |
| Crystallinity | % | unmeasured | unmeasured | unmeasured | unmeasured | unmeasured | unmeasured |
| Crystallite Size | nm | 58 | 41 | unmeasured | 48 | 38 | 36 |
| Density | g/cm³ | 2.59 | 2.59 | 2.59 | 2.50 | 2.55 | 2.56 |
| CLTE at 30-380° C. | ×10⁻⁷/° C. | unmeasured | unmeasured | unmeasured | 8.2 | 7.7 | 7.7 |
| CLTE at 30-750° C. | | unmeasured | unmeasured | unmeasured | 9.6 | 7.4 | 2.0 |
| Total Transmittance L* | — | unmeasured | unmeasured | unmeasured | unmeasured | 93.8 | 93.8 |
| Total Transmittance a* | | unmeasured | unmeasured | unmeasured | unmeasured | −0.7 | -0.4 |
| Total Transmittance b* | | unmeasured | unmeasured | unmeasured | unmeasured | 5.5 | 4.9 |
| Diffuse Transmittance L* | | unmeasured | unmeasured | unmeasured | unmeasured | 8.4 | unmeasured |
| Diffuse Transmittance a* | | unmeasured | unmeasured | unmeasured | unmeasured | −0.1 | unmeasured |
| Diffuse Transmittance b* | | unmeasured | unmeasured | unmeasured | unmeasured | −0.9 | unmeasured |
| Total Transmittance at 4 mm | | unmeasured | unmeasured | unmeasured | 90.3 | 89.1 | 89.9 |
| thickness and 1500 nm wavelength | | | | | | | |

TABLE 5

| | Unit | No. 13 | No. 14 | No. 15 | No. 16 | No. 17 | No. 18 |
|---|---|---|---|---|---|---|---|
| SiO₂ | % by | 64.7 | 66.9 | 67.7 | 67.5 | 67.1 | 65.6 |
| Al₂O₃ | mass | 26.3 | 22.0 | 22.2 | 22.0 | 21.8 | 22.4 |
| Li₂O | | 3.10 | 3.16 | 3.15 | 3.13 | 3.10 | 3.64 |
| Na₂O | | 0.08 | 0.06 | 0.07 | 0.07 | 0.07 | 0.32 |
| K₂O | | 0.01 | 0.01 | 0.01 | 0.01 | 1.11 | 0.20 |
| MgO | | 0.00 | 1.95 | 0.98 | 0.49 | 0.01 | 0.70 |
| CaO | | 0.01 | 0.05 | 0.03 | 0.02 | 0.01 | 0.03 |
| BaO | | 0.02 | 0.01 | 0.01 | 0.01 | 0.01 | 1.21 |
| ZrO₂ | | 2.18 | 2.25 | 2.24 | 2.23 | 2.21 | 2.27 |
| TiO₂ | | 1.90 | 1.95 | 1.93 | 2.89 | 2.85 | 1.99 |
| P₂O₅ | | 1.38 | 1.42 | 1.42 | 1.41 | 1.40 | 1.41 |
| ZnO | | 0 | 0 | 0 | 0 | 0 | 0 |
| SnO₂ | | 0.28 | 0.29 | 0.28 | 0.28 | 0.28 | 0.27 |
| SrO | | <0.001 | 0.002 | 0.002 | 0.002 | 0.004 | 0.004 |
| PbO | | <0.001 | <0.001 | <0.001 | <0.001 | <0.001 | <0.001 |
| Cl | | <0.001 | <0.001 | <0.001 | <0.001 | <0.001 | <0.001 |
| As₂O₃ | | <0.01 | <0.01 | <0.01 | <0.01 | <0.01 | <0.01 |
| Sb₂O₃ | | <0.01 | <0.01 | <0.01 | <0.01 | <0.01 | <0.01 |
| HfO₂ | | 0.03 | 0.03 | 0.03 | 0.03 | 0.07 | 0.04 |
| Fe₂O₃ | ppm | 70 | 100 | 90 | 80 | 300 | 80 |
| MoO₃ | | <0.3 | <0.3 | <0.3 | <0.3 | 5.00 | <0.3 |
| Pt | | unmeasured | unmeasured | unmeasured | unmeasured | unmeasured | unmeasured |
| Rh | | unmeasured | unmeasured | unmeasured | unmeasured | unmeasured | unmeasured |
| V₂O₅ | | 2.00 | unmeasured | unmeasured | unmeasured | unmeasured | 1.00 |
| Nd₂O₃ | | <5 | <5 | <5 | <5 | <5 | <5 |
| Pr₆O₁₁ | | unmeasured | unmeasured | unmeasured | unmeasured | unmeasured | 1.00 |
| Sm₂O₃ | | unmeasured | unmeasured | unmeasured | unmeasured | unmeasured | <1 |
| Li₂O/BaO | — | 155.00 | 316.00 | 315.00 | 313.00 | 310.00 | 3.01 |
| Na₂O + K₂O | % by | 0.09 | 0.0 | 0.08 | 0.08 | 1.18 | 0.52 |
| | mass | | | | | | |
| MgO + CaO | % by | 0.01 | 2.00 | 1.01 | 0.51 | 0.02 | 0.73 |
| | mass | | | | | | |
| (Na₂O + K₂O + MgO)/BaO | — | 4.50 | 202.00 | 106.00 | 57.00 | 119.00 | 1.01 |
| 8Li₂O − 4(Na₂O + K₂O + MgO) − (BaO + ZnO) | % by | 24.42 | 17.19 | 20.95 | 22.75 | 20.03 | 23.03 |
| | mass | | | | | | |
| (Li₂O + Na₂O + K₂O)/ZrO₂ | — | 1.46 | 1.44 | 1.44 | 1.44 | 1.94 | 1.83 |

TABLE 6

| | | | | | | |
|---|---|---|---|---|---|---|
| Unit | No. 13 | No. 14 | No. 15 | No. 16 | No. 17 | No. 18 |

Before Crystallization

| | | | | | | | |
|---|---|---|---|---|---|---|---|
| β-OH | /mm | 0.10 | 0.10 | 0.10 | 0.10 | 0.10 | 0.10 |
| Density | g/cm³ | 2.43 | 2.43 | 2.41 | 2.41 | 2.40 | 2.44 |
| CLTE at 30-380° C. | ×10⁻⁷/° C. | 32.2 | unmeasured | 33.7 | unmeasured | unmeasured | unmeasured |
| Glass Transition Point Tg | ° C. | 754 | unmeasured | 736 | unmeasured | unmeasured | unmeasured |
| Deformation Point Tf | | 813 | unmeasured | 791 | unmeasured | unmeasured | unmeasured |
| 10⁴ | | unmeasured | unmeasured | 1364 | 1366 | unmeasured | 1348 |
| 10^{3.5} | | unmeasured | unmeasured | 1447 | 1450 | unmeasured | 1432 |
| 10³ | | unmeasured | unmeasured | 1545 | 1547 | unmeasured | 1529 |
| 10^{2.5} | | unmeasured | unmeasured | 1660 | 1660 | unmeasured | 1642 |
| Liquidus Temperature TL | | >1500 | 1403 | 1398 | 1408 | 1448 | 1359 |
| Liquidus Viscosity log η | — | unmeasured | 3.58 | 3.79 | 3.74 | 3.52 | 3.93 |
| Primary Phase | — | mullite | mullite | mullite | mullite | mullite | ZrO₂ |

After Crystallization

| | | | | | | | |
|---|---|---|---|---|---|---|---|
| Crystallization Conditions | — | 780° C.-3 h | 780° C.-3 h | 780° C.-3 h | 780° C.-3 h | 780° C.-3 h | 780° C.-3 h |
| | | 920° C.-1 h | 890° C.-1 h | 920° C.-1 h | 920° C.-1 h | 890° C.-1 h | 890° C.-1 h |
| Precipitated Crystals | — | β-quartz | β-quartz | β-quartz | β-quartz | β-quartz | unmeasured |
| Crystallinity | % | unmeasured | unmeasured | unmeasured | unmeasured | unmeasured | unmeasured |
| Crystallite Size | nm | 74 | 37 | 38 | 35 | 47 | unmeasured |
| Density | g/cm³ | 2.45 | 2.54 | 2.54 | 2.54 | 2.47 | 2.53 |
| CLTE at 30-380° C. | ×10⁻⁷/° C. | 4.0 | 5.6 | 2.8 | 2.6 | 5.6 | −1.7 |
| CLTE at 30-750° C. | | 3.2 | 5.6 | 2.1 | 2.3 | 7.6 | −0.4 |
| Total Transmittance L* | — | unmeasured | 94.3 | 94.1 | 92.1 | unmeasured | 94.3 |
| Total Transmittance a* | | unmeasured | −0.8 | −0.5 | −0.5 | unmeasured | −0.6 |
| Total Transmittance b* | | unmeasured | 5.5 | 4.9 | 8.4 | unmeasured | 5.1 |
| Diffuse Transmittance L* | | unmeasured | 0.8 | 3.4 | 8.9 | unmeasured | 1.5 |
| Diffuse Transmittance a* | | unmeasured | 0.0 | 0.2 | 1.1 | unmeasured | 0.1 |
| Diffuse Transmittance b* | | unmeasured | −1.0 | −5.6 | −12.5 | unmeasured | −2.2 |
| Total Transmittance at 4 mm | | 91.4 | 90.1 | 90.1 | 90.3 | 89.9 | 90.6 |
| thickness and 1500 nm wavelength | | | | | | | |

TABLE 7

| | Unit | No. 19 | No. 20 | No. 21 | No. 22 | No. 23 | No. 24 |
|---|---|---|---|---|---|---|---|
| SiO₂ | % by | 65.7 | 65.8 | 65.8 | 66.3 | 66.1 | 65.8 |
| Al₂O₃ | mass | 22.2 | 22.2 | 22.2 | 22.5 | 22.4 | 22.3 |
| Li₂O | | 3.50 | 3.50 | 3.49 | 3.27 | 3.26 | 3.24 |
| Na₂O | | 0.38 | 0.39 | 0.38 | 0.08 | 0.08 | 0.09 |
| K₂O | | 0.27 | 0.01 | 0.14 | 0.01 | 0.01 | 0.01 |
| MgO | | 0.85 | 0.70 | 0.77 | 1.59 | 1.43 | 1.27 |
| CaO | | 0.03 | 0.03 | 0.03 | 0.04 | 0.04 | 0.04 |
| BaO | | 1.21 | 1.48 | 1.34 | 0.24 | 0.82 | 1.39 |
| ZrO₂ | | 2.27 | 2.27 | 2.26 | 2.28 | 2.27 | 2.27 |
| TiO₂ | | 1.98 | 1.98 | 1.98 | 1.99 | 1.98 | 1.97 |
| P₂O₅ | | 1.38 | 1.37 | 1.38 | 1.40 | 1.39 | 1.38 |
| ZnO | | 0 | 0 | 0 | 0 | 0 | 0 |
| SnO₂ | | 0.27 | 0.27 | 0.27 | 0.27 | 0.27 | 0.27 |
| SrO | | 0.004 | 0.004 | 0.004 | 0.001 | 0.002 | 0.003 |
| PbO | | <0.001 | <0.001 | <0.001 | <0.001 | <0.001 | <0.001 |
| Cl | | <0.001 | <0.001 | <0.001 | 0.001 | <0.001 | <0.001 |
| As₂O₃ | | <0.01 | <0.01 | <0.01 | <0.01 | <0.01 | <0.01 |
| Sb₂O₃ | | <0.01 | <0.01 | <0.01 | <0.01 | <0.01 | <0.01 |
| HfO₂ | | 0.04 | 0.04 | 0.04 | 0.03 | 0.03 | 0.03 |
| Fe₂O₃ | ppm | 80 | 80 | 80 | 90 | 90 | 90 |
| MoO₃ | | <0.3 | <0.3 | <0.3 | <0.3 | <0.3 | <0.3 |
| Pt | | unmeasured | unmeasured | unmeasured | unmeasured | unmeasured | unmeasured |
| Rh | | unmeasured | unmeasured | unmeasured | unmeasured | unmeasured | unmeasured |
| V₂O₅ | | 2.00 | unmeasured | unmeasured | 2.00 | 2.00 | 2.00 |
| Nd₂O₃ | | <5 | <5 | <5 | <5 | <5 | <5 |
| Pr₆O₁₁ | | 1.00 | 1.00 | 1.00 | unmeasured | unmeasured | unmeasured |
| Sm₂O₃ | | <1 | <1 | <1 | unmeasured | unmeasured | unmeasured |
| Li₂O/BaO | — | 2.89 | 2.36 | 2.60 | 13.63 | 3.98 | 2.33 |
| Na₂O + K₂O | % by | 0.65 | 0.40 | 0.52 | 0.09 | 0.09 | 0.10 |
| | mass | | | | | | |
| MgO + CaO | % by | 0.88 | 0.73 | 0.80 | 1.63 | 1.47 | 1.31 |
| | mass | | | | | | |
| (Na₂O + K₂O + MgO)/BaO | — | 1.24 | 0.74 | 0.96 | 7.00 | 1.85 | 0.99 |
| 8Li₂O − 4(Na₂O + K₂O + MgO) − (BaO + ZnO) | % by | 20.79 | 22.12 | 21.42 | 19.20 | 19.18 | 19.05 |
| | mass | | | | | | |
| (Li₂O + Na₂O + K₂O)/ZrO₂ | — | 1.83 | 1.72 | 1.77 | 1.47 | 1.48 | 1.47 |

TABLE 8

| | | | | | | |
|---|---|---|---|---|---|---|
| Unit | No. 19 | No. 20 | No. 21 | No. 22 | No. 23 | No. 24 |

Before Crystallization

| | | | | | | | |
|---|---|---|---|---|---|---|---|
| β-OH | /mm | 0.10 | 0.10 | 0.10 | 0.10 | 0.10 | 0.10 |
| Density | g/cm³ | 2.44 | 2.44 | 2.44 | 2.43 | 2.44 | 2.44 |
| CLTE at 30-380° C. | ×10⁻⁷/° C. | 39.7 | 39.1 | unmeasured | unmeasured | unmeasured | unmeasured |
| Glass Transition Point Tg | ° C. | 715 | 725 | unmeasured | unmeasured | unmeasured | unmeasured |
| Deformation Point Tf | | 777 | 785 | unmeasured | unmeasured | unmeasured | unmeasured |
| 10⁴ | | 1337 | 1345 | 1345 | 1337 | unmeasured | unmeasured |
| 10^{3.5} | | 1421 | 1428 | 1429 | 1420 | unmeasured | unmeasured |
| 10³ | | 1517 | 1525 | 1526 | 1515 | unmeasured | unmeasured |
| 10^{2.5} | | 1629 | 1638 | 1639 | 1627 | unmeasured | unmeasured |
| Liquidus Temperature TL | | 1363 | 1358 | 1353 | 1373 | 1362 | 1363 |
| Liquidus Viscosity log η | — | 3.84 | 3.92 | 3.95 | 3.77 | 3.85 | 3.86 |
| Primary Phase | — | ZrO₂ | ZrO₂ | ZrO₂ | mullite | mullite | mullite |

After Crystallization

| | | | | | | | |
|---|---|---|---|---|---|---|---|
| Crystallization Conditions | — | 780° C.-3 h | 780° C.-3 h | 780° C.-3 h | 780° C.-3 h | 780° C.-3 h | 780° C.-3 h |
| | | 890° C.-1 h | 890° C.-1 h | 890° C.-1 h | 890° C.-1 h | 890° C.-1 h | 890° C.-1 h |
| Precipitated Crystals | — | unmeasured | unmeasured | unmeasured | β-quartz | β-quartz | β-quartz |
| Crystallinity | % | unmeasured | unmeasured | unmeasured | unmeasured | unmeasured | unmeasured |
| Crystallite Size | nm | unmeasured | unmeasured | unmeasured | 37 | 37 | 37 |
| Density | g/cm³ | 2.53 | 2.54 | 2.53 | 2.55 | 2.55 | 2.55 |
| CLTE at 30-380° C. | ×10⁻⁷/° C. | 0.0 | −1.5 | −0.4 | 4.4 | unmeasured | unmeasured |
| CLTE at 30-750° C. | | 1.5 | −0.5 | 0.8 | 4.0 | unmeasured | unmeasured |
| Total Transmittance L* | — | 94.1 | 94.3 | 94.1 | 93.7 | 94.0 | 94.1 |
| Total Transmittance a* | | −0.7 | −0.7 | −0.6 | −0.6 | −0.6 | −0.5 |
| Total Transmittance b* | | 5.6 | 5.2 | 5.4 | 5.9 | 5.5 | 5.2 |
| Diffuse Transmittance L* | | 2.0 | 1.3 | 1.6 | 1.2 | 2.2 | 1.2 |
| Diffuse Transmittance a* | | 0.2 | 0.0 | 0.1 | 0.2 | 0.1 | 0.1 |
| Diffuse Transmittance b* | | −3.8 | −2.0 | −2.6 | −2.0 | −2.5 | −1.8 |
| Total Transmittance at 4 mm | | 90.4 | 90.4 | 90.4 | 90.3 | 90.1 | 89.9 |
| thickness and 1500 nm wavelength | | | | | | | |

TABLE 9

| | Unit | No. 25 | No. 26 | No. 27 | No. 28 | No. 29 | No. 30 |
|---|---|---|---|---|---|---|---|
| SiO₂ | % by | 65.5 | 65.8 | 66.3 | 65.9 | 65.5 | 65.9 |
| Al₂O₃ | mass | 22.2 | 22.3 | 22.2 | 22.0 | 21.9 | 22.2 |
| Li₂O | | 3.23 | 3.55 | 3.17 | 3.15 | 3.13 | 3.19 |
| Na₂O | | 0.09 | 0.43 | 0.08 | 0.09 | 0.09 | 0.55 |
| K₂O | | 0.01 | 0.15 | 0.01 | 0.01 | 0.01 | 0.01 |
| MgO | | 1.12 | 0.67 | 0.69 | 0.30 | 0.01 | 0.68 |
| CaO | | 0.03 | 0.02 | 0.02 | 0.02 | 0.01 | 0.02 |
| BaO | | 1.96 | 1.32 | 1.47 | 1.46 | 1.46 | 1.47 |
| ZrO₂ | | 2.25 | 2.19 | 2.37 | 2.67 | 3.04 | 2.26 |
| TiO₂ | | 1.96 | 1.95 | 1.98 | 2.27 | 2.49 | 1.99 |
| P₂O₅ | | 1.38 | 1.39 | 1.48 | 1.92 | 2.12 | 1.47 |
| ZnO | | 0 | 0 | 0 | 0 | 0 | 0 |
| SnO₂ | | 0.27 | 0.28 | 0.26 | 0.25 | 0.24 | 0.28 |
| SrO | | 0.004 | 0.002 | 0.003 | 0.002 | 0.002 | 0.002 |
| PbO | | <0.001 | <0.001 | <0.001 | <0.001 | <0.001 | <0.001 |
| Cl | | <0.001 | <0.001 | <0.001 | <0.001 | <0.001 | <0.001 |
| As₂O₃ | | <0.01 | <0.01 | <0.01 | <0.01 | <0.01 | <0.01 |
| Sb₂O₃ | | <0.01 | <0.01 | <0.01 | <0.01 | <0.01 | <0.01 |
| HfO₂ | | 0.03 | 0.03 | 0.03 | 0.03 | 0.03 | 0.03 |
| Fe₂O₃ | ppm | 90 | 80 | 80 | 80 | 80 | 80 |
| MoO₃ | | <0.3 | <0.3 | <0.3 | <0.3 | <0.3 | <0.3 |
| Pt | | unmeasured | unmeasured | unmeasured | unmeasured | unmeasured | unmeasured |
| Rh | | unmeasured | unmeasured | unmeasured | unmeasured | unmeasured | unmeasured |
| V₂O₅ | | unmeasured | unmeasured | unmeasured | unmeasured | unmeasured | unmeasured |
| Nd₂O₃ | | <5 | <5 | <5 | <5 | <5 | <5 |
| Pr₆O₁₁ | | unmeasured | unmeasured | unmeasured | unmeasured | unmeasured | unmeasured |
| Sm₂O₃ | | unmeasured | unmeasured | unmeasured | unmeasured | unmeasured | unmeasured |
| Li₂O/BaO | — | 1.65 | 2.69 | 2.16 | 2.16 | 2.14 | 2.17 |
| Na₂O + K₂O | % by | 0.10 | 0.58 | 0.09 | 0.10 | 0.10 | 0.56 |
| | mass | | | | | | |
| MgO + CaO | % by | 1.15 | 0.69 | 0.71 | 0.32 | 0.02 | 0.70 |
| | mass | | | | | | |
| (Na₂O + K₂O + MgO)/BaO | — | 0.62 | 0.95 | 0.53 | 0.27 | 0.08 | 0.84 |
| 8Li₂O − 4(Na₂O + K₂O + MgO) − (BaO + ZnO) | % by | 19.00 | 22.08 | 20.77 | 22.14 | 23.14 | 19.09 |
| | mass | | | | | | |
| (Li₂O + Na₂O + K₂O)/ZrO₂ | — | 1.48 | 1.89 | 1.38 | 1.22 | 1.06 | 1.66 |

TABLE 10

| | | | | | | |
|---|---|---|---|---|---|---|
| Unit | No. 25 | No. 26 | No. 27 | No. 28 | No. 29 | No. 30 |

Before Crystallization

| | | | | | | | |
|---|---|---|---|---|---|---|---|
| β-OH | /mm | 0.10 | 0.10 | 0.10 | 0.10 | 0.10 | 0.10 |
| Density | g/cm³ | 2.45 | 2.43 | 2.44 | 2.44 | 2.44 | 2.44 |
| CLTE at 30-380° C. | ×10⁻⁷/° C. | unmeasured | 38.9 | unmeasured | unmeasured | unmeasured | unmeasured |
| Glass Transition Point Tg | ° C. | unmeasured | 726 | unmeasured | unmeasured | unmeasured | unmeasured |
| Deformation Point Tf | | unmeasured | 787 | unmeasured | unmeasured | unmeasured | unmeasured |
| 10⁴ | | 1344 | 1350 | unmeasured | unmeasured | unmeasured | 1358 |
| 10^{3.5} | | 1427 | 1434 | unmeasured | unmeasured | unmeasured | 1442 |
| 10³ | | 1523 | 1531 | unmeasured | unmeasured | unmeasured | 1539 |
| 10^{2.5} | | 1634 | 1645 | unmeasured | unmeasured | unmeasured | 1652 |
| Liquidus Temperature TL | | 1368 | 1354 | 1386 | 1422 | 1444 | 1360 |
| Liquidus Viscosity log η | — | 3.85 | 3.97 | 3.83 | 3.65 | 3.54 | 3.98 |
| Primary Phase | — | mullite | ZrO₂ | mullite | mullite | mullite | mullite |

After Crystallization

| | | | | | | | |
|---|---|---|---|---|---|---|---|
| Crystallization Conditions | — | 780° C.-3 h | 780° C.-3 h | 780° C.-3 h | 780° C.-3 h | 780° C.-3 h | 780° C.-3 h |
| | | 890° C.-1 h | 890° C.-1 h | 920° C.-1 h | 920° C.-1 h | 890° C.-1 h | 890° C.-1 h |
| Precipitated Crystals | — | β-quartz | β-quartz | β-quartz | β-quartz | unmeasured | unmeasured |
| Crystallinity | % | unmeasured | unmeasured | unmeasured | unmeasured | unmeasured | unmeasured |
| Crystallite Size | nm | 36 | 36 | 40 | 47 | unmeasured | unmeasured |
| Density | g/cm³ | 2.56 | 2.53 | 2.57 | 2.57 | 2.51 | unmeasured |
| CLTE at 30-380° C. | ×10⁻⁷/° C. | 2.9 | −1.0 | unmeasured | unmeasured | unmeasured | 3.5 |
| CLTE at 30-750° C. | | 3.0 | 0.1 | unmeasured | unmeasured | unmeasured | 3.5 |
| Total Transmittance L* | — | 94.2 | 94.6 | 93.4 | unmeasured | unmeasured | 93.2 |
| Total Transmittance a* | | −0.4 | −0.4 | −0.7 | unmeasured | unmeasured | −0.4 |
| Total Transmittance b* | | 4.8 | 4.1 | 7.1 | unmeasured | unmeasured | 6.3 |
| Diffuse Transmittance L* | | 0.7 | 2.0 | 2.2 | unmeasured | unmeasured | 7.7 |
| Diffuse Transmittance a* | | 0.1 | 0.0 | 0.7 | unmeasured | unmeasured | 0.7 |
| Diffuse Transmittance b* | | −1.1 | −2.1 | −5.3 | unmeasured | unmeasured | −10.8 |
| Total Transmittance at 4 mm | | 90.7 | 90.9 | 90.7 | 90.5 | 89.3 | 90.6 |
| thickness and 1500 nm wavelength | | | | | | | |

TABLE 11

| | Unit | No. 31 | No. 32 | No. 33 | No. 34 | No. 35 | No. 36 |
|---|---|---|---|---|---|---|---|
| SiO₂ | % by | 65.8 | 65.7 | 65.5 | 65.8 | 66.3 | 66.7 |
| Al₂O₃ | mass | 22.1 | 22.1 | 22.0 | 22.2 | 22.2 | 22.3 |
| Li₂O | | 3.18 | 3.18 | 3.16 | 3.39 | 3.37 | 3.37 |
| Na₂O | | 1.10 | 1.60 | 0.83 | 0.42 | 0.26 | 0.26 |
| K₂O | | 0.01 | 0.01 | 1.16 | 0.16 | 0.08 | 0.08 |
| MgO | | 0.33 | 0.0 | 0.00 | 0.67 | 1.29 | 0.77 |
| CaO | | 0.02 | 0.01 | 0.01 | 0.03 | 0.04 | 0.03 |
| BaO | | 1.46 | 1.46 | 1.45 | 1.31 | 0.66 | 0.67 |
| ZrO₂ | | 2.26 | 2.25 | 2.25 | 2.22 | 2.22 | 2.21 |
| TiO₂ | | 1.98 | 1.98 | 1.97 | 1.95 | 1.93 | 1.92 |
| P₂O₅ | | 1.47 | 1.46 | 1.45 | 1.39 | 1.41 | 1.42 |
| ZnO | | 0 | 0 | 0 | 0 | 0 | 0 |
| SnO₂ | | 0.29 | 0.28 | 0.27 | 0.48 | 0.28 | 0.27 |
| SrO | | 0.002 | 0.003 | 0.003 | 0.003 | 0.002 | 0.002 |
| PbO | | <0.001 | <0.001 | <0.001 | <0.001 | <0.001 | <0.001 |
| Cl | | <0.001 | <0.001 | <0.001 | <0.001 | <0.001 | <0.001 |
| As₂O₃ | | <0.01 | <0.01 | <0.01 | <0.01 | <0.01 | <0.01 |
| Sb₂O₃ | | <0.01 | <0.01 | <0.01 | <0.01 | <0.01 | <0.01 |
| HfO₂ | | 0.03 | 0.03 | 0.03 | 0.03 | 0.03 | 0.03 |
| Fe₂O₃ | ppm | 70 | 70 | 70 | 80 | 90 | 80 |
| MoO₃ | | <0.3 | <0.3 | <0.3 | <0.3 | <0.3 | <0.3 |
| Pt | | unmeasured | unmeasured | unmeasured | unmeasured | unmeasured | unmeasured |
| Rh | | unmeasured | unmeasured | unmeasured | unmeasured | unmeasured | unmeasured |
| V₂O₅ | | unmeasured | unmeasured | unmeasured | unmeasured | unmeasured | unmeasured |
| Nd₂O₃ | | <5 | <5 | <5 | <5 | <5 | <5 |
| Pr₆O₁₁ | | unmeasured | unmeasured | unmeasured | unmeasured | unmeasured | unmeasured |
| Sm₂O₃ | | unmeasured | unmeasured | unmeasured | unmeasured | unmeasured | unmeasured |
| Li₂O/BaO | — | 2.18 | 2.18 | 2.18 | 2.59 | 5.11 | 5.03 |
| Na₂O + K₂O | % by | 1.11 | 1.61 | 1.99 | 0.58 | 0.34 | 0.34 |
| | mass | | | | | | |
| MgO + CaO | % by | 0.35 | 0.01 | 0.01 | 0.70 | 1.33 | 0.80 |
| | mass | | | | | | |
| (Na₂O + K₂O + MgO)/BaO | — | 0.99 | 1.10 | 1.37 | 0.95 | 2.47 | 1.66 |
| 8Li₂O − 4(Na₂O + K₂O + MgO) − (BaO + ZnO) | % by | 18.22 | 17.54 | 15.87 | 20.81 | 19.78 | 21.85 |
| | mass | | | | | | |
| (Li₂O + Na₂O + K₂O)/ZrO₂ | — | 1.90 | 2.13 | 2.29 | 1.79 | 1.67 | 1.68 |

TABLE 12

| | | | | | | |
|---|---|---|---|---|---|---|
| Unit | No. 31 | No. 32 | No. 33 | No. 34 | No. 35 | No. 36 |

Before Crystallization

| | | | | | | | |
|---|---|---|---|---|---|---|---|
| β-OH | /mm | 0.10 | 0.40 | 0.40 | 0.40 | 0.40 | 0.10 |
| Density | g/cm³ | 2.43 | 2.43 | 2.43 | 2.44 | 2.43 | 2.42 |
| CLTE at 30-380° C. | ×10⁻⁷/° C. | unmeasured | unmeasured | unmeasured | unmeasured | unmeasured | 37.0 |
| Glass Transition Point Tg | ° C. | unmeasured | unmeasured | unmeasured | unmeasured | unmeasured | 724 |
| Deformation Point Tf | | unmeasured | unmeasured | unmeasured | unmeasured | unmeasured | 781 |
| 10⁴ | | 1366 | unmeasured | unmeasured | unmeasured | unmeasured | 1352 |
| 10^{3.5} | | 1452 | unmeasured | unmeasured | unmeasured | unmeasured | 1436 |
| 10³ | | 1551 | unmeasured | unmeasured | unmeasured | unmeasured | 1530 |
| 10^{2.5} | | 1667 | unmeasured | unmeasured | unmeasured | unmeasured | 1637 |
| Liquidus Temperature TL | | 1378 | 1387 | 1392 | 1387 | 1367 | 1398 |
| Liquidus Viscosity log η | — | 3.93 | 3.80 | 3.80 | 3.74 | 3.82 | 3.72 |
| Primary Phase | — | mullite, β- | ZrO₂ | ZrO₂ | ZrO₂ | mullite | mullite, β- |
| | | spodumene | | | | | spodumene |

After Crystallization

| | | | | | | | |
|---|---|---|---|---|---|---|---|
| Crystallization Conditions | — | 780° C.-3 h | 780° C.-3 h | 780° C.-3 h | 780° C.-3 h | 780° C.-3 h | 780° C.-3 h |
| | | 920° C.-1 h | 920° C.-1 h | 920° C.-1 h | 920° C.-1 h | 890° C.-1 h | 890° C.-1 h |
| Precipitated Crystals | — | unmeasured | unmeasured | unmeasured | unmeasured | unmeasured | β-quartz |
| Crystallinity | % | unmeasured | unmeasured | unmeasured | unmeasured | unmeasured | unmeasured |
| Crystallite Size | nm | unmeasured | unmeasured | unmeasured | unmeasured | unmeasured | 39 |
| Density | g/cm³ | unmeasured | unmeasured | unmeasured | unmeasured | unmeasured | unmeasured |
| CLTE at 30-380° C. | ×10⁻⁷/° C. | 3.8 | unmeasured | unmeasured | 1.6 | 2.5 | −0.9 |
| CLTE at 30-750° C. | | 4.3 | unmeasured | unmeasured | 2.4 | 2.5 | −0.5 |
| Total Transmittance L* | — | 92.9 | unmeasured | unmeasured | 94.0 | 94.4 | 94.0 |
| Total Transmittance a* | | −0.3 | unmeasured | unmeasured | −0.8 | −0.5 | −0.5 |
| Total Transmittance b* | | 6.8 | unmeasured | unmeasured | 5.8 | 4.6 | 5.0 |
| Diffuse Transmittance L* | | unmeasured | unmeasured | unmeasured | 1.3 | 0.7 | 1.6 |
| Diffuse Transmittance a* | | unmeasured | unmeasured | unmeasured | 0.1 | 0.1 | 0.1 |
| Diffuse Transmittance b* | | unmeasured | unmeasured | unmeasured | −2.3 | −1.3 | −2.0 |
| Total Transmittance at 4 mm | | 90.8 | unmeasured | unmeasured | 90.9 | 90.8 | 90.5 |
| thickness and 1500 nm wavelength | | | | | | | |

TABLE 13

| | Unit | No. 37 | No. 38 | No. 39 | No. 40 | No. 41 | No. 42 |
|---|---|---|---|---|---|---|---|
| SiO₂ | % by | 65.8 | 67.7 | 68.0 | 67.6 | 66.8 | 67.3 |
| Al₂O₃ | mass | 22.2 | 22.1 | 21.9 | 21.7 | 21.3 | 22.3 |
| Li₂O | | 3.37 | 3.21 | 3.21 | 3.20 | 3.16 | 3.25 |
| Na₂O | | 0.25 | 0.05 | 0.05 | 0.07 | 0.07 | 0.05 |
| K₂O | | 0.09 | 0.01 | 0.01 | 0.01 | 0.01 | 0.02 |
| MgO | | 0.89 | 0.97 | 0.97 | 0.98 | 0.48 | 1.22 |
| CaO | | 0.03 | 0.03 | 0.03 | 0.03 | 0.02 | 0.04 |
| BaO | | 1.64 | 0.01 | 0.01 | 0.01 | 1.85 | 0.01 |
| ZrO₂ | | 2.18 | 2.24 | 2.22 | 2.72 | 2.72 | 2.25 |
| TiO₂ | | 1.94 | 1.94 | 1.95 | 1.95 | 1.93 | 1.92 |
| P₂O₅ | | 1.39 | 1.42 | 1.39 | 1.42 | 1.39 | 1.43 |
| ZnO | | 0 | 0 | 0 | 0 | 0 | 0 |
| SnO₂ | | 0.24 | 0.29 | 0.26 | 0.30 | 0.29 | 0.26 |
| SrO | | 0.003 | <0.001 | <0.001 | <0.001 | 0.003 | <0.001 |
| PbO | | <0.001 | <0.001 | <0.001 | <0.001 | <0.001 | <0.001 |
| Cl | | <0.001 | <0.001 | <0.001 | <0.001 | <0.001 | <0.001 |
| As₂O₃ | | <0.01 | <0.01 | <0.01 | <0.01 | <0.01 | <0.01 |
| Sb₂O₃ | | <0.01 | <0.01 | <0.01 | <0.01 | <0.01 | <0.01 |
| HfO₂ | | 0.03 | 0.03 | 0.03 | 0.03 | 0.03 | 0.03 |
| Fe₂O₃ | ppm | 80 | 90 | 90 | 90 | 80 | 100 |
| MoO₃ | | <0.3 | <0.3 | <0.3 | <0.3 | <0.3 | <0.3 |
| Pt | | unmeasured | unmeasured | unmeasured | unmeasured | unmeasured | unmeasured |
| Rh | | unmeasured | unmeasured | unmeasured | unmeasured | unmeasured | unmeasured |
| V₂O₅ | | unmeasured | unmeasured | unmeasured | unmeasured | unmeasured | unmeasured |
| Nd₂O₃ | | <5 | <5 | <5 | <5 | <5 | <5 |
| Pr₆O₁₁ | | unmeasured | unmeasured | unmeasured | unmeasured | unmeasured | unmeasured |
| Sm₂O₃ | | unmeasured | unmeasured | unmeasured | unmeasured | unmeasured | unmeasured |
| Li₂O/BaO | — | 2.05 | 321 | 321 | 320 | 1.71 | 325 |
| Na₂O + K₂O | % by | 0.34 | 0.06 | 0.06 | 0.08 | 0.08 | 0.07 |
| | mass | | | | | | |
| MgO + CaO | % by | 0.92 | 1.00 | 1.00 | 1.01 | 0.50 | 1.26 |
| | mass | | | | | | |
| (Na₂O + K₂O + MgO)/BaO | — | 0.75 | 103.00 | 103.00 | 106.00 | 0.30 | 129.00 |
| 8Li₂O − 4(Na₂O + K₂O + MgO) − (BaO + ZnO) | % by | 20.40 | 21.55 | 21.55 | 21.35 | 21.19 | 20.83 |
| | mass | | | | | | |
| (Li₂O + Na₂O + K₂O)/ZrO₂ | — | 1.70 | 1.46 | 1.47 | 1.21 | 1.19 | 1.48 |

TABLE 14

| | | | | | | |
|---|---|---|---|---|---|---|
| Unit | No. 37 | No. 38 | No. 39 | No. 40 | No. 41 | No. 42 |

Before Crystallization

| | | | | | | | |
|---|---|---|---|---|---|---|---|
| β-OH | /mm | 0.10 | 0.10 | 0.10 | 0.10 | 0.10 | 0.10 |
| Density | g/cm³ | 2.44 | 2.41 | 2.41 | 2.42 | 2.44 | 2.42 |
| CLTE at 30-380° C. | ×10⁻⁷/° C. | 38.0 | unmeasured | unmeasured | unmeasured | 35.0 | unmeasured |
| Glass Transition Point Tg | ° C. | 720 | unmeasured | unmeasured | unmeasured | 739 | unmeasured |
| Deformation Point Tf | | 774 | unmeasured | unmeasured | unmeasured | 801 | unmeasured |
| 10⁴ | | 1347 | unmeasured | unmeasured | unmeasured | unmeasured | 1364 |
| 10^{3.5} | | 1431 | unmeasured | unmeasured | unmeasured | unmeasured | 1448 |
| 10³ | | 1527 | unmeasured | unmeasured | unmeasured | unmeasured | 1544 |
| 10^{2.5} | | 1636 | unmeasured | unmeasured | unmeasured | unmeasured | 1655 |
| Liquidus Temperature TL | | 1364 | 1428 | 1430 | 1404 | 1401 | 1426 |
| Liquidus Viscosity log η | — | 3.90 | 3.61 | 3.60 | 3.75 | 3.80 | 3.62 |
| Primary Phase | — | mullite | mullite | mullite | ZrO₂ | mullite | mullite |

After Crystallization

| | | | | | | | |
|---|---|---|---|---|---|---|---|
| Crystallization Conditions | — | 780° C.-3 h | 780° C.-3 h | 780° C.-3 h | 780° C.-3 h | 780° C.-3 h | 780° C.-3 h |
| | | 890° C.-1 h | 920° C.-1 h | 920° C.-1 h | 920° C.-1 h | 920° C.-1 h | 890° C.-1 h |
| Precipitated Crystals | — | unmeasured | unmeasured | unmeasured | unmeasured | β-quartz | β-quartz |
| Crystallinity | % | unmeasured | unmeasured | unmeasured | unmeasured | unmeasured | unmeasured |
| Crystallite Size | nm | unmeasured | unmeasured | unmeasured | unmeasured | 47 | 42 |
| Density | g/cm³ | unmeasured | unmeasured | unmeasured | unmeasured | unmeasured | unmeasured |
| CLTE at 30-380° C. | ×10⁻⁷/° C. | 0.8 | 4.1 | 4.6 | 3.4 | 2.4 | 2.5 |
| CLTE at 30-750° C. | | 1.4 | 2.5 | 2.7 | 2.8 | 0.7 | 2.2 |
| Total Transmittance L* | — | 94.6 | 94.0 | 93.7 | unmeasured | unmeasured | 93.7 |
| Total Transmittance a* | | −0.4 | −0.7 | −0.8 | unmeasured | unmeasured | −0.5 |
| Total Transmittance b* | | 4.1 | 6.1 | 6.6 | unmeasured | unmeasured | 5.9 |
| Diffuse Transmittance L* | | 1.0 | 3.7 | 2.6 | unmeasured | unmeasured | 5.2 |
| Diffuse Transmittance a* | | 0.1 | 0.4 | 0.8 | unmeasured | unmeasured | 0.4 |
| Diffuse Transmittance b* | | −1.7 | −4.8 | −6.4 | unmeasured | unmeasured | −8.5 |
| Total Transmittance at 4 mm | | 90.5 | 90.3 | 90.2 | 90.6 | 90.1 | 90.3 |
| thickness and 1500 nm wavelength | | | | | | | |

TABLE 15

| | Unit | No.43 | No.44 | No.45 | No.46 | No.47 | No.48 |
|---|---|---|---|---|---|---|---|
| SiO₂ | % by | 66.1 | 65.0 | 66.5 | 65.9 | 66.9 | 66.8 |
| Al₂O₃ | mass | 21.9 | 21.5 | 22.2 | 23.1 | 22.3 | 22.4 |
| Li₂O | | 3.20 | 3.14 | 3.23 | 3.36 | 3.25 | 3.37 |
| Na₂O | | 0.07 | 0.09 | 0.06 | 0.26 | 0.27 | 0.07 |
| K₂O | | 0.02 | 0.02 | 0.02 | 0.08 | 0.08 | 0.08 |
| MgO | | 0.60 | 0.01 | 0.97 | 0.81 | 0.80 | 0.81 |
| CaO | | 0.03 | 0.01 | 0.03 | 0.03 | 0.03 | 0.03 |
| BaO | | 2.3 | 4.51 | 0.01 | 0.67 | 0.67 | 0.68 |
| ZrO₂ | | 2.21 | 2.17 | 2.24 | 2.18 | 2.18 | 2.18 |
| TiO₂ | | 1.90 | 1.87 | 1.92 | 1.89 | 1.89 | 1.90 |
| P₂O₅ | | 1.41 | 1.39 | 2.33 | 1.43 | 1.42 | 1.43 |
| ZnO | | 0 | 0 | 0 | 0 | 0 | 0 |
| SnO₂ | | 0.27 | 0.27 | 0.26 | 0.27 | 0.26 | 0.26 |
| SrO | | 0.004 | 0.007 | <0.001 | 0.001 | 0.001 | 0.005 |
| PbO | | <0.001 | <0.001 | <0.001 | <0.001 | <0.001 | <0.001 |
| Cl | | <0.001 | <0.001 | <0.001 | <0.001 | <0.001 | <0.001 |
| As₂O₃ | | <0.01 | <0.01 | <0.01 | <0.01 | <0.01 | <0.01 |
| Sb₂O₃ | | <0.01 | <0.01 | <0.01 | <0.01 | <0.01 | <0.01 |
| HfO₂ | | 0.03 | 0.03 | 0.03 | 0.03 | 0.03 | 0.03 |
| Fe₂O₃ | ppm | 90 | 80 | 100 | 90 | 90 | 90 |
| MoO₃ | | <0.3 | <0.3 | <0.3 | <0.3 | <0.3 | <0.3 |
| Pt | | 2.0 | unmeasured | unmeasured | unmeasured | unmeasured | unmeasured |
| Rh | | 0.03 | unmeasured | unmeasured | unmeasured | unmeasured | unmeasured |
| V₂O₅ | | unmeasured | 1.00 | 3.00 | 3.00 | 3.00 | unmeasured |
| Nd₂O₃ | | <5 | <5 | <5 | <5 | <5 | <5 |
| Pr₆O₁₁ | | unmeasured | unmeasured | unmeasured | unmeasured | unmeasured | unmeasured |
| Sm₂O₃ | | unmeasured | unmeasured | unmeasured | unmeasured | unmeasured | unmeasured |
| Li₂O/BaO | — | 1.39 | 0.70 | 323 | 5.01 | 4.85 | 4.96 |
| Na₂O + K₂O | % by | 0.09 | 0.11 | 0.08 | 0.34 | 0.35 | 0.15 |
| | mass | | | | | | |
| MgO + CaO | % by | 0.63 | 0.02 | 1.00 | 0.84 | 0.83 | 0.84 |
| | mass | | | | | | |
| (Na₂O + K₂O + MgO)/BaO | — | 0.30 | 0.03 | 105.00 | 1.72 | 1.72 | 1.41 |
| 8Li₂O − 4 (Na₂O + K₂O + | % by | 20.54 | 20.13 | 21.63 | 21.61 | 20.73 | 22.44 |
| MgO) − (BaO + ZnO) | mass | | | | | | |
| (Li₂O + Na₂O + K₂O)/ZrO₂ | — | 1.49 | 1.50 | 1.48 | 1.70 | 1.65 | 1.61 |

TABLE 16

| | | | | | | |
|---|---|---|---|---|---|---|
| Unit | No.43 | No.44 | No.45 | No.46 | No.47 | No.48 |

Before Crystallization

| | | | | | | | |
|---|---|---|---|---|---|---|---|
| β-OH | /mm | 0.10 | 0.10 | 0.10 | 0.10 | 0.10 | 0.10 |
| Density | g/cm ³ | 2.45 | 2.48 | 2.41 | 2.43 | 2.42 | 2.42 |
| CLTE at 30-380° C. | ×10⁻⁷/° C. | 35.9 | 37.7 | unmeasured | unmeasured | unmeasured | unmeasured |
| Glass Transition Point Tg | ° C. | 736 | 735 | unmeasured | unmeasured | unmeasured | unmeasured |
| Deformation Point Tf | | 795 | 794 | unmeasured | unmeasured | unmeasured | unmeasured |
| 10 ⁴ | | unmeasured | 1377 | 1353 | unmeasured | unmeasured | unmeasured |
| 10 ^{3.5} | | unmeasured | 1461 | 1436 | unmeasured | unmeasured | unmeasured |
| 10 ³ | | unmeasured | 1557 | 1531 | unmeasured | unmeasured | unmeasured |
| 10 ^{2.5} | | unmeasured | 1668 | 1641 | unmeasured | unmeasured | unmeasured |
| Liquidus Temperature TL | | 1386 | 1372 | 1409 | 1426 | 1390 | 1408 |
| Liquidus Viscosity bg η | — | 3.83 | 4.03 | 3.66 | unmeasured | unmeasured | unmeasured |
| Primary Phase | — | mullite | mullite | mullite | mullite | mullite | mullite |

After Crystallization

| | | | | | | | |
|---|---|---|---|---|---|---|---|
| Crystallization Conditions | — | 780° C.-3 h | 780° C.-3 h | 780° C.-3 h | 780° C.-3 h | 780° C.-3 h | 780° C.-3 h |
| | | 890° C.-1 h | 920° C.-1 h | 890° C.-1 h | 890° C.-1 h | 890° C.-1 h | 890° C.-1 h |
| Precipitated Crystal | — | β-quartz | β-quartz | β-quartz | unmeasured | β-quartz | β-quartz |
| Crystallinity | % | unmeasured | unmeasured | unmeasured | unmeasured | unmeasured | unmeasured |
| Crystallite Size | nm | 43 | 39 | 40 | unmeasured | 39 | 38 |
| Density | g/cm ³ | unmeasured | unmeasured | unmeasured | unmeasured | unmeasured | unmeasured |
| CLTE at 30-380° C. | ×10⁻⁷/° C. | −0.6 | −0.3 | −0.1 | −0.7 | 0.0 | −1.6 |
| CLTE at 30-750° C. | | −0.4 | 0.2 | −0.7 | −0.2 | −0.6 | −1.5 |
| Total Transmittance L* | | 94.2 | 94.5 | 94.4 | 94.0 | 93.7 | 94.1 |
| Total Transmittance a* | | −0.4 | −0.4 | −0.4 | −0.4 | −0.4 | −0.5 |
| Total Transmittance b* | | 5.5 | 4.2 | 4.7 | 5.1 | 5.6 | 5.2 |
| Diffuse Transmittance L* | | 4.4 | 2.3 | 2.7 | 2.5 | 6.0 | 1.6 |
| Diffuse Transmittance a* | | 0.4 | 0.1 | 0.2 | 0.2 | 0.4 | 0.1 |
| Diffuse Transmittance b* | | −7.2 | −3.1 | −4.3 | −3.8 | −8.9 | −2.4 |
| Total Transmittance at 4 mm thickness | | 90.7 | 91.3 | 90.5 | 90.4 | 90.1 | 90.1 |
| and 1500 nm wave length | | | | | | | |

TABLE 17

| | Unit | No.49 | No.50 | No.51 | No.52 | No.53 | No.54 |
|---|---|---|---|---|---|---|---|
| SiO₂ | % by | 66.9 | 66.7 | 66.5 | 66.0 | 67.0 | 65.1 |
| Al₂O₃ | mass | 22.3 | 22.3 | 22.3 | 22.1 | 22.4 | 21.5 |
| Li₂O | | 3.37 | 3.32 | 3.27 | 3.25 | 3.29 | 3.15 |
| Na₂O | | 0.26 | 0.08 | 0.08 | 0.11 | 0.07 | 0.08 |
| K₂O | | 0.09 | 0.01 | 0.01 | 0.01 | 0.01 | 0.01 |
| MgO | | 0.66 | 0.97 | 0.97 | 0.72 | 1.22 | 0.01 |
| CaO | | 0.03 | 0.03 | 0.03 | 0.03 | 0.04 | 0.01 |
| BaO | | 0.67 | 0.91 | 1.14 | 2.07 | 0.24 | 3.61 |
| ZrO₂ | | 2.18 | 2.18 | 2.18 | 2.16 | 2.19 | 2.17 |
| TiO₂ | | 1.90 | 1.83 | 1.83 | 1.81 | 1.86 | 1.86 |
| P₂O₅ | | 1.43 | 1.43 | 1.43 | 1.42 | 1.44 | 2.2 |
| ZnO | | 0 | 0 | 0 | 0 | 0 | 0 |
| SnO₂ | | 0.26 | 0.26 | 0.27 | 0.28 | 0.27 | 0.27 |
| SrO | | 0.002 | 0.003 | 0.003 | 0.003 | 0.003 | 0.002 |
| PbO | | <0.001 | 10.001 | <0.001 | 0.001 | 0.001 | 0.001 |
| Cl | | <0.001 | <0.001 | <0.001 | <0.001 | 0.001 | 0.001 |
| As₂O₃ | | <0.01 | <0.01 | <0.01 | <0.01 | <0.01 | <0.01 |
| Sb₂O₃ | | <0.01 | <0.01 | <0.01 | <0.01 | <0.01 | <0.01 |
| HfO₂ | | 0.03 | 0.03 | 0.03 | 0.04 | 0.04 | 0.04 |
| Fe₂O₃ | ppm | 90 | 80 | 80 | 80 | 80 | 80 |
| MoO₃ | | <0.3 | <0.3 | <0.3 | <0.3 | <0.3 | <0.3 |
| Pt | | unmeasured | unmeasured | unmeasured | 20.00 | unmeasured | unmeasured |
| Rh | | unmeasured | unmeasured | unmeasured | 10.00 | unmeasured | unmeasured |
| V₂O₅ | | unmeasured | unmeasured | unmeasured | 3.00 | unmeasured | unmeasured |
| Nd₂O₃ | | <5 | <5 | <5 | <5 | <5 | <5 |
| Pr₆O₁₁ | | unmeasured | unmeasured | unmeasured | unmeasured | unmeasured | unmeasured |
| Sm₂O₃ | | unmeasured | unmeasured | unmeasured | unmeasured | unmeasured | unmeasured |
| Li₂O/BaO | — | 5.03 | 3.65 | 2.87 | 1.57 | 13.71 | 0.87 |
| Na₂O + K₂O | % by | 0.35 | 0.09 | 0.09 | 0.12 | 0.08 | 0.09 |
| | mass | | | | | | |
| MgO + CaO | % by | 0.69 | 1.00 | 1.00 | 0.75 | 1.26 | 0.02 |
| | mass | | | | | | |
| (Na₂O + K₂O + MgO)/BaO | — | 1.51 | 1.16 | 0.93 | 0.41 | 5.42 | 0.03 |
| 8Li₂O − 4 (Na₂O + K₂O + | % by | 22.25 | 21.41 | 20.78 | 20.57 | 20.88 | 21.19 |
| MgO) − (BaO + ZnO) | mass | | | | | | |
| (Li₂O + Na₂O + K₂O)/ZrO₂ | — | 1.71 | 1.56 | 1.54 | 1.56 | 1.54 | 1.49 |

TABLE 18

| | | | | | | |
|---|---|---|---|---|---|---|
| Unit | No.49 | No.50 | No.51 | No.52 | No.53 | No.54 |

Before Crystallization

| | | | | | | | |
|---|---|---|---|---|---|---|---|
| β-OH | /mm | 0.10 | 0.10 | 0.10 | 0.10 | 0.10 | 0.10 |
| Density | g/cm ³ | 2.42 | 2.42 | 2.43 | 2.43 | 2.42 | 2.46 |
| CLTE at 30-380° C. | ×10⁻⁷/° C. | unmeasured | unmeasured | unmeasured | unmeasured | unmeasured | unmeasured |
| Glass Transition Point Tg | ° C. | unmeasured | unmeasured | unmeasured | unmeasured | unmeasured | unmeasured |
| Deformation Point Tf | | unmeasured | unmeasured | unmeasured | unmeasured | unmeasured | unmeasured |
| 10 ⁴ | | unmeasured | 1355 | 1355 | 1361 | 1351 | 1382 |
| 10 ^{3.5} | | unmeasured | 1439 | 1439 | 1444 | 1433 | 1466 |
| 10 ³ | | unmeasured | 1534 | 1535 | 1540 | 1528 | 1563 |
| 10 ^{2.5} | | unmeasured | 1645 | 1646 | 1651 | 1639 | 1676 |
| Liquidus Temperature TL | | 1386 | 1398 | 1384 | 1398 | 1375 | 1368 |
| Liquidus Viscosity bg η | — | unmeasured | 3.73 | 3.82 | 3.77 | 3.84 | 4.09 |
| Primary Phase | — | mullite | mullite | mullite | ZrO₂ | ZrO₂ | ZrO₂ |

After Crystallization

| | | | | | | | |
|---|---|---|---|---|---|---|---|
| Crystallization Conditions | — | 780° C.-3 h | 780° C.-3 h | 780° C.-3 h | 780° C.-3 h | 780° C.-3 h | 780° C.-3 h |
| | | 905° C.-1 h | 875° C.-1 h | 875° C.-1 h | 905° C.-1 h | 875° C.-1 h | 905° C.-1 h |
| Precipitated Crystal | — | unmeasured | β-quartz | β-quartz | β-quartz | unmeasured | β-quartz |
| Crystallinity | % | unmeasured | unmeasured | unmeasured | unmeasured | unmeasured | unmeasured |
| Crystallite Size | nm | unmeasured | 37 | 37 | 37 | unmeasured | 34 |
| Density | g/cm ³ | unmeasured | unmeasured | unmeasured | unmeasured | unmeasured | unmeasured |
| CLTE at 30-380° C. | ×10⁻⁷/° C. | −1.1 | −0.9 | −0.3 | −0.7 | 0.8 | −2.7 |
| CLTE at 30-750° C. | | −0.8 | −0.7 | −0.1 | −0.3 | 0.9 | −2.2 |
| Total Transmittance L* | | 94.1 | 94.1 | 93.9 | 93.7 | 94.1 | 94.2 |
| Total Transmittance a* | | −0.5 | −0.4 | −0.3 | −0.3 | −0.3 | −0.3 |
| Total Transmittance b* | | 5.3 | 5.0 | 5.1 | 6.5 | 5.0 | 4.3 |
| Diffuse Transmittance L* | | unmeasured | 3.1 | 2.8 | 0.9 | 2.5 | 6.2 |
| Diffuse Transmittance a* | | unmeasured | 0.1 | 0.2 | 0.1 | 0.2 | −0.2 |
| Diffuse Transmittance b* | | unmeasured | −3.7 | −4.0 | −1.5 | −3.6 | −5.6 |
| Total Transmittance at 4 mm thickness | | 90.0 | 90.5 | 90.3 | 90.8 | 90.8 | 91.1 |
| and 1500 nm wave length | | | | | | | |

TABLE 19

| | Unit | No.55 | No.56 | No.57 | No.58 | No.59 | No.60 |
|---|---|---|---|---|---|---|---|
| SiO₂ | % by | 65.0 | 65.0 | 64.7 | 64.9 | 64.8 | 64.9 |
| Al₂O₃ | mass | 21.5 | 21.5 | 21.4 | 21.5 | 21.5 | 21.5 |
| Li₂O | | 3.14 | 3.01 | 3.00 | 3.19 | 3.19 | 3.19 |
| Na₂O | | 0.08 | 0.08 | 0.08 | 0.27 | 0.08 | 0.10 |
| K₂O | | 0.01 | 0.01 | 0.01 | 0.01 | 0.27 | 0.01 |
| MgO | | 0.09 | 0.18 | 0.01 | 0.00 | 0.00 | 0.12 |
| CaO | | 0.01 | 0.02 | 0.01 | 0.01 | 0.01 | 0.02 |
| BaO | | 3.61 | 3.62 | 3.59 | 4.49 | 4.48 | 4.49 |
| ZrO₂ | | 2.17 | 2.17 | 2.16 | 2.15 | 2.15 | 2.14 |
| TiO₂ | | 1.86 | 1.86 | 1.85 | 1.86 | 1.86 | 1.86 |
| P₂O₅ | | 2.26 | 2.27 | 2.88 | 1.40 | 1.40 | 1.41 |
| ZnO | | 0 | 0 | 0 | 0 | 0 | 0 |
| SnO₂ | | 0.27 | 0.28 | 0.27 | 0.26 | 0.26 | 0.26 |
| SrO | | 0.003 | 0.003 | 0.003 | 0.003 | 0.003 | 0.003 |
| PbO | | <0.001 | <0.001 | <0.001 | <0.001 | <0.001 | <0.001 |
| Cl | | <0.001 | <0.001 | <0.001 | <0.001 | <0.001 | <0.001 |
| As₂O₃ | | <0.01 | <0.01 | <0.01 | <0.01 | <0.01 | <0.01 |
| Sb₂O₃ | | <0.01 | <0.01 | <0.01 | <0.01 | <0.01 | <0.01 |
| HfO₂ | | 0.04 | 0.04 | 0.04 | 0.04 | 0.04 | 0.04 |
| Fe₂O₃ | ppm | 80 | 80 | 80 | 80 | 80 | 80 |
| MoO₃ | | <0.3 | <0.3 | <0.3 | <0.3 | <0.3 | <0.3 |
| Pt | | unmeasured | unmeasured | unmeasured | 0.80 | unmeasured | 1.50 |
| Rh | | unmeasured | unmeasured | unmeasured | 0.02 | unmeasured | 0.02 |
| V₂O₅ | | unmeasured | unmeasured | unmeasured | 2.00 | unmeasured | unmeasured |
| Nd₂O₃ | | <5 | <5 | <5 | <5 | <5 | <5 |
| Pr₆O₁₁ | | unmeasured | unmeasured | unmeasured | unmeasured | unmeasured | unmeasured |
| Sm₂O₃ | | unmeasured | unmeasured | unmeasured | unmeasured | unmeasured | unmeasured |
| Li₂O/BaO | — | 0.87 | 0.83 | 0.84 | 0.71 | 0.71 | 0.71 |
| Na₂O + K₂O | % by | 0.09 | 0.09 | 0.09 | 0.28 | 0.35 | 0.11 |
| | mass | | | | | | |
| MgO + CaO | % by | 0.10 | 0.20 | 0.02 | 0.01 | 0.01 | 0.14 |
| | mass | | | | | | |
| (Na₂O + K₂O + MgO)/BaO | — | 0.05 | 0.07 | 0.03 | 0.06 | 0.08 | 0.05 |
| 8Li₂O − 4 (Na₂O + K₂O + | % by | 20.79 | 19.38 | 20.01 | 19.91 | 19.64 | 20.11 |
| MgO) − (BaO + ZnO) | mass | | | | | | |
| (Li₂O + Na₂O + K₂O)/ZrO₂ | — | 1.49 | 1.43 | 1.43 | 1.61 | 1.65 | 1.54 |

TABLE 20

| | | | | | | |
|---|---|---|---|---|---|---|
| Unit | No.55 | No.56 | No.57 | No.58 | No.59 | No.60 |

Before Crystallization

| | | | | | | | |
|---|---|---|---|---|---|---|---|
| β-OH | /mm | 0.10 | 0.10 | 0.10 | 0.10 | 0.10 | 0.10 |
| Density | g/cm ³ | 2.46 | 2.46 | 2.45 | 2.48 | 2.48 | 2.48 |
| CLTE at 30-380° C. | ×10⁻⁷/° C. | unmeasured | unmeasured | unmeasured | 38.7 | 38.7 | 37.8 |
| Glass Transition Point Tg | ° C. | unmeasured | unmeasured | unmeasured | 742 | 742 | 739 |
| Deformation Point Tf | | unmeasured | unmeasured | unmeasured | 803 | 802 | 802 |
| 10 ⁴ | | unmeasured | 1381 | 1387 | 1372 | 1373 | 1369 |
| 10 ^{3.5} | | unmeasured | 1466 | 1471 | 1455 | 1457 | 1452 |
| 10 ³ | | unmeasured | 1562 | 1568 | 1553 | 1555 | 1549 |
| 10 ^{2.5} | | unmeasured | 1673 | 1680 | 1669 | 1688 | 1662 |
| Liquidus Temperature TL | | 1342 | 1376 | 1371 | 1370 | 1353 | 1363 |
| Liquidus Viscosity bg η | — | unmeasured | 4.03 | 4.1 | 4.01 | 4.13 | 4.04 |
| Primary Phase | — | ZrO₂ | ZrO₂ | ZrO₂ | ZrO₂ | ZrO₂ | ZrO₂ |

After Crystallization

| | | | | | | | |
|---|---|---|---|---|---|---|---|
| Crystallization Conditions | — | 780° C.-3 h | 780° C.-3 h | 780° C.-3 h | 780° C.-3 h | 780° C.-3 h | 780° C.-3 h |
| | | 905° C.-1 h | 905° C.-1 h | 905° C.-1 h | 905° C.-1 h | 920° C.-1 h | 905° C.-1 h |
| Precipitated Crystal | — | β-quartz | β-quartz | β-quartz | β-quartz | β-quartz | β-quartz |
| Crystallinity | % | unmeasured | unmeasured | unmeasured | unmeasured | unmeasured | unmeasured |
| Crystallite Size | nm | 36 | 36 | 34 | unmeasured | 39 | unmeasured |
| Density | g/cm ³ | unmeasured | unmeasured | unmeasured | unmeasured | unmeasured | 2.57 |
| CLTE at 30-380° C. | ×10⁻⁷/° C. | −1.6 | −0.2 | −0.8 | −3.2 | −0.4 | −1.5 |
| CLTE at 30-750° C. | | −1.5 | −0.6 | −1.4 | −1.3 | 1.0 | −0.2 |
| Total Transmittance L* | | 94.3 | 94.3 | 94.3 | 94.2 | 94.3 | 94.5 |
| Total Transmittance a* | | −0.3 | −0.3 | −0.3 | −0.3 | −0.2 | −0.3 |
| Total Transmittance b* | | 4.0 | 4.3 | 4.4 | 4.5 | 5.3 | 4.2 |
| Diffuse Transmittance L* | | 2.5 | 4.2 | 3.0 | 4.2 | 3.2 | 2.7 |
| Diffuse Transmittance a* | | 0.1 | 0.0 | 0.3 | 0.3 | 0.2 | 0.1 |
| Diffuse Transmittance b* | | −3.1 | −5.0 | −4.8 | −6.9 | −3.5 | −3.0 |
| Total Transmittance at 4 mm thickness | | 90.4 | 90.7 | 90.9 | 91.3 | 91.1 | 90.7 |
| and 1500 nm wave length | | | | | | | |

TABLE 21

| | Unit | No.61 | No.62 | No.63 | No.64 | No.65 | No.66 |
|---|---|---|---|---|---|---|---|
| SiO₂ | % by | 64.7 | 63.8 | 63.6 | 64.2 | 63.6 | 63.6 |
| Al₂O₃ | mass | 21.5 | 21.6 | 21.4 | 21.7 | 21.5 | 21.5 |
| Li₂O | | 3.18 | 3.19 | 3.17 | 3.21 | 3.18 | 3.16 |
| Na₂O | | 0.08 | 1.18 | 0.80 | 1.54 | 0.78 | 0.12 |
| K₂O | | 0.01 | 0.01 | 0.01 | 0.01 | 0.01 | 0.01 |
| MgO | | 0.00 | 0.01 | 0.01 | 0.01 | 0.01 | 0.01 |
| CaO | | 0.01 | 0.01 | 0.01 | 0.01 | 0.01 | 0.01 |
| BaO | | 4.48 | 4.56 | 5.45 | 3.67 | 4.53 | 6.01 |
| ZrO₂ | | 2.51 | 2.15 | 2.14 | 2.17 | 2.88 | 2.18 |
| TiO₂ | | 1.85 | 1.78 | 1.78 | 1.79 | 1.90 | 1.81 |
| P₂O₅ | | 1.40 | 1.40 | 1.39 | 1.41 | 1.39 | 1.36 |
| ZnO | | 0 | 0 | 0 | 0 | 0 | 0 |
| SnO₂ | | 0.27 | 0.27 | 0.27 | 0.26 | 0.26 | 0.27 |
| SrO | | 0.003 | 0.003 | 0.004 | 0.003 | 0.003 | 0.004 |
| PbO | | <0.001 | <0.001 | <0.001 | <0.001 | <0.001 | <0.001 |
| Cl | | <0.001 | <0.001 | <0.001 | <0.001 | <0.001 | <0.001 |
| As₂O₃ | | <0.01 | <0.01 | <0.01 | <0.01 | <0.01 | <0.01 |
| Sb₂O₃ | | <0.01 | <0.01 | <0.01 | <0.01 | <0.01 | <0.01 |
| HfO₂ | | 0.04 | 0.04 | 0.04 | 0.04 | 0.04 | 0.04 |
| Fe₂O₃ | ppm | 150 | 80 | 70 | 80 | 80 | 60 |
| MoO₃ | | 1.00 | <0.3 | <0.3 | <0.3 | <0.3 | <0.3 |
| Pt | | 20.00 | unmeasured | unmeasured | unmeasured | unmeasured | 1.00 |
| Rh | | 10.00 | unmeasured | unmeasured | unmeasured | unmeasured | 0.02 |
| V₂O₅ | | 2.00 | 2.00 | 3.00 | unmeasured | unmeasured | 2.00 |
| Nd₂O₃ | | <5 | <5 | <5 | <5 | <5 | <5 |
| Pr₆O₁₁ | | unmeasured | unmeasured | unmeasured | unmeasured | unmeasured | unmeasured |
| Sm₂O₃ | | unmeasured | unmeasured | unmeasured | unmeasured | unmeasured | unmeasured |
| Li₂O/BaO | — | 0.71 | 0.70 | 0.58 | 0.87 | 0.70 | 0.53 |
| Na₂O + K₂O | % by | 0.09 | 1.19 | 0.81 | 1.55 | 0.79 | 0.13 |
| | mass | | | | | | |
| MgO + CaO | % by | 0.01 | 0.02 | 0.02 | 0.02 | 0.02 | 0.02 |
| | mass | | | | | | |
| (Na₂O + K₂O + MgO)/BaO | — | 0.02 | 0.26 | 0.15 | 0.43 | 0.18 | 0.02 |
| 8Li₂O − 4 (Na₂O + K₂O + | % by | 20.60 | 16.16 | 16.63 | 15.77 | 17.71 | 18.71 |
| MgO) − (BaO + ZnO) | mass | | | | | | |
| (Li₂O + Na₂O + K₂O)/ZrO₂ | — | 1.30 | 2.04 | 1.86 | 2.19 | 1.38 | 1.51 |

TABLE 22

| | | | | | | |
|---|---|---|---|---|---|---|
| Unit | No.61 | No.62 | No.63 | No.64 | No.65 | No.66 |

Before Crystallization

| | | | | | | | |
|---|---|---|---|---|---|---|---|
| β-OH | /mm | 0.10 | 0.10 | 0.10 | 0.10 | 0.10 | 0.10 |
| Density | g/cm ³ | 2.48 | 2.48 | 2.49 | 2.47 | 2.49 | 2.50 |
| CLTE at 30-380° C. | ×10⁻⁷/° C. | 38.0 | unmeasured | unmeasured | unmeasured | unmeasured | 39.6 |
| Glass Transition Point Tg | ° C. | 734 | unmeasured | unmeasured | unmeasured | unmeasured | 733 |
| Deformation Point Tf | | 797 | unmeasured | unmeasured | unmeasured | unmeasured | 793 |
| 10 ⁴ | | 1371 | 1372 | 1369 | 1367 | 1360 | 1365 |
| 10 ^{3.5} | | 1454 | 1449 | 1452 | 1451 | 1443 | 1448 |
| 10 ³ | | 1551 | 1548 | 1549 | 1549 | 1539 | 1544 |
| 10 ^{2.5} | | 1666 | 1681 | 1667 | 1663 | 1651 | 1657 |
| Liquidus Temperature TL | | 1387 | 1384 | 1376 | 1390 | 1438 | 1370 |
| Liquidus Viscosity bg η | — | 3.9 | 3.91 | 3.96 | 3.85 | 3.53 | 3.97 |
| Primary Phase | — | ZrO₂ | ZrO₂, β- | ZrO₂ | ZrO₂ | ZrO₂ | ZrO₂ |
| | | | spodumene | | | | |

After Crystallization

| | | | | | | | |
|---|---|---|---|---|---|---|---|
| Crystallization Conditions | — | | | | | | |
| | | 780° C.-3 h | 780° C.-3 h | 780° C.-3 h | 780° C.-3 h | 780° C.-3 h | 780° C.-3 h |
| Precipitated Crystal | — | 920° C.-1 h | 920° C.-1 h | 920° C.-1 h | 920° C.-1 h | 920° C.-1 h | 905° C.-1 h |
| Crystallinity | % | β-quartz | β-quartz | β-quartz | β-quartz | β-quartz | β-quartz |
| Crystallite Size | nm | unmeasured | unmeasured | unmeasured | unmeasured | unmeasured | unmeasured |
| Density | g/cm ³ | 58 | 39 | 40 | 40 | 67 | 33 |
| CLTE at 30-380° C. | ×10⁻⁷/° C. | 2.57 | 2.55 | 2.56 | 2.53 | 2.55 | 2.58 |
| CLTE at 30-750° C. | | −1.5 | 3.6 | 2.9 | 4.4 | 1.5 | 0.5 |
| Total Transmittance L* | | −0.5 | 5.7 | 4.9 | 6.9 | 3.5 | 1.9 |
| Total Transmittance a* | | 92.7 | 93.5 | 94.2 | 92.6 | unmeasured | 94.8 |
| Total Transmittance b* | | −0.5 | −0.2 | −0.3 | −0.2 | unmeasured | −0.3 |
| Diffuse Transmittance L* | | 6.3 | 5.5 | 4.6 | 7.0 | unmeasured | 3.7 |
| Diffuse Transmittance a* | | unmeasured | 10.6 | 1.0 | 14.5 | unmeasured | 1.1 |
| Diffuse Transmittance b* | | unmeasured | 0.5 | 0.5 | 0.6 | unmeasured | 0.1 |
| Total Transmittance at 4 mm thickness | | unmeasured | −10.4 | −8.3 | −11.3 | unmeasured | −1.9 |
| and 1500 nm wave length | | 90.6 | 91.3 | 90.9 | 90.6 | 90.2 | unmeasured |
| and 1500 mm wave length | | | | | | | |

TABLE 23

| | Unit | No.67 | No.68 | No.69 | No.70 | No.71 | No.72 |
|---|---|---|---|---|---|---|---|
| SiO₂ | % by | 63.9 | 63.3 | 63.8 | 64.6 | 64.5 | 64.4 |
| Al₂O₃ | mass | 21.7 | 21.6 | 21.7 | 21.8 | 22.6 | 22.1 |
| Li₂O | | 3.18 | 3.25 | 3.27 | 3.19 | 3.19 | 3.19 |
| Na₂O | | 0.11 | 0.12 | 0.11 | 0.11 | 0.11 | 0.12 |
| K₂O | | 0.01 | 0.01 | 0.01 | 0.01 | 0.01 | 0.01 |
| MgO | | 0.24 | 0.01 | 0.24 | 0.01 | 0.01 | 0.01 |
| CaO | | 0.02 | 0.02 | 0.02 | 0.01 | 0.01 | 0.02 |
| BaO | | 5.21 | 6.08 | 5.20 | 3.86 | 3.86 | 3.85 |
| ZrO₂ | | 2.19 | 2.18 | 2.20 | 2.66 | 2.18 | 2.57 |
| TiO₂ | | 1.82 | 1.81 | 1.82 | 2.15 | 1.86 | 2.08 |
| P₂O₅ | | 1.36 | 1.36 | 1.36 | 1.37 | 1.37 | 1.37 |
| ZnO | | 0 | 0 | 0 | 0 | 0 | 0 |
| SnO₂ | | 0.27 | 0.28 | 0.27 | 0.28 | 0.28 | 0.29 |
| SrO | | 0.004 | 0.004 | 0.004 | 0.003 | 0.003 | 0.003 |
| PbO | | <0.001 | <0.001 | <0.001 | <0.001 | <0.001 | <0.001 |
| Cl | | <0.001 | <0.001 | <0.001 | <0.001 | <0.001 | <0.001 |
| As₂O₃ | | <0.01 | <0.01 | <0.01 | <0.01 | <0.0 | <0.01 |
| Sb₂O₃ | | <0.01 | <0.01 | <0.01 | <0.01 | <0.01 | <0.01 |
| HfO₂ | | 0.04 | 0.04 | 0.04 | 0.04 | 0.04 | 0.04 |
| Fe₂O₃ | ppm | 70 | 60 | 70 | 80 | 80 | 80 |
| MoO₃ | | <0.3 | <0.3 | <0.3 | 10.00 | <0.3 | 0.3 |
| Pt | | unmeasured | unmeasured | unmeasured | unmeasured | unmeasured | unmeasured |
| Rh | | unmeasured | unmeasured | unmeasured | unmeasured | unmeasured | unmeasured |
| V₂O₅ | | 2.00 | unmeasured | unmeasured | unmeasured | unmeasured | unmeasured |
| Nd₂O₃ | | <5 | <5 | <5 | <5 | <5 | <5 |
| Pr₆O₁₁ | | unmeasured | unmeasured | unmeasured | unmeasured | unmeasured | unmeasured |
| Sm₂O₃ | | unmeasured | unmeasured | unmeasured | unmeasured | unmeasured | unmeasured |
| Li₂O/BaO | — | 0.61 | 0.53 | 0.63 | 0.83 | 0.83 | 0.83 |
| Na₂O + K₂O | % by | 0.12 | 0.13 | 0.12 | 0.12 | 0.12 | 0.13 |
| | mass | | | | | | |
| MgO + CaO | % by | 0.26 | 0.03 | 0.26 | 0.02 | 0.02 | 0.03 |
| | mass | | | | | | |
| (Na₂O + K₂O + MgO)/BaO | — | 0.07 | 0.02 | 0.07 | 0.03 | 0.03 | 0.04 |
| 8Li₂O − 4 (Na₂O + K₂O + | % by | 18.79 | 19.36 | 19.52 | 21.14 | 21.14 | 21.11 |
| MgO) − (BaO + ZnO) | mass | | | | | | |
| (Li₂O + Na₂O + K₂O)/ZrO₂ | — | 1.51 | 1.55 | 1.54 | 1.24 | 1.52 | 1.29 |

TABLE 24

| | | | | | | |
|---|---|---|---|---|---|---|
| Unit | No.67 | No.68 | No.69 | No.70 | No.71 | No.72 |

Before Crystallization

| | | | | | | | |
|---|---|---|---|---|---|---|---|
| β-OH | /mm | 0.10 | 0.10 | 0.10 | 0.10 | 0.10 | 0.10 |
| Density | g/cm ³ | 2.49 | 2.51 | 2.49 | 2.48 | 2.47 | 2.48 |
| CLTE at 30-380° C. | ×10⁻⁷/° C. | unmeasured | unmeasured | unmeasured | unmeasured | unmeasured | unmeasured |
| Glass Transition Point Tg | ° C. | unmeasured | unmeasured | unmeasured | unmeasured | unmeasured | unmeasured |
| Deformation Point Tf | | unmeasured | unmeasured | unmeasured | unmeasured | unmeasured | unmeasured |
| 10 ⁴ | | 1360 | 1362 | 1356 | 1362 | 1365 | 1362 |
| 10 ^{3.5} | | 1443 | 1445 | 1438 | 1445 | 1448 | 1445 |
| 10 ³ | | 1539 | 1540 | 1533 | 1541 | 1543 | 1540 |
| 10 ^{2.5} | | 1651 | 1653 | 1645 | 1653 | 1655 | 1653 |
| Liquidus Temperature TL | | 1366 | unmeasured | 1371 | unmeasured | unmeasured | unmeasured |
| Liquidus Viscosity bg η | — | 3.96 | unmeasured | 3.90 | unmeasured | unmeasured | unmeasured |
| Primary Phase | — | ZrO₂ | unmeasured | ZrO₂ | unmeasured | unmeasured | unmeasured |

After Crystallization

| | | | | | | | |
|---|---|---|---|---|---|---|---|
| Crystallization Conditions | — | 780° C.-3 h | 780° C.-3 h | 780° C.-3 h | 780° C.-3 h | 780° C.-3 h | 780° C.-3 h |
| | | 905° C.-1 h | 905° C.-1 h | 905° C.-1 h | 905° C.-0.5 h | 905° C.-1 h | 905° C.-1 h |
| Precipitated Crystal | — | β-quartz | β-quartz | β-quartz | unmeasured | β-quartz | unmeasured |
| Crystallinity | % | unmeasured | unmeasured | unmeasured | unmeasured | unm easured | unmeasured |
| Crystallite Size | nm | unmeasured | 34 | 36 | unmeasured | 41 | unmeasured |
| Density | g/cm ³ | 2.58 | 2.58 | 2.58 | unmeasured | 2.57 | unmeasured |
| CLTE at 30-380° C. | ×10⁻⁷/° C. | unmeasured | 0.1 | unmeasured | unmeasured | unm easured | unmeasured |
| CLTE at 30-750° C. | | unmeasured | 1.8 | unmeasured | unmeasured | unmeasured | unmeasured |
| Total Transmittance L* | | 94.7 | 94.8 | 94.8 | unmeasured | 94.1 | unmeasured |
| Total Transmittance a* | | −0.3 | −0.4 | −0.3 | unmeasured | −0.2 | unmeasured |
| Total Transmittance b* | | 3.8 | 3.6 | 3.8 | unmeasured | 4.2 | unmeasured |
| Diffuse Transmittance L* | | 0.9 | 1.8 | 0.9 | unmeasured | 2.8 | unmeasured |
| Diffuse Transmittance a* | | 0.2 | 0.1 | 0.2 | unmeasured | 0.3 | unmeasured |
| Diffuse Transmittance b* | | −1.6 | −1.4 | −1.4 | unmeasured | −4.5 | unmeasured |
| Total Transmittance at 4 mm thickness | | unmeasured | unmeasured | unmeasured | unmeasured | unmeasured | unmeasured |
| and 1500 nm wave length | | | | | | | |

TABLE 25

| | Unit | No.73 | No.74 | No.75 | No.76 | No.77 | No.78 |
|---|---|---|---|---|---|---|---|
| SiO₂ | % by | 65.2 | 63.9 | 64.2 | 67.2 | 67.0 | 65.0 |
| Al₂O₃ | mass | 21.8 | 21.8 | 21.8 | 22.2 | 22.3 | 22.0 |
| Li₂O | | 3.29 | 3.32 | 3.42 | 3.29 | 3.38 | 3.58 |
| Na₂O | | 0.30 | 0.10 | 0.10 | 0.08 | 0.08 | 0.46 |
| K₂O | | 0.08 | 0.01 | 0.01 | 0.01 | 0.01 | 0.19 |
| MgO | | 0.01 | 0.12 | 0.12 | 0.86 | 0.86 | 0.34 |
| CaO | | 0.01 | 0.02 | 0.02 | 0.04 | 0.03 | 0.02 |
| BaO | | 3.72 | 4.99 | 4.56 | 0.49 | 0.48 | 2.58 |
| ZrO₂ | | 2.14 | 2.18 | 2.19 | 1.90 | 2.21 | 2.19 |
| TiO₂ | | 1.81 | 1.91 | 1.92 | 2.21 | 1.91 | 1.95 |
| P₂O₅ | | 1.40 | 1.35 | 1.37 | 1.43 | 1.43 | 1.35 |
| ZnO | | 0 | 0 | 0 | 0 | 0 | 0 |
| SnO₂ | | 0.29 | 0.26 | 0.27 | 0.29 | 0.29 | 0.30 |
| SrO | | 0.003 | 0.004 | 0.004 | 0.001 | 0.001 | 0.002 |
| PbO | | <0.001 | <0.001 | <0.001 | <0.001 | <0.001 | <0.001 |
| Cl | | <0.001 | <0.001 | <0.001 | 0.001 | <0.001 | <0.001 |
| As₂O₃ | | <0.01 | <0.01 | <0.01 | <0.01 | <0.01 | <0.01 |
| Sb₂O₃ | | <0.01 | <0.01 | <0.01 | <0.01 | <0.01 | <0.01 |
| HfO₂ | | 0.04 | 0.04 | 0.04 | 0.04 | 0.04 | 0.04 |
| Fe₂O₃ | ppm | 80 | 80 | 80 | 90 | 90 | 80 |
| MoO₃ | | <0.3 | <0.3 | <0.3 | <0.3 | <0.3 | 0.3 |
| Pt | | unmeasured | 1.00 | unmeasured | unmeasured | unmeasured | unmeasured |
| Rh | | unmeasured | 0.02 | unmeasured | unmeasured | unmeasured | unmeasured |
| V₂O₅ | | unmeasured | unmeasured | unmeasured | unmeasured | unmeasured | unmeasured |
| Nd₂O₃ | | <5 | <5 | <5 | <5 | <5 | <5 |
| Pr₆O₁₁ | | unmeasured | unmeasured | unmeasured | unmeasured | unmeasured | unmeasured |
| Sm₂O₃ | | unmeasured | unmeasured | unmeasured | unmeasured | unmeasured | unmeasured |
| Li₂O/BaO | — | 0.88 | 0.67 | 0.75 | 6.71 | 7.04 | 1.39 |
| Na₂O + K₂O | % by | 0.38 | 0.11 | 0.11 | 0.09 | 0.09 | 0.65 |
| | mass | | | | | | |
| MgO + CaO | % by | 0.02 | 0.14 | 0.14 | 0.90 | 0.89 | 0.36 |
| | mass | | | | | | |
| (Na₂O + K₂O + MgO)/BaO | — | 0.10 | 0.05 | 0.05 | 1.94 | 1.98 | 0.38 |
| 8Li₂O − 4 (Na₂O + K₂O + | % by | 21.04 | 20.65 | 21.88 | 22.03 | 22.76 | 22.10 |
| MgO) − (BaO + ZnO) | mass | | | | | | |
| (Li₂O + Na₂O + K₂O)/ZrO₂ | — | 1.71 | 1.57 | 1.61 | 1.78 | 1.57 | 1.93 |

TABLE 26

| | | | | | | |
|---|---|---|---|---|---|---|
| Unit | No.73 | No.74 | No.75 | No.76 | No.77 | No.78 |

Before Crystallization

| | | | | | | | |
|---|---|---|---|---|---|---|---|
| β-OH | /mm | 0.10 | 0.10 | 0.10 | 0.10 | 0.10 | 0.10 |
| Density | g/cm ³ | 2.46 | 2.49 | 2.48 | 2.42 | 2.42 | 2.45 |
| CLTE at 30-380° C. | ×10⁻⁷/° C. | unmeasured | 39.3 | 39.2 | 34.8 | 35.2 | 40.8 |
| Glass Transition Point Tg | ° C. | unmeasured | 737 | 735 | 734 | 732 | 725 |
| Deformation Point Tf | | unmeasured | 795 | 791 | 788 | 785 | 784 |
| 10 ⁴ | | 1372 | 1358 | 1356 | 1360 | 1358 | 1352 |
| 10 ^{3.5} | | 1455 | 1441 | 1440 | 1444 | 1441 | 1435 |
| 10 ³ | | 1552 | 1539 | 1535 | 1540 | 1538 | 1532 |
| 10 ^{2.5} | | 1667 | 1652 | 1647 | 1653 | 1651 | 1646 |
| Liquidus Temperature TL | | unmeasured | 1370 | 1364 | 1396 | 1391 | unmeasured |
| Liquidus Viscosity bg η | — | unmeasured | 3.92 | 3.95 | 3.78 | 3.79 | unmeasured |
| Primary Phase | — | unmeasured | ZrO₂ | ZrO₂ | mullite | mullite | unmeasured |

After Crystallization

| | | | | | | | |
|---|---|---|---|---|---|---|---|
| Crystallization Conditions | — | 780° C.-3 h | 780° C.-3 h | 780° C.-3 h | 780° C.-3 h | 780° C.-3 h | 780° C.-3 h |
| | | 905° C.-1 h | 920° C.-1 h | 920° C.-1 h | 920° C.-1 h | 920° C.-1 h | 920° C.-1 h |
| Precipitated Crystal | — | β-quartz | β-quartz | β-quartz | unmeasured | unmeasured | unmeasured |
| Crystallinity | % | unmeasured | unmeasured | unmeasured | unmeasured | unmeasured | unmeasured |
| Crystallite Size | nm | 37 | 38 | 38 | unmeasured | unmeasured | unmeasured |
| Density | g/cm ³ | 2.55 | 2.58 | 2.57 | 2.56 | 2.55 | 2.54 |
| CLTE at 30-380° C. | ×10⁻⁷/° C. | unmeasured | −1.5 | −2.8 | −0.7 | −1.5 | −1.1 |
| CLTE at 30-750° C. | | unmeasured | 0.2 | −1.0 | −0.6 | −1.4 | 0.7 |
| Total Transmittance L* | | 94.2 | 94.5 | 94.5 | unmeasured | unmeasured | unmeasured |
| Total Transmittance a* | | −0.3 | −0.4 | −0.4 | unmeasured | unmeasured | unmeasured |
| Total Transmittance b* | | 4.0 | 4.4 | 4.4 | unmeasured | unmeasured | unmeasured |
| Diffuse Transmittance L* | | 3.0 | 1.3 | 1.2 | unmeasured | unmeasured | unmeasured |
| Diffuse Transmittance a* | | 0.3 | 0.0 | 0.0 | unmeasured | unmeasured | unmeasured |
| Diffuse Transmittance b* | | −4.9 | −1.2 | −1.2 | unmeasured | unmeasured | unmeasured |
| Total Transmittance at 4 mm thickness | | unmeasured | unmeasured | unmeasured | unmeasured | unmeasured | unmeasured |
| and 1500 nm wave length | | | | | | | |

TABLE 27

| | Unit | No.79 | No.80 | No.81 | No.82 | No.83 | No.84 |
|---|---|---|---|---|---|---|---|
| SiO₂ | % by | 64.6 | 64.8 | 63.4 | 64.0 | 64.3 | 64.3 |
| Al₂O₃ | mass | 21.8 | 22.7 | 22.4 | 21.7 | 21.4 | 21.5 |
| Li₂O | | 3.55 | 3.30 | 3.16 | 3.32 | 3.32 | 3.32 |
| Na₂O | | 0.45 | 0.29 | 0.11 | 0.09 | 0.09 | 0.08 |
| K₂O | | 0.18 | 0.08 | 0.01 | 0.01 | 0.01 | 0.01 |
| MgO | | 0.06 | 0.19 | 0.01 | 0.12 | 0.12 | 0.12 |
| CaO | | 0.01 | 0.02 | 0.01 | 0.02 | 0.01 | 0.01 |
| BaO | | 3.63 | 3.00 | 6.08 | 4.99 | 5.11 | 5.13 |
| ZrO₂ | | 2.18 | 2.12 | 1.78 | 2.18 | 2.13 | 2.07 |
| TiO₂ | | 1.93 | 1.85 | 1.43 | 1.93 | 1.91 | 1.89 |
| P₂O₅ | | 1.34 | 1.42 | 1.38 | 1.36 | 1.33 | 1.30 |
| ZnO | | 0 | 0 | 0 | 0 | 0 | 0 |
| SnO₂ | | 0.30 | 0.27 | 0.28 | 0.26 | 0.25 | 0.25 |
| SrO | | 0.002 | 0.003 | 0.005 | unmeasured | 0.004 | 0.005 |
| PbO | | <0.001 | <0.001 | <0.001 | <0.001 | <0.001 | <0.001 |
| Cl | | <0.001 | <0.001 | <0.001 | <0.001 | <0.001 | <0.001 |
| As₂O₃ | | <0.01 | <0.0 | <0.01 | <0.01 | <0.01 | <0.01 |
| Sb₂O₃ | | <0.01 | <0.0 | <0.01 | <0.01 | <0.01 | <0.01 |
| HfO₂ | | 0.04 | 0.04 | 0.03 | unmeasured | 0.04 | 0.04 |
| Fe₂O₃ | ppm | 80 | 80 | 70 | unmeasured | 90 | 70 |
| MoO₃ | | <0.3 | <0.3 | <0.3 | <0.3 | <0.3 | <0.3 |
| Pt | | unmeasured | unmeasured | unmeasured | unmeasured | unmeasured | unmeasured |
| Rh | | unmeasured | unmeasured | unmeasured | unmeasured | unmeasured | unmeasured |
| V₂O₅ | | unmeasured | unmeasured | unmeasured | unmeasured | unmeasured | unmeasured |
| Nd₂O₃ | | <5 | <5 | <5 | <5 | <5 | 5 |
| Pr₆O₁₁ | | unmeasured | unmeasured | unmeasured | unmeasured | unmeasured | unmeasured |
| Sm₂O₃ | | unmeasured | unmeasured | unmeasured | unmeasured | unmeasured | unmeasured |
| Li₂O/BaO | — | 0.98 | 1.10 | 0.52 | 0.67 | 0.65 | 0.65 |
| Na₂O + K₂O | % by | 0.63 | 0.37 | 0.12 | 0.10 | 0.10 | 0.09 |
| | mass | | | | | | |
| MgO + CaO | % by | 0.07 | 0.21 | 0.02 | 0.14 | 0.13 | 0.13 |
| | mass | | | | | | |
| (Na₂O + K₂O + MgO)/BaO | — | 0.19 | 0.19 | 0.02 | 0.04 | 0.04 | 0.04 |
| 8Li₂O − 4 (Na₂O + K₂O + | % by | 22.01 | 21.16 | 18.68 | 20.69 | 20.57 | 20.59 |
| MgO) − (BaO + ZnO) | mass | | | | | | |
| (Li₂O + Na₂O + K₂O)/ZrO₂ | — | 1.92 | 1.73 | 1.84 | 1.57 | 1.61 | 1.65 |

TABLE 28

| | | | | | | |
|---|---|---|---|---|---|---|
| Unit | No.79 | No.80 | No.81 | No.82 | No.83 | No.84 |

Before Crystallization

| | | | | | | | |
|---|---|---|---|---|---|---|---|
| β-OH | /mm | 0.10 | 0.10 | 0.10 | 0.10 | 0.40 | 0.40 |
| Density | g/cm ³ | 2.47 | 2.46 | 2.50 | 2.49 | 2.49 | 2.49 |
| CLTE at 30-380° C. | ×10⁻⁷/° C. | 41.6 | unmeasured | unmeasured | unmeasured | unmeasured | unmeasured |
| Glass Transition Point Tg | ° C. | 729 | unmeasured | unmeasured | unmeasured | unmeasured | unmeasured |
| Deformation Point Tf | | 789 | unmeasured | unmeasured | unmeasured | unmeasured | unmeasured |
| 10 ⁴ | | 1357 | 1359 | 1370 | 1359.6488 | 1363.1831 | 1359.4664 |
| 10 ^{3.5} | | 1440 | 1441 | 1453 | 1442.5593 | 1446.6926 | 1442.2471 |
| 10 ³ | | 1536 | 1537 | 1548 | 1538.4018 | 1543.1955 | 1537.9877 |
| 10 ^{2.5} | | 1650 | 1649 | 1658 | 1651.4759 | 1657.0032 | 1650.9562 |
| Liquidus Temperature TL | | unmeasured | unmeasured | unmeasured | unmeasured | unmeasured | unmeasured |
| Liquidus Viscosity bg η | — | unmeasured | unmeasured | unmeasured | unmeasured | unmeasured | unmeasured |
| Primary Phase | — | unmeasured | unmeasured | unmeasured | unmeasured | unmeasured | unmeasured |

After Crystallization

| | | | | | | | |
|---|---|---|---|---|---|---|---|
| Crystallization Conditions | — | 780° C.-3 h | 780° C.-3 h | 780° C.-3 h | 780° C.-3 h | 780° C.-3 h | 780° C.-3 h |
| | | 920° C.-1 h | 920° C.-1 h | 920° C.-1 h | 920° C.-1 h | 920° C.-1 h | 920° C.-1 h |
| Precipitated Crystal | — | β-quartz | β-quartz | unmeasured | unmeasured | unmeasured | β-quartz |
| Crystallinity | % | unmeasured | unmeasured | unmeasured | unmeasured | unmeasured | unmeasured |
| Crystallite Size | nm | 40 | 37 | unmeasured | unmeasured | unmeasured | 37 |
| Density | g/cm ³ | 2.56 | 2.57 | unmeasured | unmeasured | unmeasured | unmeasured |
| CLTE at 30-380° C. | ×10⁻⁷/° C. | −2.2 | unmeasured | unmeasured | unmeasured | unmeasured | unmeasured |
| CLTE at 30-750° C. | | 0.1 | unmeasured | unmeasured | unmeasured | unmeasured | unmeasured |
| Total Transmittance L* | | 94.1 | 94.6 | unmeasured | unmeasured | unmeasured | 94.4 |
| Total Transmittance a* | | −0.4 | −0.3 | unmeasured | unmeasured | unmeasured | −0.4 |
| Total Transmittance b* | | 4.7 | 5.1 | unmeasured | unmeasured | unmeasured | 3.8 |
| Diffuse Transmittance L* | | 2.6 | 2.0 | unmeasured | unmeasured | unmeasured | 0.8 |
| Diffuse Transmittance a* | | 0.1 | 0.3 | unmeasured | unmeasured | unmeasured | 0.1 |
| Diffuse Transmittance b* | | −4.0 | −3.8 | unmeasured | unmeasured | unmeasured | −1.3 |
| Total Transmittance at 4 mm thickness | | unmeasured | unmeasured | unmeasured | unmeasured | unmeasured | unmeasured |
| and 1500 nm wave length | | | | | | | |

TABLE 29

| | Unit | No.85 | No.86 | No.87 | No.88 | No.89 | No.90 |
|---|---|---|---|---|---|---|---|
| SiO₂ | % by | 64.1 | 64.3 | 63.5 | 63.5 | 64.0 | 63.7 |
| Al₂O₃ | mass | 21.8 | 21.7 | 21.7 | 21.7 | 21.8 | 22.0 |
| Li₂O | | 3.32 | 3.32 | 3.30 | 3.30 | 3.32 | 3.31 |
| Na₂O | | 0.09 | 0.09 | 0.10 | 0.10 | 0.10 | 0.09 |
| K₂O | | 0.01 | 0.01 | 0.01 | 0.01 | 0.01 | 0.01 |
| MgO | | 0.12 | 0.12 | 0.00 | 0.00 | 0.00 | 0.00 |
| CaO | | 0.01 | 0.01 | 0.02 | 0.01 | 0.01 | 0.01 |
| BaO | | 5.00 | 4.94 | 5.68 | 6.41 | 5.71 | 5.24 |
| ZrO₂ | | 2.11 | 2.05 | 2.17 | 2.17 | 2.18 | 2.18 |
| TiO₂ | | 1.89 | 1.89 | 1.88 | 1.89 | 1.90 | 1.89 |
| P₂O₅ | | 1.33 | 1.28 | 1.35 | 0.68 | 0.68 | 1.35 |
| ZnO | | 0 | 0 | 0 | 0 | 0 | 0 |
| SnO₂ | | 0.26 | 0.24 | 0.27 | 0.26 | 0.26 | 0.27 |
| SrO | | 0.005 | 0.006 | 0.008 | 0.005 | 0.006 | 0.005 |
| PbO | | <0.001 | <0.001 | <0.001 | <0.001 | <0.001 | <0.001 |
| Cl | | <0.001 | <0.001 | <0.001 | <0.001 | <0.001 | <0.001 |
| As₂O₃ | | <0.01 | <0.01 | <0.01 | <0.01 | <0.01 | <0.01 |
| Sb₂O₃ | | <0.01 | <0.01 | <0.01 | <0.01 | <0.01 | <0.01 |
| HfO₂ | | 0.04 | 0.04 | 0.04 | 0.04 | 0.04 | 0.04 |
| Fe₂O₃ | ppm | 70 | 70 | 80 | 60 | 60 | 70 |
| MoO₃ | | <0.3 | <0.3 | <0.3 | <0.3 | <0.3 | <0.3 |
| Pt | | unmeasured | unmeasured | unmeasured | unmeasured | unmeasured | unmeasured |
| Rh | | unmeasured | unmeasured | unmeasured | unmeasured | unmeasured | unmeasured |
| V₂O₅ | | unmeasured | unmeasured | unmeasured | unmeasured | unmeasured | 2.00 |
| Nd₂O₃ | | <5 | <5 | <5 | <5 | <5 | <5 |
| Pr₆O₁₁ | | unmeasured | unmeasured | unmeasured | unmeasured | unmeasured | unmeasured |
| Sm₂O₃ | | unmeasured | unmeasured | unmeasured | unmeasured | unmeasured | unmeasured |
| Li₂O/BaO | — | 0.66 | 0.67 | 0.58 | 0.51 | 0.58 | 0.63 |
| Na₂O + K₂O | % by | 0.10 | 0.10 | 0.11 | 0.11 | 0.11 | 0.10 |
| | mass | | | | | | |
| MgO + CaO | % by | 0.13 | 0.13 | 0.02 | 0.01 | 0.01 | 0.01 |
| | mass | | | | | | |
| (Na₂O + K₂O + MgO)/BaO | — | 0.04 | 0.04 | 0.02 | 0.02 | 0.02 | 0.02 |
| 8Li₂O − 4 (Na₂O + K₂O + | % by | 20.68 | 20.74 | 20.28 | 19.55 | 20.41 | 20.84 |
| MgO) − (BaO + ZnO) | mass | | | | | | |
| (Li₂O + Na₂O + K₂O)/ZrO₂ | — | 1.62 | 1.67 | 1.57 | 1.57 | 1.57 | 1.56 |

TABLE 30

| | | | | | | |
|---|---|---|---|---|---|---|
| Unit | No.85 | No.86 | No.87 | No.88 | No.89 | No.90 |

Before Crystallization

| | | | | | | | |
|---|---|---|---|---|---|---|---|
| β-OH | /mm | 0.40 | 0.40 | 0.10 | 0.10 | 0.10 | 0.10 |
| Density | g/cm ³ | 2.49 | 2.49 | 2.50 | 2.52 | 2.50 | 2.49 |
| CLTE at 30-380° C. | ×10⁻⁷/° C. | unmeasured | unmeasured | unmeasured | unmeasured | unmeasured | unmeasured |
| Glass Transition Point Tg | | unmeasured | unmeasured | unmeasured | unmeasured | unmeasured | unmeasured |
| Deformation Point Tf | | unmeasured | unmeasured | unmeasured | unmeasured | unmeasured | unmeasured |
| 10 ⁴ | | 1359.4664 | 1359 | 1360.8472 | 1355.8997 | 1358.7937 | 1361.1289 |
| 10 ^{3.5} | | 1442.2471 | 1442 | 1443.6015 | 1438.2614 | 1441.4296 | 1443.6899 |
| 10 ³ | | 1537.9877 | 1538 | 1539.3143 | 1533.9098 | 1537.2939 | 1539.18 |
| 10 ^{2.5} | | 1650.9562 | 1651 | 1652.521 | 1647.1984 | 1650.6936 | 1652.0475 |
| Liquidus Temperature TL | | unmeasured | 1373 | unmeasured | unmeasured | unmeasured | unmeasured |
| Liquidus Viscosity bg η | — | unmeasured | unmeasured | unmeasured | unmeasured | unmeasured | unmeasured |
| Primary Phase | — | unmeasured | ZrO₂ | unmeasured | unmeasured | unmeasured | unmeasured |

After Crystallization

| | | | | | | | |
|---|---|---|---|---|---|---|---|
| Crystallization Conditions | — | 780° C.-3 h | 780° C.-3 h | 780° C.-3 h | 780° C.-3 h | 780° C.-3 h | 780° C.-3 h |
| | | 920° C.-1 h | 920° C.-1 h | 920° C.-1 h | 920° C.-1 h | 920° C.-1 h | 920° C.-1 h |
| Precipitated Crystals | — | β-quartz | β-quartz | β-quartz | β-quartz | β-quartz | β-quartz |
| Crystallinity | % | unmeasured | unmeasured | unmeasured | unmeasured | unmeasured | unmeasured |
| Crystallite Size | nm | 40 | 37 | 36 | 38 | 42 | 37 |
| Density | g/cm ³ | unmeasured | unmeasured | unmeasured | unmeasured | unmeasured | unmeasured |
| CLTE at 30-380° C. | ×10⁻⁷/° C. | unmeasured | unmeasured | unmeasured | unmeasured | unmeasured | unmeasured |
| CLTE at 30-750° C. | | unmeasured | unmeasured | unmeasured | unmeasured | unmeasured | unmeasured |
| Total Transmittance L* | — | 94.5 | 94.6 | 94.6 | 94.5 | 94.7 | 94.2 |
| Total Transmittance a* | | −0.4 | −0.3 | −0.4 | −0.4 | −0.4 | −0.3 |
| Total Transmittance b* | | 4.2 | 3.9 | 4.1 | 4.1 | 4.2 | 3.8 |
| Diffuse Transmittance L* | | 0.9 | 1.2 | 1.0 | 1.3 | 1.3 | 1.1 |
| Diffuse Transmittance a* | | 0.1 | 0.1 | 0.1 | 0.1 | 0.1 | 0.1 |
| Diffuse Transmittance b* | | −1.4 | −1.5 | −1.3 | −2.0 | −2.1 | −1.5 |
| Total Transmittance at 4 mm thickness | | unmeasured | unmeasured | unmeasured | unmeasured | unmeasured | unmeasured |
| and 1500 nm wave length | | | | | | | |

TABLE 31

| | Unit | No.91 | No.92 | No.93 | No.94 | No.95 | No.96 |
|---|---|---|---|---|---|---|---|
| SiO₂ | % by | 63.9 | 64.1 | 63.9 | 63.8 | 63.9 | 64.1 |
| Al₂O₃ | mass | 22.3 | 21.8 | 22.0 | 21.7 | 21.9 | 21.8 |
| Li₂O | | 3.31 | 3.32 | 3.32 | 3.31 | 3.32 | 3.40 |
| Na₂O | | 0.10 | 0.09 | 0.10 | 0.10 | 0.09 | 0.08 |
| K₂O | | 0.01 | 0.01 | 0.01 | 0.01 | 0.01 | 0.01 |
| MgO | | 0.00 | 0.12 | 0.12 | 0.12 | 0.12 | 0.12 |
| CaO | | 0.01 | 0.02 | 0.02 | 0.02 | 0.02 | 0.02 |
| BaO | | 4.80 | 4.99 | 4.99 | 5.38 | 4.98 | 4.96 |
| ZrO₂ | | 2.19 | 2.19 | 2.18 | 2.19 | 2.34 | 2.19 |
| TiO₂ | | 1.89 | 1.73 | 1.73 | 1.73 | 1.73 | 1.73 |
| P₂O₅ | | 1.35 | 1.36 | 1.35 | 1.36 | 1.36 | 1.37 |
| ZnO | | 0 | 0 | 0 | 0 | 0 | 0 |
| SnO₂ | | 0.25 | 0.28 | 0.28 | 0.28 | 0.28 | 0.27 |
| SrO | | 0.005 | 0.004 | 0.004 | 0.005 | 0.005 | 0.004 |
| PbO | | <0.001 | <0.001 | <0.001 | <0.001 | 0.001 | <0.001 |
| Cl | | <0.001 | <0.001 | <0.001 | <0.001 | <0.001 | <0.001 |
| As₂O₃ | | <0.01 | <0.01 | <0.01 | <0.01 | <0.01 | <0.01 |
| Sb₂O₃ | | <0.01 | <0.01 | <0.0 | 0.01 | <0.01 | <0.01 |
| HfO₂ | | 0.04 | 0.04 | 0.04 | 0.04 | 0.04 | 0.04 |
| Fe₂O₃ | ppm | 70 | 80 | 70 | 80 | 80 | 80 |
| MoO₃ | | <0.3 | <0.3 | <0.3 | <0.3 | <0.3 | <0.3 |
| Pt | | unmeasured | 0.50 | unmeasured | unmeasured | unmeasured | unmeasured |
| Rh | | unmeasured | 0.10 | unmeasured | unmeasured | unmeasured | unmeasured |
| V₂O₅ | | 2.00 | 2.00 | 2.00 | 1.00 | 2.00 | 2.00 |
| Nd₂O₃ | | <5 | <5 | <5 | <5 | <5 | <5 |
| Pr₆O₁₁ | | unmeasured | unmeasured | unmeasured | unmeasured | unmeasured | unmeasured |
| Sm₂O₃ | | unmeasured | unmeasured | unmeasured | unmeasured | unmeasured | unmeasured |
| Li₂O/BaO | — | 0.69 | 0.67 | 0.67 | 0.62 | 0.67 | 0.69 |
| Na₂O + K₂O | % by | 0.11 | 0.10 | 0.11 | 0.11 | 0.10 | 0.09 |
| | mass | | | | | | |
| MgO + CaO | % by | 0.01 | 0.14 | 0.14 | 0.14 | 0.14 | 0.14 |
| | mass | | | | | | |
| (Na₂O + K₂O + MgO)/BaO | — | 0.02 | 0.04 | 0.05 | 0.04 | 0.04 | 0.04 |
| 8Li₂O − 4 (Na₂O + K₂O + | % by | 21.24 | 20.69 | 20.65 | 20.18 | 20.70 | 21.40 |
| MgO) − (BaO + ZnO) | mass | | | | | | |
| (Li₂O + Na₂O + K₂O)/ZrO₂ | — | 1.56 | 1.56 | 1.57 | 1.56 | 1.46 | 1.59 |

TABLE 32

| | | | | | | |
|---|---|---|---|---|---|---|
| Unit | No.91 | No.92 | No.93 | No.94 | No.95 | No.96 |

Before Crystallization

| | | | | | | | |
|---|---|---|---|---|---|---|---|
| β-OH | /mm | 0.20 | 0.20 | 0.20 | 0.20 | 0.10 | 0.10 |
| Density | g/cm ³ | 2.49 | 2.49 | 2.49 | 2.50 | 2.49 | 2.49 |
| CLTE at 30-380° C. | ×10⁻⁷/° C. | unmeasured | unmeasured | unmeasured | unmeasured | unmeasured | unmeasured |
| Glass Transition Point Tg | ° C. | unmeasured | unmeasured | unmeasured | unmeasured | unmeasured | unmeasured |
| Deformation Point Tf | | unmeasured | unmeasured | unmeasured | unmeasured | unmeasured | unmeasured |
| 10 ⁴ | | 1361.3983 | 1363 | 1361.2573 | 1360.9114 | 1359.7675 | 1359.9535 |
| 10 ^{3.5} | | 1443.763 | 1446 | 1443.7222 | 1443.6758 | 1442.3211 | 1442.8542 |
| 10 ³ | | 1539.0277 | 1541 | 1539.2259 | 1539.4956 | 1537.7194 | 1538.7212 |
| 10 ^{2.5} | | 1651.5527 | 1654 | 1651.9011 | 1652.6059 | 1650.3404 | 1651.785 |
| Liquidus Temperature TL | | unmeasured | 1378 | 1377 | 1377 | unmeasured | 1392 |
| Liquidus Viscosity bg η | — | unmeasured | 3.90 | 3.90 | 3.90 | unmeasured | 3.80 |
| Primary Phase | — | unmeasured | ZrO₂ | ZrO₂ | ZrO₂ | unmeasured | ZrO₂ |

After Crystallization

| | | | | | | | |
|---|---|---|---|---|---|---|---|
| Crystallization Conditions | — | 780° C.-3 h | 780° C.-3 h | 780° C.-3 h | 780° C.-3 h | 780° C.-3 h | 780° C.-3 h |
| | | 920° C.-1 h | 920° C.-1 h | 920° C.-1 h | 920° C.-1 h | 920° C.-1 h | 920° C.-1 h |
| Precipitated Crystals | — | β-quartz | β-quartz | β-quartz | β-quartz | unmeasured | β-quartz |
| Crystallinity | % | unmeasured | 78 | unmeasured | unmeasured | unmeasured | unmeasured |
| Crystallite Size | nm | 39 | 25 | unmeasured | unmeasured | unmeasured | unmeasured |
| Density | g/cm ³ | unmeasured | 2.58 | 2.58 | 2.58 | 2.58 | unmeasured |
| CLTE at 30-380° C. | ×10⁻⁷/° C. | unmeasured | −1.1 | −1.2 | −0.8 | unmeasured | unmeasured |
| CLTE at 30-750° C. | | unmeasured | 0.2 | 0.4 | 0.8 | unmeasured | unmeasured |
| Total Transmittance L* | — | 94.5 | 94.4 | 94.2 | 94.4 | 94.4 | 94.7 |
| Total Transmittance a* | | −0.3 | −0.3 | −0.3 | −0.3 | −0.4 | −0.3 |
| Total Transmittance b* | | 4.4 | 4.1 | 4.2 | 4.5 | 4.5 | 4.0 |
| Diffuse Transmittance L* | | 1.1 | 0.8 | 0.8 | 0.9 | 1.8 | 0.7 |
| Diffuse Transmittance a* | | 0.1 | 0.1 | 0.1 | 0.1 | 0.1 | 0.1 |
| Diffuse Transmittance b* | | −1.7 | −1.4 | −1.4 | −1.5 | −2.4 | −1.1 |
| Total Transmittance at 4 mm thickness | | unmeasured | unmeasured | unmeasured | unmeasured | unmeasured | unmeasured |
| and 1500 nm wave length | | | | | | | |

TABLE 33

| | Unit | No.97 | No.98 | No.99 | No.100 | No.101 | No.102 |
|---|---|---|---|---|---|---|---|
| SiO₂ | % by | 63.9 | 63.9 | 64.2 | 65.6 | 66.2 | 66.8 |
| Al₂O₃ | mass | 21.8 | 21.8 | 21.8 | 22.3 | 22.3 | 22.4 |
| Li₂O | | 3.31 | 3.32 | 3.32 | 3.60 | 3.61 | 3.63 |
| Na₂O | | 0.08 | 0.08 | 0.10 | 0.45 | 0.47 | 0.46 |
| K₂O | | 0.01 | 0.01 | 0.01 | 0.18 | 0.18 | 0.19 |
| MgO | | 0.12 | 0.12 | 0.12 | 0.67 | 0.68 | 0.67 |
| CaO | | 0.02 | 0.02 | 0.02 | 0.03 | 0.03 | 0.04 |
| BaO | | 4.94 | 4.96 | 4.99 | 1.30 | 1.31 | 1.32 |
| ZrO₂ | | 2.18 | 2.19 | 2.18 | 2.22 | 2.23 | 2.23 |
| TiO₂ | | 1.73 | 1.73 | 1.70 | 1.95 | 1.97 | 1.98 |
| P₂O₅ | | 1.34 | 1.36 | 1.35 | 1.39 | 0.70 | 0.02 |
| ZnO | | 0 | 0.22 | 0 | 0 | 0 | 0 |
| SnO₂ | | 0.59 | 0.26 | 0.26 | 0.27 | 0.28 | 0.28 |
| SrO | | 0.003 | 0.004 | unmeasured | 0.00 | 0.00 | 0.01 |
| PbO | | <0.001 | 0.001 | <0.001 | <0.001 | 0.001 | <0.001 |
| Cl | | <0.001 | 0.001 | <0.001 | <0.001 | <0.001 | <0.001 |
| As₂O₃ | | <0.01 | <0.01 | <0.01 | <0.01 | <0.01 | <0.01 |
| Sb₂O₃ | | <0.01 | <0.01 | <0.01 | <0.01 | <0.01 | <0.01 |
| HfO₂ | | 0.04 | 0.04 | unmeasured | unmeasured | unmeasured | unmeasured |
| Fe₂O₃ | ppm | 80 | 80 | unmeasured | 100.00 | 90.00 | 100.00 |
| MoO₃ | | <0.3 | <0.3 | <0.3 | <0.3 | <0.3 | <0.3 |
| Pt | | unmeasured | unmeasured | unmeasured | unmeasured | unmeasured | unmeasured |
| Rh | | unmeasured | unmeasured | unmeasured | unmeasured | unmeasured | unmeasured |
| V₂O₅ | | 3.00 | 2.00 | 2.00 | unmeasured | unmeasured | unmeasured |
| Nd₂O₃ | | <5 | <5 | <5 | <5 | <5 | <5 |
| Pr₆O₁₁ | | unmeasured | unmeasured | unmeasured | unmeasured | unmeasured | unmeasured |
| Sm₂O₃ | | unmeasured | unmeasured | unmeasured | unmeasured | unmeasured | unmeasured |
| Li₂O/BaO | — | 0.67 | 0.67 | 0.67 | 2.77 | 2.76 | 2.75 |
| Na₂O + K₂O | % by | 0.09 | 0.09 | 0.11 | 0.63 | 0.65 | 0.65 |
| | mass | | | | | | |
| MgO + CaO | % by | 0.14 | 0.14 | 0.14 | 0.70 | 0.71 | 0.71 |
| | mass | | | | | | |
| (Na₂O + K₂O + MgO)/BaO | — | 0.04 | 0.04 | 0.05 | 1.00 | 1.02 | 1.00 |
| 8Li₂O − 4 (Na₂O + K₂O + | % by | 20.70 | 20.54 | 20.65 | 22.30 | 22.25 | 22.44 |
| MgO) − (BaO + ZnO) | mass | | | | | | |
| (Li₂O + Na₂O + K₂O)/ZrO₂ | — | 1.56 | 1.56 | 1.57 | 1.91 | 1.91 | 1.92 |

TABLE 34

| | | | | | | |
|---|---|---|---|---|---|---|
| Unit | No.97 | No.98 | No.99 | No.100 | No.101 | No.102 |

Before Crystallization

| | | | | | | | |
|---|---|---|---|---|---|---|---|
| β-OH | /mm | 0.10 | 0.10 | 0.10 | 0.10 | 0.10 | 0.10 |
| Density | g/cm ³ | 2.49 | 2.49 | 2.49 | 2.43 | 2.44 | 2.44 |
| CLTE at 30-380° C. | ×10⁻⁷/° C. | unmeasured | unmeasured | unmeasured | 39.8 | 39.3 | 39.6 |
| Glass Transition Point Tg | ° C. | unmeasured | unmeasured | unmeasured | 726 | 728 | 727 |
| Deformation Pont Tf | | unmeasured | unmeasured | unmeasured | 780 | 779 | 782 |
| 10 ⁴ | | 1359.8713 | 1360 | 1362.2868 | 1344 | 1346 | 1345 |
| 10 ^{3.5} | | 1442.3974 | 1443 | 1445.1116 | 1427 | 1429 | 1429 |
| 10 ³ | | 1538.4402 | 1539 | 1540.95 | 1523 | 1526 | 1525 |
| 10 ^{2.5} | | 1651.5743 | 1651 | 1653.9877 | 1635 | 1639 | 1638 |
| Liquidus Temperature TL | | 1380 | 1377 | unmeasured | 1368 | 1366 | 1367 |
| Liquidus Viscosity bg η | — | unmeasured | unmeasured | unmeasured | 3.85 | 3.87 | 3.86 |
| Primary Phase | — | ZrO₂ | ZrO₂ | unmeasured | ZrO₂ | ZrO₂, | ZrO₂, |
| | | | | | | mullite | m ullite |

After Crystallization

| | | | | | | | |
|---|---|---|---|---|---|---|---|
| Crystallization Conditions | — | 780° C.-3 h | 780° C.-3 h | 780° C.-3 h | 780° C.-3 h | 780° C.-3 h | 780° C.-3 h |
| | | 920° C.-1 h | 920° C.-1 h | 920° C.-1 h | 905° C.-1 h | 905° C.-1 h | 905° C.-1 h |
| Precipitated Crystal | — | β-quartz | β-quartz | unmeasured | β-quartz | β-quartz | β-quartz |
| Crystallinity | % | unmeasured | unmeasured | unmeasured | 86 | 87 | 86 |
| Crystallite Size | nm | unmeasured | 35 | unmeasured | 28 | 29 | 31 |
| Density | g/cm ³ | 2.58 | unmeasured | unmeasured | 2.53 | 2.53 | 2.53 |
| CLTE at 30-380° C. | ×10⁻⁷/° C. | unmeasured | −1.8 | unmeasured | −0.8 | −0.5 | −0.5 |
| CLTE at 30-750° C. | | unmeasured | −0.3 | unmeasured | 0.4 | 0.8 | 1.0 |
| Total Transmittance L* | | 94.4 | 94.7 | unmeasured | 94.2 | 94.2 | 94.1 |
| Total Transmittance a* | | −0.9 | −0.4 | unmeasured | −0.6 | −0.7 | −0.8 |
| Total Transmittance b* | | 5.6 | 4.0 | unmeasured | 5.1 | 5.3 | 5.4 |
| Diffuse Transmittance L* | | unmeasured | 0.9 | unmeasured | 1.4 | 1.5 | 2.2 |
| Diffuse Transmittance a* | | unmeasured | 0.1 | unmeasured | 0.1 | 0.2 | 0.3 |
| Diffuse Transmittance b* | | unmeasured | −1.7 | unmeasured | −1.8 | −2.5 | −3.7 |
| Total Transmittance at 4 mm thickness | | unmeasured | unmeasured | unmeasured | unmeasured | unmeasured | unmeasured |
| and 1500 nm wave length | | | | | | | |

TABLE 35

| | Unit | No.103 | No.104 | No.105 | No.106 | No.107 | No.108 |
|---|---|---|---|---|---|---|---|
| SiO₂ | % by | 64.6 | 64.3 | 63.6 | 64.6 | 65.0 | 64.8 |
| Al₂O₃ | mass | 22.0 | 21.9 | 21.7 | 21.2 | 21.2 | 22.1 |
| Li₂O | | 3.33 | 3.55 | 3.51 | 3.57 | 3.57 | 2.70 |
| Na₂O | | 0.09 | 0.1 | 0.1 | 0.1 | 0.1 | 0.12 |
| K₂O | | 0.01 | 0.01 | 0.01 | 0.01 | 0.01 | 0.01 |
| MgO | | 0.12 | 0.66 | 0.36 | 0.97 | 0.61 | 0.40 |
| CaO | | 0.00 | 0.01 | 0.01 | 0.01 | 0.01 | 0.03 |
| BaO | | 5.00 | 3.68 | 5.23 | 3.70 | 3.69 | 3.03 |
| ZrO₂ | | 2.20 | 2.19 | 2.17 | 2.20 | 2.20 | 1.93 |
| TiO₂ | | 1.73 | 1.93 | 1.70 | 1.94 | 1.94 | 0.01 |
| P₂O₅ | | 0.68 | 1.33 | 1.32 | 1.34 | 1.34 | 0.51 |
| ZnO | | 0 | 0 | 0 | 0 | 0 | 1.97 |
| SnO₂ | | 0.27 | 0.30 | 0.29 | 0.30 | 0.30 | 1.33 |
| SrO | | 0.004 | 0.01 | 0.01 | 0.01 | 0.01 | 1.03 |
| PbO | | <0.001 | <0.001 | <0.001 | <0.001 | <0.001 | <0.001 |
| Cl | | <0.001 | <0.001 | <0.001 | <0.001 | <0.001 | <0.001 |
| As₂O₃ | | <0.01 | <0.01 | <0.01 | <0.01 | <0.01 | <0.01 |
| Sb₂O₃ | | <0.01 | <0.01 | <0.01 | <0.01 | <0.01 | <0.01 |
| HfO₂ | | unmeasured | 0.03 | 0.03 | 0.03 | 0.03 | 0.04 |
| Fe₂O₃ | ppm | 80 | 90 | 90 | 100 | 90 | 90 |
| MoO₃ | | <0.3 | <0.3 | <0.3 | <0.3 | <0.3 | <0.3 |
| Pt | | unmeasured | unmeasured | unmeasured | unmeasured | unmeasured | unmeasured |
| Rh | | unmeasured | unmeasured | unmeasured | unmeasured | unmeasured | unmeasured |
| V₂O₅ | | unmeasured | unmeasured | unmeasured | unmeasured | unmeasured | unmeasured |
| Nd₂O₃ | | <5 | <5 | <5 | <5 | <5 | <5 |
| Pr₆O₁₁ | | unmeasured | 1 | 1 | 1 | 1 | 1 |
| Sm₂O₃ | | unmeasured | unmeasured | unmeasured | unmeasured | unmeasured | unmeasured |
| Li₂O/BaO | — | 0.67 | 0.96 | 0.67 | 0.96 | 0.97 | 0.89 |
| Na₂O + K₂O | % by | 0.09 | 0.11 | 0.11 | 0.11 | 0.11 | 0.13 |
| | mass | | | | | | |
| MgO + CaO | % by | 0.12 | 0.67 | 0.37 | 0.98 | 0.62 | 0.43 |
| | mass | | | | | | |
| (Na₂O + K₂O + MgO)/BaO | — | 0.04 | 0.21 | 0.09 | 0.29 | 0.20 | 0.17 |
| 8Li₂O − 4 (Na₂O + K₂O + | % by | 20.78 | 21.64 | 20.97 | 20.54 | 21.99 | 14.48 |
| MgO) − (BaO + ZnO) | mass | | | | | | |
| (Li₂O + Na₂O + K₂O)/ZrO₂ | — | 1.56 | 1.67 | 1.67 | 1.67 | 1.67 | 1.47 |

TABLE 36

| | | | | | | |
|---|---|---|---|---|---|---|
| Unit | No.103 | No.104 | No.105 | No.106 | No.107 | No.108 |

Before Crystallization

| | | | | | | | |
|---|---|---|---|---|---|---|---|
| β-OH | /mm | 0.10 | 0.10 | 0.10 | 0.10 | 0.10 | 0.10 |
| Density | g/cm ³ | 2.49 | 2.47 | 2.50 | 2.48 | 2.47 | 2.52 |
| CLTE at 30-380° C. | ×10⁻⁷/° C. | 39.1 | 40.3 | 41.8 | 41.6 | 40.3 | 35.3 |
| Glass Transition Point Tg | ° C. | 742 | 721 | 728 | 721 | 724 | 731 |
| Deformation Point Tf | | 794 | 783 | 787 | 770 | 775 | 788 |
| 10 ⁴ | | 1361 | 1338 | 1346 | 1333 | 1347 | 1355 |
| 10 ^{3.5} | | 1444 | 1421 | 1428 | 1416 | 1416 | 1438 |
| 10 ³ | | 1540 | 1516 | 1523 | 1511 | 1526 | 1533 |
| 10 ^{2.5} | | 1652 | 1627 | 1635 | 1624 | 1624 | 1644 |
| Liquidus Temperature TL | | 1373 | 1369 | 1380 | 1380 | 1370 | 1421 |
| Liquidus Viscosity bg η | — | 3.92 | 3.81 | 3.78 | 3.80 | 3.80 | 3.60 |
| Primary Phase | — | ZrO₂ | ZrO₂ | ZrO₂ | ZrO₂ | ZrO₂ | mullite |

After Crystallization

| | | | | | | | |
|---|---|---|---|---|---|---|---|
| Crystallization Conditions | — | 780° C.-3 h | 780° C.-3 h | 780° C.-3 h | 780° C.-3 h | 780° C.-3 h | 780° C.-3 h |
| | | 920° C.-1 h | 905° C.-1 h | 905° C.-1 h | 905° C.-1 h | 905° C.-1 h | 910° C.-1 h |
| Precipitated Crystals | — | β-quartz | β-quartz | β-quartz | β-quartz | β-quartz | β-quartz |
| Crystallinity | % | unmeasured | unmeasured | unmeasured | unmeasured | unmeasured | 78 |
| Crystallite Size | nm | unmeasured | unmeasured | unmeasured | unmeasured | unmeasured | 56 |
| Density | g/cm ³ | unmeasured | 2.56 | 2.57 | 2.56 | 2.56 | 2.59 |
| CLTE at 30-380° C. | ×10⁻⁷/° C. | unmeasured | 0.4 | 0.6 | 3.3 | 0.0 | −2.2 |
| CLTE at 30-750° C. | | unmeasured | 1.8 | 2.5 | 4.3 | 1.3 | −1.0 |
| Total Transmittance L* | | unmeasured | 94.5 | 94.7 | 94.2 | 94.4 | 91.5 |
| Total Transmittance a* | | unmeasured | −0.9 | −0.7 | −1.2 | −1.1 | −0.6 |
| Total Transmittance b* | | unmeasured | 4.9 | 4.3 | 6.1 | 5.7 | 8.5 |
| Diffuse Transmittance L* | | unmeasured | 0.6 | 0.8 | 0.5 | 0.5 | 14.0 |
| Diffuse Transmittance a* | | unmeasured | 0.0 | 0.1 | 0.0 | 0.0 | 2.4 |
| Diffuse Transmittance b* | | unmeasured | −0.8 | −1.2 | −0.5 | −0.7 | −15.0 |
| Total Transmittance at 4 mm thickness | | unmeasured | unmeasured | unmeasured | unmeasured | unmeasured | 90.3 |
| and 1500 nm wave length | | | | | | | |

TABLE 37

| | Unit | No.109 | No.110 | No.111 | No.112 | No.113 | No.114 |
|---|---|---|---|---|---|---|---|
| SiO₂ | % by | 64.1 | 66.0 | 65.9 | 61.3 | 60.6 | 59.6 |
| Al₂O₃ | mass | 19.9 | 18.5 | 18.0 | 21.9 | 21.6 | 20.0 |
| Li₂O | | 3.30 | 3.00 | 3.00 | 2.90 | 3.45 | 2.60 |
| Na₂O | | 0.17 | 0.96 | 0.16 | 0.12 | 0.96 | 1.31 |
| K₂O | | 0.01 | 0.30 | 0.01 | 0.29 | 0.39 | 0.39 |
| MgO | | 0.20 | 0.31 | 0.01 | 0.80 | 1.98 | 0.00 |
| CaO | | 0.02 | 0.49 | 1.45 | 0.96 | 0.20 | 0.01 |
| BaO | | 6.54 | 3.02 | 4.03 | 2.50 | 0.21 | 5.04 |
| ZrO₂ | | 2.34 | 1.51 | 1.41 | 1.52 | 2.25 | 2.14 |
| TiO₂ | | 0.03 | 2.18 | 2.97 | 3.37 | 1.47 | 2.18 |
| P₂O₅ | | 1.40 | 0.01 | 0.02 | 0.02 | 2.02 | 1.51 |
| ZnO | | 0.99 | 2.50 | 1.70 | 0 | 4.11 | 4.54 |
| SnO₂ | | 0.99 | 0.20 | 0.20 | 0.20 | 0.20 | 0.40 |
| SrO | | 0 | 0.83 | 1.13 | 4.08 | 0.52 | 0.21 |
| PbO | | <0.001 | <0.001 | <0.001 | <0.001 | <0.001 | <0.001 |
| Cl | | <0.001 | <0.001 | <0.001 | <0.001 | <0.001 | <0.001 |
| As₂O₃ | | <0.01 | <0.01 | <0.01 | <0.01 | <0.01 | <0.01 |
| Sb₂O₃ | | <0.01 | <0.01 | <0.01 | <0.01 | <0.01 | <0.01 |
| HfO₂ | | 0.04 | 0.04 | 0.04 | 0.05 | 0.05 | 0.05 |
| Fe₂O₃ | ppm | 80 | 80 | 80 | 80 | 100 | 120 |
| MoO₃ | | <0.3 | <0.3 | <0.3 | <0.3 | <0.3 | <0.3 |
| Pt | | unmeasured | unmeasured | unmeasured | unmeasured | unmeasured | unmeasured |
| Rh | | unmeasured | unmeasured | unmeasured | unmeasured | unmeasured | unmeasured |
| V₂O₅ | | unmeasured | unmeasured | unmeasured | unmeasured | unmeasured | unmeasured |
| Nd₂O₃ | | <5 | 1500 | <5 | <5 | <5 | <5 |
| Pr₆O₁₁ | | 1 | 1 | 1 | 1 | 1 | 1 |
| Sm₂O₃ | | unmeasured | unmeasured | unmeasured | unmeasured | unmeasured | unmeasured |
| Li₂O/BaO | — | 0.50 | 0.99 | 0.74 | 1.16 | 16.43 | 0.52 |
| Na₂O + K₂O | % by | 0.18 | 1.26 | 0.17 | 0.41 | 1.35 | 1.70 |
| | mass | | | | | | |
| MgO + CaO | % by | 0.22 | 0.80 | 1.46 | 1.76 | 2.18 | 0.01 |
| | mass | | | | | | |
| (Na₂O + K₂O + MgO)/BaO | — | 0.06 | 0.52 | 0.04 | 0.48 | 15.86 | 0.34 |
| 8Li₂O − 4 (Na₂O + K₂O + | % by | 17.35 | 12.20 | 17.55 | 15.86 | 9.96 | 4.42 |
| MgO) − (BaO + ZnO) | mass | | | | | | |
| (Li₂O + Na₂O + K₂O)/ZrO₂ | — | 1.49 | 2.82 | 2.25 | 2.18 | 2.13 | 2.01 |

TABLE 38

| | | | | | | |
|---|---|---|---|---|---|---|
| Unit | No.109 | No.110 | No.111 | No.112 | No.113 | No.114 |

Before Crystallization

| | | | | | | | |
|---|---|---|---|---|---|---|---|
| β-OH | /mm | 0.10 | 0.20 | 0.10 | 0.10 | 0.10 | 0.40 |
| Density | g/cm ³ | 2.53 | 2.50 | 2.52 | 2.55 | 2.52 | 2.58 |
| CLTE at 30-380° C. | ×10⁻⁷/° C. | 41.4 | 42.8 | 41.6 | 43.1 | 44.9 | 43.8 |
| Glass Transition Point Tg | ° C. | 728 | 681 | 691 | 706 | 661 | 678 |
| Deformation Point Tf | | 785 | 744 | 752 | 766 | 721 | 735 |
| 10 ⁴ | | 1369 | 1336 | 1331.1 | 1291 | 1241 | 1292 |
| 10 ^{3.5} | | 1453 | 1425 | 1419 | 1370 | 1320 | 1376 |
| 10 ³ | | 1551 | 1527 | 1519.8 | 1462 | 1412 | 1472 |
| 10 ^{2.5} | | 1668 | 1646 | 1636.5 | 1570 | 1520 | 1585 |
| Liquidus Temperature TL | | 1415 | 1173 | 1201 | 1278 | 1322 | 1352 |
| Liquidus Viscosity bg η | — | 3.72 | 5.17 | 4.91 | 4.09 | 3.49 | 3.64 |
| Primary Phase | — | ZrO₂ | β- | ZrO₂ | ZrO₂ | ZrO₂ | ZrO₂ |
| | | | spodumene | | | | |

After Crystallization

| | | | | | | | |
|---|---|---|---|---|---|---|---|
| Crystallization Conditions | — | 780° C.-3 h | 760° C.-3 h | 780° C.-3 h | 780° C.-3 h | 780° C.-3 h | 740° C.-3 h |
| | | 910° C.-1 h | 870° C.-1 h | 910° C.-1 h | 890° C.-1 h | 910° C.-1 h | 890° C.-1 h |
| Precipitated Crystals | — | β-quartz | β-quartz | β-quartz | β-quartz | β- | β-quartz |
| | | β- | β- | β- | | spodumene | |
| | | spodumene | spodumene | spodumene | | | |
| Crystallinity | % | 72 | 81 | 72 | 70 | 88 | 69 |
| Crystallite Size | nm | 65 | 69 | 46 | 36 | 81 | 71 |
| Density | g/cm ³ | 2.59 | 2.57 | 2.60 | 2.66 | 2.54 | 2.62 |
| CLTE at 30-380° C. | ×10⁻⁷/° C. | 0.3 | 3.8 | 4.8 | 17.1 | 15.1 | 5.9 |
| CLTE at 30-750° C. | | 2.8 | 7.2 | 6.3 | 19.1 | 18.4 | 9.9 |
| Total Transmittance L* | — | 92.0 | 76.5 | 76.8 | 92.4 | 20.1 | 80.1 |
| Total Transmittance a* | | −0.2 | 1.6 | 0.3 | −0.7 | 14.4 | 0.2 |
| Total Transmittance b* | | 5.7 | 14.6 | 25.0 | 6.0 | 31.8 | 18.5 |
| Diffuse Transmittance L* | | 19.3 | 43.2 | 33.7 | 1.4 | 20.1 | 38.2 |
| Diffuse Transmittance a* | | 1.6 | −3.4 | −4.5 | 0.3 | 14.4 | −4.2 |
| Diffuse Transmittance b* | | −15.8 | −10.1 | −9.2 | −2.6 | 31.8 | −8.8 |
| Total Transmittance at 4 mm thickness | | 90.6 | 89.3 | 88.6 | 89.9 | 60.8 | 33.8 |
| and 1500 nm wave length | | | | | | | |

TABLE 39

| | Unit | No.115 | No.116 | No.117 | No.118 | No.119 | No.120 |
|---|---|---|---|---|---|---|---|
| SiO₂ | % by | 60.9 | 67.7 | 66.4 | 68.1 | 64.9 | 64.0 |
| Al₂O₃ | mass | 20.1 | 19.0 | 18.0 | 16.5 | 19.5 | 20.0 |
| Li₂O | | 3.45 | 2.90 | 2.50 | 3.45 | 3.10 | 3.30 |
| Na₂O | | 0.38 | 0.33 | 0.12 | 1.20 | 0.62 | 0.24 |
| K₂O | | 0.10 | 0.20 | 0.01 | 0.10 | 0.01 | 0.01 |
| MgO | | 0.61 | 1.49 | 0.59 | 1.98 | 0.50 | 0.01 |
| CaO | | 0.03 | 0.20 | 0.03 | 0.68 | 1.45 | 0.39 |
| BaO | | 3.53 | 1.01 | 3.00 | 1.71 | 1.50 | 3.03 |
| ZrO₂ | | 1.32 | 2.14 | 1.72 | 2.34 | 1.93 | 1.73 |
| TiO₂ | | 2.18 | 1.68 | 1.68 | 1.70 | 2.17 | 3.38 |
| P₂O₅ | | 0.02 | 0.81 | 0.01 | 0.02 | 1.21 | 0.41 |
| ZnO | | 3.55 | 1.01 | 2.98 | 0 | 0.51 | 1.10 |
| SnO₂ | | 0.52 | 0.20 | 0.31 | 0.52 | 0.30 | 0.20 |
| SrO | | 3.08 | 1.02 | 2.03 | 1.53 | 1.75 | 2.06 |
| PbO | | <0.001 | <0.001 | <0.001 | <0.001 | <0.001 | <0.001 |
| Cl | | <0.001 | <0.001 | <0.001 | <0.001 | <0.001 | <0.001 |
| As₂O₃ | | <0.01 | <0.01 | <0.01 | <0.01 | <0.01 | <0.01 |
| Sb₂O₃ | | <0.01 | <0.01 | <0.01 | <0.01 | <0.01 | <0.01 |
| HfO₂ | | 0.05 | 0.04 | 0.04 | 0.04 | 0.04 | 0.04 |
| Fe₂O₃ | ppm | 100 | 90 | 80 | 80 | 80 | 80 |
| MoO₃ | | <0.3 | <0.3 | <0.3 | <0.3 | <0.3 | 0.3 |
| Pt | | unmeasured | unmeasured | unmeasured | unmeasured | unmeasured | unmeasured |
| Rh | | unmeasured | unmeasured | unmeasured | unmeasured | unmeasured | unmeasured |
| V₂O₅ | | unmeasured | unmeasured | unmeasured | unmeasured | unmeasured | unmeasured |
| Nd₂O₃ | | 2000 | 1900 | 4400 | 1600 | 3800 | 850 |
| Pr₆O₁₁ | | −1 | 600 | 1700 | 100 | 1300 | 300 |
| Sm₂O₃ | | unmeasured | unmeasured | unmeasured | unmeasured | unmeasured | unmeasured |
| Li₂O/BaO | — | 0.98 | 2.87 | 0.83 | 2.02 | 2.07 | 1.09 |
| Na₂O + K₂O | % by | 0.48 | 0.53 | 0.13 | 1.30 | 0.63 | 0.25 |
| | mass | | | | | | |
| MgO + CaO | % by | 0.64 | 1.69 | 0.62 | 2.66 | 1.95 | 0.40 |
| | mass | | | | | | |
| (Na₂O + K₂O + MgO)/BaO | — | 0.31 | 2.00 | 0.24 | 1.92 | 0.75 | 0.09 |
| 8Li₂O − 4 (Na₂O + K₂O + | % by | 16.16 | 13.10 | 11.14 | 12.77 | 18.27 | 21.23 |
| MgO) − (BaO + ZnO) | mass | | | | | | |
| (Li₂O + Na₂O + K₂O)/ZrO₂ | — | 2.98 | 1.60 | 1.53 | 2.03 | 1.93 | 2.05 |

TABLE 40

| | | | | | | |
|---|---|---|---|---|---|---|
| Unit | No.115 | No.116 | No.117 | No.118 | No.119 | No.120 |

Before Crystallization

| | | | | | | | |
|---|---|---|---|---|---|---|---|
| β-OH | /mm | 0.10 | 0.30 | 0.10 | 0.10 | 0.10 | 0.10 |
| Density | g/cm ³ | 2.59 | 2.46 | 2.53 | 2.48 | 2.49 | 2.51 |
| CLTE at 30-380° C. | ×10⁻⁷/° C. | 47.0 | 37.5 | 36.3 | 47.8 | 42.8 | 41.7 |
| Glass Transition Point Tg | ° C. | 665 | 707 | 707 | 660 | 699 | 700 |
| Deformation Point Tf | | 723 | 769 | 764 | 720 | 761 | 759 |
| 10 ⁴ | | 1256 | 1347 | 1347.7 | 1297 | 1325 | 1323 |
| 10 ^{3.5} | | 1338 | 1433 | 1434.3 | 1387 | 1410 | 1408 |
| 10 ³ | | 1434 | 1532 | 1533.5 | 1491 | 1509 | 1506 |
| 10 ^{2.5} | | 1545 | 1648 | 1648.3 | 1613 | 1623 | 1620 |
| Liquidus Temperature TL | | 1280 | 1325 | 1353 | 1330 | 1328 | 1327 |
| Liquidus Viscosity bg η | — | 3.85 | 4.14 | 3.97 | 3.81 | 3.98 | 3.98 |
| Primary Phase | — | β- | ZrO₂ | ZrO₂ | ZrO₂ | ZrO₂ | ZrO₂ |
| | | spodumene | | | | | |

After Crystallization

| | | | | | | | |
|---|---|---|---|---|---|---|---|
| Crystallization Conditions | — | 780° C.-3 h | 780° C.-3 h | 780° C.-3 h | 780° C.-3 h | 780° C.-3 h | 780° C.-3 h |
| | | 910° C.-1 h | 910° C.-1 h | 910° C.-1 h | 910° C.-1 h | 880° C.-1 h | 910° C.-1 h |
| Precipitated Crystals | — | β- | β-quartz | β-quartz | β-quartz | β-quartz | β-quartz |
| | | spodumene, | | | | | |
| | | Al₂O₃-SiO₂- | | | | | |
| | | based | | | | | |
| | | crystals | | | | | |
| Crystallinity | % | 94 | 91 | 81 | 80 | 81 | 78 |
| Crystallite Size | nm | 60 | 37 | 38 | 87 | 36 | 37 |
| Density | g/cm ³ | 2.66 | 2.56 | 2.63 | 2.56 | 2.57 | 2.59 |
| CLTE at 30-380° C. | ×10⁻⁷/° C. | 10.3 | 6.9 | 3.1 | 6.6 | 7.3 | 0.5 |
| CLTE at 30-750° C. | | 14.8 | 7.2 | 3.7 | 12.4 | 8.9 | 3.0 |
| Total Transmittance L* | — | 0.0 | 92.1 | 89.4 | 36.1 | 89.2 | 90.7 |
| Total Transmittance a* | | 0.0 | −0.9 | −0.9 | 8.0 | −0.7 | −1.3 |
| Total Transmittance b* | | 0.0 | 3.6 | 1.5 | 32.6 | 3.3 | 6.9 |
| Diffuse Transmittance L* | | 0.0 | 1.3 | 0.7 | 35.9 | 1.4 | 1.8 |
| Diffuse Transmittance a* | | 0.0 | 0.1 | 0.2 | 8.0 | 0.1 | 0.6 |
| Diffuse Transmittance b* | | 0.0 | −1.6 | −2.0 | 32.7 | −2.1 | −4.2 |
| Total Transmittance at 4 mm thickness | | 87.6 | 85.3 | 47.2 | 86.0 | 88.9 | 90.6 |
| and 1500 nm wave length | | | | | | | |

TABLE 41

| | Unit | No.121 | No.122 | No.123 | No.124 | No.125 | No.126 |
|---|---|---|---|---|---|---|---|
| SiO₂ | % by | 64.5 | 65.3 | 65.0 | 67.7 | 67.9 | 67.7 |
| Al₂O₃ | mass | 23.0 | 22.0 | 21.0 | 19.0 | 18.8 | 19.0 |
| Li₂O | | 3.00 | 3.40 | 3.45 | 2.90 | 2.90 | 2.90 |
| Na₂O | | 0.64 | 0.10 | 0.10 | 0.42 | 0.43 | 0.43 |
| K₂O | | 0.29 | 0.29 | 0.20 | 0.20 | 0.20 | 0.20 |
| MgO | | 0.30 | 1.30 | 1.00 | 1.49 | 1.49 | 1.49 |
| CaO | | 0.02 | 0.77 | 1.92 | 0.20 | 0.20 | 0.20 |
| BaO | | 2.03 | 0.40 | 0.71 | 1.01 | 1.01 | 1.00 |
| ZrO₂ | | 2.03 | 1.62 | 1.72 | 2.13 | 2.14 | 2.13 |
| TiO₂ | | 1.68 | 2.98 | 2.17 | 1.68 | 1.69 | 1.68 |
| P₂O₅ | | 0.01 | 0.20 | 0.51 | 0.81 | 0.80 | 0.81 |
| ZnO | | 2.01 | 0 | 1.52 | 0.98 | 0.97 | 0.98 |
| SnO₂ | | 0.40 | 0.20 | 0.20 | 0.20 | 0.20 | 0.20 |
| SrO | | 0 | 1.35 | 0 | 1.03 | 1.03 | 1.02 |
| PbO | | <0.001 | <0.001 | <0.001 | <0.001 | <0.001 | <0.001 |
| Cl | | <0.001 | <0.001 | <0.001 | <0.001 | <0.001 | <0.001 |
| As₂O₃ | | <0.01 | <0.0 | <0.01 | <0.01 | <0.01 | <0.01 |
| Sb₂O₃ | | <0.01 | <0.01 | <0.01 | <0.01 | <0.01 | <0.01 |
| HfO₂ | | 0.04 | 0.04 | 0.04 | 0.04 | 0.04 | 0.04 |
| Fe₂O₃ | ppm | 90 | 100 | 110 | 100 | 100 | 100 |
| MoO₃ | | <0.3 | <0.3 | <0.3 | <0.3 | <0.3 | <0.3 |
| Pt | | unmeasured | unmeasured | unmeasured | unmeasured | unmeasured | unmeasured |
| Rh | | unmeasured | unmeasured | unmeasured | unmeasured | unmeasured | unmeasured |
| V₂O₅ | | unmeasured | unmeasured | unmeasured | unmeasured | unmeasured | unmeasured |
| Nd₂O₃ | | 380 | 490 | 4200 | 2000 | 2100 | 2100 |
| Pr₆O₁₁ | | 1 | 100 | 1 | 300 | 100 | 20 |
| Sm₂O₃ | | unmeasured | unmeasured | unmeasured | unmeasured | unmeasured | unmeasured |
| Li₂O/BaO | — | 1.48 | 8.50 | 4.86 | 2.87 | 2.87 | 2.90 |
| Na₂O + K₂O | % by | 0.93 | 0.39 | 0.30 | 0.62 | 0.63 | 0.63 |
| | mass | | | | | | |
| MgO + CaO | % by | 0.32 | 2.07 | 2.92 | 1.69 | 1.69 | 1.69 |
| | mass | | | | | | |
| (Na₂O + K₂O + MgO)/BaO | — | 0.61 | 4.23 | 1.83 | 2.09 | 2.10 | 2.12 |
| 8Li₂O − 4 (Na₂O + K₂O + | % by | 15.04 | 20.04 | 20.17 | 12.77 | 12.74 | 12.74 |
| MgO) − (BaO + ZnO) | mass | | | | | | |
| (Li₂O + Na₂O + K₂O)/ZrO₂ | — | 1.94 | 2.34 | 2.18 | 1.65 | 1.65 | 1.66 |

TABLE 42

| | | | | | | |
|---|---|---|---|---|---|---|
| Unit | No.121 | No.122 | No.123 | No.124 | No.125 | No.126 |

Before Crystallization

| | | | | | | | |
|---|---|---|---|---|---|---|---|
| β-OH | /mm | 0.10 | 0.10 | 0.10 | 0.20 | 0.10 | 0.30 |
| Density | g/cm ³ | 2.49 | 2.46 | 2.48 | 2.46 | 2.46 | 2.46 |
| CLTE at 30-380° C. | ×10⁻⁷/° C. | 37.5 | 40.1 | 41.6 | 37.7 | 37.9 | 37.8 |
| Glass Transition Point Tg | ° C. | 710 | 706 | 693 | 710 | 709 | 710 |
| Deformation Point Tf | | 774 | 762 | 750 | 763 | 757 | 759 |
| 10 ⁴ | | 1330 | 1309 | 1293.2 | 1351 | 1354 | 1355 |
| 10 ^{3.5} | | 1411 | 1391 | 1375.4 | 1437 | 1441 | 1441 |
| 10 ³ | | 1506 | 1485 | 1470.6 | 1537 | 1542 | 1541 |
| 10 ^{2.5} | | 1618 | 1595 | 1582 | 1653 | 1659 | 1659 |
| Liquidus Temperature TL | | 1430 | 1259 | 1268 | 1352 | 1353 | 1352 |
| Liquidus Viscosity bg η | — | 3.39 | 4.34 | 4.17 | 3.98 | 4.00 | 4.02 |
| Primary Phase | — | mullite | β- | β- | ZrO₂ | ZrO₂ | ZrO₂ |
| | | | spodumene | spodumene | | | |

After Crystallization

| | | | | | | | |
|---|---|---|---|---|---|---|---|
| Crystallization Conditions | — | 780° C.-3 h | 780° C.-3 h | 760° C.-3 h | 780° C.-3 h | 780° C.-3 h | 780° C.-3 h |
| | | 930° C.-1 h | 910° C.-1 h | 880° C.-1 h | 910° C.-1 h | 910° C.-1 h | 910° C.-1 h |
| Precipitated Crystals | — | β-quartz | β-quartz | β-quartz | β-quartz | β-quartz | β-quartz |
| Crystallinity | % | 84 | 87 | 90 | 88 | 91 | 90 |
| Crystallite Size | nm | 44 | 38 | 42 | 37 | 38 | 37 |
| Density | g/cm ³ | 2.58 | 2.56 | 2.56 | 2.56 | 2.55 | 2.56 |
| CLTE at 30-380° C. | ×10⁻⁷/° C. | 1.8 | 7.9 | 3.3 | 7.8 | 7.4 | 7.7 |
| CLTE at 30-750° C. | | 3.5 | 8.8 | 5.0 | 8.1 | 7.8 | 8.0 |
| Total Transmittance L* | — | 91.6 | 91.9 | 88.8 | 92.0 | 92.2 | 92.0 |
| Total Transmittance a* | | −0.5 | −0.4 | −0.2 | −0.9 | −0.8 | −0.7 |
| Total Transmittance b* | | 7.1 | 4.6 | 2.3 | 3.8 | 3.4 | 3.1 |
| Diffuse Transmittance L* | | 12.9 | 1.0 | 2.6 | 1.3 | 1.0 | 1.1 |
| Diffuse Transmittance a* | | 1.3 | 0.2 | 0.6 | 0.1 | 0.1 | 0.1 |
| Diffuse Transmittance b* | | −11.9 | −2.0 | −6.0 | −2.0 | −2.0 | −2.1 |
| Total Transmittance at 4 mm thickness | | 90.2 | 88.8 | 89.9 | 87.1 | 89.7 | 89.9 |
| and 1500 nm wave length | | | | | | | |

TABLE 43

| | Unit | No.127 | No.128 | No.129 | No.130 | No.131 |
|---|---|---|---|---|---|---|
| SiO₂ | % by | 67.7 | 67.8 | 67.7 | 67.7 | 67.8 |
| Al₂O₃ | mass | 19.0 | 19.0 | 19.0 | 19.0 | 19.0 |
| Li₂O | | 2.90 | 2.90 | 2.90 | 2.90 | 2.90 |
| Na₂O | | 0.43 | 0.32 | 0.32 | 0.34 | 0.33 |
| K₂O | | 0.20 | 0.20 | 0.20 | 0.20 | 0.20 |
| MgO | | 1.50 | 1.48 | 1.48 | 1.49 | 1.49 |
| CaO | | 0.20 | 0.19 | 0.19 | 0.20 | 0.20 |
| BaO | | 1.01 | 1.00 | 1.00 | 1.00 | 1.00 |
| ZrO₂ | | 2.13 | 2.13 | 2.13 | 2.12 | 2.13 |
| TiO₂ | | 1.68 | 1.69 | 1.69 | 1.68 | 1.69 |
| P₂O₅ | | 0.81 | 0.81 | 0.81 | 0.81 | 0.81 |
| ZnO | | 0.98 | 0.98 | 0.98 | 0.99 | 1.00 |
| SnO₂ | | 0.20 | 0.18 | 0.18 | 0.19 | 0.18 |
| SrO | | 1.030 | 1.030 | 1.03 | 1.03 | 1.03 |
| PbO | | <0.001 | <0.001 | <0.001 | <0.001 | <0.001 |
| Cl | | <0.001 | <0.001 | <0.001 | <0.001 | <0.001 |
| As₂O₃ | | <0.01 | <0.01 | <0.01 | <0.01 | <0.01 |
| Sb₂O₃ | | <0.01 | <0.01 | <0.01 | <0.01 | <0.01 |
| HfO₂ | | 0.04 | 0.04 | 0.04 | 0.04 | 0.04 |
| Fe₂O₃ | ppm | 110 | 90 | 100 | 100 | 110 |
| MoO₃ | | <0.3 | <0.3 | <0.3 | <0.3 | <0.3 |
| Pt | | 0.50 | unmeasured | unmeasured | unmeasured | unmeasured |
| Rh | | 0.10 | unmeasured | unmeasured | unmeasured | unmeasured |
| V₂O₅ | | 1.00 | unmeasured | unmeasured | unmeasured | unmeasured |
| Nd₂O₃ | | 2200 | 1800 | 2200 | 2300 | 1900 |
| Pr₆O₁₁ | | 1 | 500 | 700 | 800 | 100 |
| Sm₂O₃ | | unmeasured | 600 | 200 | 40 | 100 |
| Li₂O/BaO | — | 2.87 | 2.90 | 2.90 | 2.90 | 2.90 |
| Na₂O + K₂O | % by | 0.63 | 0.52 | 0.52 | 0.54 | 0.53 |
| | mass | | | | | |
| MgO + CaO | % by | 1.70 | 1.67 | 1.67 | 1.69 | 1.69 |
| | mass | | | | | |
| (Na₂O + K₂O + MgO)/BaO | — | 2.11 | 2.00 | 2.00 | 2.03 | 2.02 |
| 8Li₂O − 4 (Na₂O + K₂O + | % by | 12.69 | 13.22 | 13.22 | 13.09 | 13.12 |
| MgO) − (BaO + ZnO) | mass | | | | | |
| (Li₂O + Na₂O + K₂O)/ZrO₂ | — | 1.66 | 1.61 | 1.61 | 1.62 | 1.61 |

TABLE 44

| | | | | | |
|---|---|---|---|---|---|
| Unit | No.127 | No.128 | No.129 | No.130 | No.131 |

Before Crystallization

| | | | | | | |
|---|---|---|---|---|---|---|
| β-OH | /mm | 0.10 | 0.10 | 0.10 | 0.10 | 0.10 |
| Density | g/cm ³ | 2.46 | 2.46 | 2.46 | 2.46 | 2.46 |
| CLTE at 30-380° C. | ×10⁻⁷/° C. | 37.8 | 36.7 | 37.4 | 37.2 | 37.1 |
| Glass Transition Point Tg | ° C. | 711 | 714 | 711 | 711 | 713 |
| Deformation Point Tf | | 760 | 768 | 763 | 766 | 766 |
| 10 ⁴ | | 1354 | 1353 | 1352.9 | 1353 | 1354 |
| 10 ^{3.5} | | 1440 | 1439 | 1439.4 | 1440 | 1440 |
| 10 ³ | | 1539 | 1537 | 1538.2 | 1540 | 1538 |
| 10 ^{2.5} | | 1656 | 1651 | 1652 | 1657 | 1653 |
| Liquidus Temperature TL | | 1358 | unmeasured | unmeasured | unmeasured | unmeasured |
| Liquidus Viscosity bg η | — | 3.97 | unmeasured | unmeasured | unmeasured | unmeasured |
| Primary Phase | — | ZrO₂ | unmeasured | unmeasured | unmeasured | unmeasured |

After Crystallization

| | | | | | | |
|---|---|---|---|---|---|---|
| Crystallization Conditions | — | 780° C.-3 h | 780° C.-3 h | 780° C.-3 h | 780° C.-3 h | 780° C.-3 h |
| | | 910° C.-1 h | 910° C.-1 h | 910° C.-1 h | 910° C.-1 h | 910° C.-1 h |
| Precipitated Crystals | — | β-quartz | β-quartz | β-quartz | β-quartz | β-quartz |
| Crystallinity | % | 88 | 91 | 90 | 89 | 91 |
| Crystallite Size | nm | 36 | 38 | 35 | 37 | 36 |
| Density | g/cm ³ | 2.56 | 2.56 | 2.56 | 2.56 | 2.56 |
| CLTE at 30-380° C. | ×10⁻⁷/° C. | 7.7 | 7.2 | 7.1 | 5.2 | unmeasured |
| CLTE at 30-750° C. | | 8.1 | 7.4 | 7.3 | 6.4 | unmeasured |
| Total Transmittance L* | — | 92.1 | 92.6 | 92.1 | 92.1 | 92.5 |
| Total Transmittance a* | | −0.7 | −0.8 | −0.7 | −0.8 | −0.6 |
| Total Transmittance b* | | 3.0 | 3.3 | 3.0 | 2.8 | 2.8 |
| Diffuse Transmittance L* | | 0.8 | 0.9 | 0.9 | 1.0 | 1.0 |
| Diffuse Transmittance a* | | 0.1 | 0.1 | 0.1 | 0.1 | 0.2 |
| Diffuse Transmittance b* | | −1.9 | −1.8 | −1.8 | −1.8 | −2.0 |
| Total Transmittance at 4 mm thickness | | 90.4 | 87.7 | 87.9 | 88.5 | 90.4 |
| and 1500 nm wave length | | | | | | |

First, raw materials were compounded in the form of an oxide, a hydroxide, a carbonate, a nitrate or other forms so that each of glasses having respective compositions shown in the tables was obtained, thus obtaining a raw material batch. The obtained raw material batch was melted at 1500 to 1700° C. to form it into an ingot shape having a thickness of about 15 mm, and subjected to heat treatment at 700° C. for 60 minutes using an annealing furnace, and then the annealing furnace was cooled at a rate of 100° C./h to room temperature, thus obtaining a glass sample. The compositions shown in the tables are analysis values of actually produced glasses. The melting was performed by the electric melting process widely used for the development of glass materials.

The respective contents of Pt and Rh in the samples were analyzed with an ICP-MS (inductively coupled plasma mass spectrometry) instrument (Agilent 8800 manufactured by Agilent Technologies, Inc.). First, the produced glass sample was ground and wetted with pure water and, then, perchloric acid, nitric acid, sulfuric acid, hydrofluoric acid or the like was added to the glass sample to dissolve the glass sample with the acid. Thereafter, the respective contents of Pt and Rh in the sample were measured with ICP-MS. Based on calibration curves made using prepared Pt and Rh solutions the concentrations of which had been known, the respective contents of Pt and Rh in each measurement sample were determined. The measurement modes were a He gas/HMI (low mode) for Pt and a HEHe gas/HMI (middle mode) for Rh. The mass numbers were 198 for Pt and 10³ for Rh. The content of Li₂O in the produced samples was analyzed with an atomic absorption spectrometer (contrAA 600 manufactured by Analytik Jena). The manner of analysis for this component was fundamentally the same as the analysis for Pt and Rh, such as the method for dissolving the glass sample and the use of the calibration curve. With respect to the other components, the content of each component was measured with ICP-MS or atomic absorption spectrometry, like Pt, Rh, and Li₂O. Otherwise, a calibration curve was made with an XRF (X-ray fluorescence) analyzer (ZSX Primus IV manufactured by Rigaku Corporation) using, as a sample for determining the calibration curve, a glass sample the concentration of which had been known by previously examining it with an ICP-MS or atomic absorption spectrometer, and the actual content of the component was then determined from an XRF analysis value of the measurement sample based on the calibration curve. In doing XRF analysis, the tube voltage, the tube current, the exposure time, and so on were adjusted according to the analytical component as needed.

Each of crystallizable glasses shown in the tables was subjected to nucleation by heat treatment at 700 to 950° C. for 0.75 to 10 hours and subsequently subjected to crystal growth by heat treatment at 800 to 1050° C. for 0.25 to 3 hours, thus obtaining a LAS-based crystallized glass containing β-quartz solid solution crystals as a major crystalline phase. The obtained LAS-based crystallized glasses were measured and evaluated in terms of β-OH value, type of precipitated crystals, crystallinity, crystallite size, density, coefficient of thermal expansion, total transmittance, and diffuse transmittance. In addition, the crystallizable glasses before crystallization were measured and evaluated in terms of density and coefficient of thermal expansion in the same manners as with the crystallized glasses and also measured and evaluated in terms of glass transition temperature (Tg), deformation point (Tf), temperatures at high-temperature viscosities (10⁴ dPa·s, 10^{3.5} dPa·s, 10³ dPa·s, and 10^{2.5} dPa·s), liquidus temperature (T_{L}), liquidus viscosity (logη, where η represents the glass viscosity (dPa·s) at liquidus temperature), and primary phase.

The β-OH was determined by measuring the transmittance of glass with FT-IR Frontier (manufactured by PerkinElmer Inc.) and using the following equation. The scan speed was 100 μ/min, the sampling pitch was 1 cm⁻¹, and the scan times were five per measurement.

$$β - OH = ( 1 / X ) log 10 ( {T}_{1} / {T}_{2} )$$

X: glass thickness (mm)

T1: transmittance (%) at a reference wavelength of 3846 cm⁻¹

T2: minimum transmittance (%) at a hydroxyl group absorption wavelength of around 3600 cm⁻¹

The precipitated crystals were evaluated with an X-ray diffractometer (a benchtop X-ray diffractometer Aeris manufactured by Malvern Panalytical Ltd.). The measurement range was 5 to 60°, the measurement step was 0.01°, and the scan speed was 1.5°/min. The type of major crystalline phase and the crystal grain size were evaluated using analysis software. The type of precipitated crystals identified as a major crystalline phase was shown in the tables. The crystallinity was determined from the integrated intensity ratio between the amorphous peak and the crystal peak. The average crystallite size of the major crystalline phase was calculated using a measured X-ray diffraction peak based on the Debeye-Sherrer method.

The density was evaluated by the Archimedes's method.

The coefficients of thermal expansion were evaluated, using glass samples processed with a length of 20 mm and a diameter of 3.8 mm, from the average coefficients of linear thermal expansion measured in a temperature range of 30 to 380° C. and a temperature range of 30 to 750° C. A dilatometer manufactured by NETZSCH was used for the measurement.

Each of the transmittances was evaluated by measuring a crystallized glass sheet (30 mm square) optically polished on both sides to have a thickness of 4 mm with a spectro-photometer. A spectro-photometer V-670 manufactured by JASCO Corporation was used for the measurement. The spectro-photometer V-670 was fitted with an integrating sphere unit “ISN-723” and the transmittance measured with a barium plate attached to the unit corresponds to the total transmittance. The measurement wavelength range was 380 to 780 nm, the scan speed was 200 nm/min, the sampling pitch was 1 nm, and the band width was 5 nm. As needed, measurement was made also in a wavelength range (200 to 2500 nm) other than the above wavelength range. As an exceptional condition, measurement was made with a band width of 20 nm in the near-infrared wavelength range. Prior to the measurement, a baseline correction (adjustment to 100%) and a dark measurement (adjustment to 0%) were performed. The dark measurement was conducted in a state where the barium sulfate plate attached to ISN-723 was removed. In terms of the diffuse transmittance of the crystallized glass, using the same type of instrument as above, the measurement sample was set and measured in a state where the barium sulfate plate attached to ISN-723 was removed. Regarding the chromaticity of each transmittance, the chromaticity of illuminant D65 under a visual angle of 2 degrees was determined by calculation. The calculation method was based on JIS Z 8781-4.

The glass transition point and the deformation point were evaluated by measuring the thermal expansion curve of the glass sample in a temperature range of 30 to 750° C. with a dilatometer manufactured by NETZSCH and calculating the inflection points of the curve.

The temperatures at high-temperature viscosities were evaluated by the platinum ball pulling-up method. In making the evaluation, a mass of glass sample was crushed to an appropriate size and loaded into an alumina-made crucible so as not to involve air bubbles as much as possible. Subsequently, the alumina crucible was heated to turn the sample into a melt and the measured values of the glass viscosity of the melt at a plurality of temperatures were determined. Furthermore, the constant of the Vogel-Fulcher equation was calculated and a viscosity curve was created. The temperature at each viscosity was calculated from the viscosity curve.

The liquidus temperature was evaluated in the following manner. First, glass powder sized in the particle size range from 300 micrometers to 500 micrometers was filled in a platinum boat with a size of approximately 120×20×10 mm, the boat was put into an electric furnace, and the glass powder was melted at 1600° C. for 30 minutes in the furnace. Thereafter, the platinum boat was placed in an electric furnace having a linear temperature gradient for 20 hours to precipitate devitrification. The measurement sample was air cooled to room temperature, a devitrified matter precipitated at the interface between the platinum boat and the glass was observed, and the temperature at the portion where the devitrified matter was precipitated was calculated as a liquidus temperature from the temperature gradient graph of the electric furnace. Furthermore, the obtained liquidus temperature was interpolated into the high-temperature viscosity curve of the glass and the viscosity in the viscosity curve corresponding to the liquidus temperature was determined as a liquidus viscosity.

The primary phases produced in the crystallized glasses of the examples shown in the tables were analyzed using X-ray diffractometry, composition analysis, and so on (with a scanning electron microscope S-3400N Type II manufactured by Hitachi High-Tech Corporation and EMAX ENERGY EX-250×manufactured by Horiba, Ltd.).

As is obvious from the tables, it was found that the crystallized glasses in Example Nos. 1 to 131 were low in coefficient of thermal expansion, high in L* value of total transmittance, small in a* value and b* value of total transmittance, and therefore had excellent transparency.

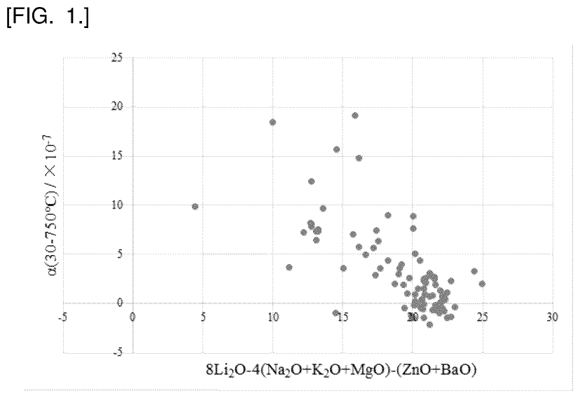

FIG. 1 is a scatter graph on which, for the crystallized glasses in Examples of the present invention, their coefficients of thermal expansion at 30 to 750° C. are plotted against their values of 8Li₂O—4(Na₂O+K₂O+MgO)—(BaO+ZnO). The gragh shows that there is a tendency that the larger the value of 8Li₂O—4(Na₂O+K₂O+MgO)—(BaO+ZnO) is, the lower the coefficient of thermal expansion of the crystallized glass is.

1. A LAS-based crystallized glass containing, in terms of % by mass, 55 to 75% SiO₂, 10 to 35% Al₂O₃, 0.1 to 5% Li₂O, 0 to 10% BaO, 0 to 10% MgO, 0 to 5% TiO₂, 0 to 5% ZrO₂, and 0 to 5% P₂O₅ and satisfying that a value of 8Li₂O−4(Na₂O+K₂O+MgO)—(BaO+ZnO) is not more than 30%.

2. The LAS-based crystallized glass according to claim 1, containing, in terms of % by mass, 0.1 to 4% Li₂O and 1 to 10% BaO and satisfying that the value of 8Li₂O—4(Na₂O+K₂O+MgO)—(BaO+ZnO) is 0 to 25%.

3. The LAS-based crystallized glass according to claim 2, containing 2 to 10% BaO in terms of % by mass.

4. The LAS-based crystallized glass according to claim 2, containing more than 0 to less than 0.7% Na₂O+K₂O in terms of % by mass.

5. The LAS-based crystallized glass according to claim 4, containing 0.01 to 4% P₂O₅ in terms of % by mass.

6. The LAS-based crystallized glass according to claim 5, containing 0 to less than 900 ppm Fe₂O₃ in terms of % by mass.

7. The LAS-based crystallized glass according to claim 6, containing 0 to 0.2% CaO in terms of % by mass.

8. The LAS-based crystallized glass according to claim 2, satisfying that the value of 8Li₂O—4(Na₂O+K₂O+MgO)—(BaO+ZnO) is 12 to 25% in terms of % by mass.

9. The LAS-based crystallized glass according to claim 2, being substantially free of As₂O₃ and Sb₂O₃.

10. The LAS-based crystallized glass according to claim 2, wherein Li₂O/BaO is not more than 2.5 in terms of mass ratio.

11. The LAS-based crystallized glass according to claim 2, wherein (Na₂O+K₂O+MgO)/BaO is not more than 6 in terms of mass ratio.

12. The LAS-based crystallized glass according to claim 2, wherein (Li₂O+Na₂O+K₂O)/ZrO₂ is not more than 2.5 in terms of mass ratio.

13. The LAS-based crystallized glass according to claim 4, containing 0 to less than 1.1% ZnO in terms of % by mass.

14. The LAS-based crystallized glass according to claim 2, containing 0.1 to 3.47% Li₂O in terms of % by mass and satisfying that the value of 8Li₂O—4(Na₂O+K₂O+MgO)—(BaO+ZnO) is 18 to 25%.

15. The LAS-based crystallized glass according to claim 2, containing 0.1 to 2000 ppm Pr₆O₁₁ in terms of % by mass.

16. The LAS-based crystallized glass according to claim 2, containing 0.1 to 2000 ppm Sm₂O₃ in terms of % by mass.

17. A LAS-based crystallized glass containing, in terms of % by mass, 55 to 75% SiO₂, 15 to 30% Al₂O₃, 2.5 to 3.55% Li₂O, 0 to 1.1% MgO, 0 to 1.6% CaO, 0.01 to 2.5% TiO₂, 0 to 2.9% ZrO₂, 0 to 2% P₂O₅ , 30 to 2000 ppm Fe₂O₃, and 0 to 1000 ppm V₂O₅ and satisfies that a value of 8Li₂O—4(Na₂O+K₂O+MgO)—(BaO+ZnO) is 0 to 30%.

18. A LAS-based crystallized glass containing, in terms of % by mass, 55 to 75% SiO₂, 15 to 30% Al₂O₃, 2.0 to 3.49% Li₂O, 2.7 to 10% BaO, 0 to 4% MgO+CaO, 0.01 to 5% TiO₂, 1.3 to 5% ZrO₂, and 30 to 10000 ppm Fe₂O₅ and satisfying that a value of 8Li₂O—4(Na₂O+K₂O+MgO)—(BaO+ZnO) is 10 to 30%.

19. A LAS-based crystallized glass containing, in terms of % by mass, 55 to 75% SiO₂, 15 to 30% Al₂O₃, 2.0 to 3.55% Li₂O, 2.6 to 10% BaO, 0 to 4% MgO+CaO, 0.01 to 2.5% TiO₂, 0 to 2.9% ZrO₂, 0 to 2% P₂O₅ , and 30 to 10000 ppm Fe₂O₃ and satisfying that a value of 8Li₂O—4(Na₂O+K₂O+MgO)—(BaO+ZnO) is 0 to 30%.

20. A LAS-based crystallized glass containing, in terms of % by mass, 55 to 68% SiO₂, 15 to 30% Al₂O₃, 2.0 to 3.49% Li₂O, 0 to 2.7% BaO, 1.5 to 5% MgO+CaO, 0.01 to 3.9% TiO₂, 1.4 to 2.9% ZrO₂, 0 to 2.5% P₂O₅ , and 30 to 10000 ppm Fe₂O₃ and satisfying that a value of 8Li₂O—4(Na₂O+K₂O+MgO)—(BaO+ZnO) is 10 to 30%.

21. The LAS-based crystallized glass according to claim 2, having an L* value of total transmittance of not less than 90 at a thickness of 4 mm.

22. The LAS-based crystallized glass according to claim 2, wherein a β-quartz solid solution is precipitated as a major crystalline phase.

23. The LAS-based crystallized glass according to claim 2, having a coefficient of thermal expansion of −20×10⁻⁷/° C. to 20×10⁻⁷/° C. at Page 6 of 7 30 to 750° C.

24. A method for producing the LAS-based crystallized glass according to claim 2, the method comprising the steps of:
melting a glass raw material to obtain a molten glass;
forming the molten glass into shape; and
subjecting a glass obtained in the step of forming the molten glass into shape to heat treatment to crystallize the glass,
wherein a process for forming the molten glass into shape is at least one selected from an overflow process, a float process, a down-draw process, a slot down process, a redraw process, a containerless process, a blow process, a press forming process, a roll process, a bushing process, and a tube draw process.

25. A crystallizable glass containing, in terms of % by mass, 55 to 75% SiO₂, 10 to 35% Al₂O₃, 0.1 to 5% Li₂O, 0 to 10% BaO, 0 to 10% MgO, 0 to 5% TiO₂, 0 to 5% ZrO₂, and 0 to 5% P₂O₅ and satisfying that a value of 8Li₂O—4(Na₂O+K₂O+MgO)—(BaO+ZnO) is not more than 30%.
